(19) United States
(12) Patent Application Publication
(10) Pub. No.: US 2003/0014400 A1
(43) Pub. Date: Jan. 16, 2003

(54) System and method for case study instruction

(75) Inventor: Martin A. Siegel, Bloomington, IN (US)

Correspondence Address: Thomas A. Walsh, Ice Miller, One American Square, Box 82001, Indianapolis, IN, 46282-0002, US

(73) Assignee: Advanced Research and Technology Institute, Indianapolis, IN

(21) Appl. No.: 10/167,131

(22) Filed: Jun. 11, 2002

Related U.S. Application Data
(60) Provisional application No. 60/297,673, filed on Jun. 12, 2001.

(51) Int. Cl. G06F 17/30

(52) U.S. Cl. 707/3

(57) ABSTRACT

A system and method for case study instruction, comprising a host server, a database associated with the host server, at least one client computer, and a network operably connecting the host server and the client computer(s). Client computers are operated by learners or facilitators. Case studies according to the present invention comprise episodes. Each episode comprises events on timelines, character profiles, and, optionally, resources. Each event optionally comprises activities. Information about a case study is retrievably stored on the host server and in the database. Case studies are executed by one or more learners using a client computer to retrieve case study information through the network. Learners may be organized into teams. Where the network comprises a global computer network, learners may execute a case study from substantially any place in the world, at substantially any time of the day. Facilitators assist learners during execution of a case study.

This application claims the benefit of U.S. Provisional Patent Application Serial No. 60/297,673, filed Jun. 12, 2001, the disclosure of which is incorporated herein by reference.

### BACKGROUND

The case study method of instruction is well known and well accepted in the education art. From the mathematical story problems solved by elementary schoolchildren, to the complex cases analyzed by graduate-level business students and law students, the case study method of instruction provides a valuable alternative to instruction based on, for example, theoretical lectures, rote memorization, and repetitious problem-solving practice.

A case study typically begins with a factual setting. The factual setting may comprise the facts related to an actual occurrence, perhaps embellished by certain hypothetical facts. Alternatively, the factual setting may be completely hypothetical. In either case, it is preferred that the factual setting describe an environment and circumstances that are authentic to the student. An authentic factual setting is more appealing to a student, thus enhancing learning.

The purpose of the factual setting is to present one or more problems for each student to resolve. In most instances, resolving case study problems requires a student to exercise skills and/or to apply knowledge learned by the student in conjunction with, or in advance of, the case study. The exercise of the student's skills and/or the application of the student's knowledge in resolving the problem(s) presented by a case study preferably results in the student building a greater facility with the skills, and/or a greater understanding of the knowledge, than could have been accomplished in the absence of the case study.

At the discretion of the case study instructor, case study instruction may be performed by one or more students working individually, or by groups of two or more students working as a team. A team arrangement may enhance the learning experience of each student within the team, as the interaction of the team members may result in each team member deriving knowledge and/or skills from the knowledge and/or skills possessed by each other team member. The interaction between, and collaboration among, team members often improves the efficacy of a case study as an educational tool. Team members have an opportunity to test new conceptions and ideas against the opinions of well-informed peers. Individuals learn best when they are put in the position of articulating (whether in writing or verbally) what they think and where they compare and contrast their conceptions with the positions of their peers. T. M. Duffy & D. J. Cunningham, Constructivism: Implications for the Design and Delivery of Instruction, in Handbook of Research on Educational Communications and Technology (D. H. Jonassen ed., 1996).

In a typical case study, the students, individually or in teams, are first expected to comprehend the factual setting. Next, the students are asked to resolve the problems presented by the factual setting. In some instances, the instructor may identify the problems for the students. In other instances, students must identify the problem(s), with only limited assistance from the instructor. Problem identification itself may be a learning objective of this type of case study.

After identification of the problem(s) presented by the case study, the students develop one or more alternative courses of action or solutions, and then evaluate the alternative courses of action or solutions to determine which alternative best resolves the problem(s). Each course of action or solution must be feasible in light of the factual setting.

The success of a case study often correlates highly with the effectiveness of the case study instructor. An effective approach taken by case study instructors is the approach of “choreographing” a case study. V. Kasturi Rangan, Choreographing a Case Class, Harvard Business School Publishing, 1995. Choreographing a case involves facilitating the students' understanding of the case study's underlying lesson. Instead of leading the students through discussion of the key conceptual and decision issues, the instructor takes a subordinate role. The case study is student-directed. Student discussion and analysis predominates, with the instructor interjecting to ensure discussion of important topics and encourage consideration of all sides of an issue during such discussion. The role of the instructor in this instance can best be categorized as a “facilitator.”

Recognizing the value of case study instruction, companies, institutions, organizations, and associations frequently employ case studies in training programs offered to management, employees, and volunteers. Several problems arise in delivering the case study instruction to such management, employees, and volunteers. First, it is expensive to provide all prospective students with the opportunity to participate in a case study in person. Classroom rental, instructor fees, travel expenses, and time away from the job all present a drain on the financial resources of the sponsor of the case study and/or the students. In addition, inevitable scheduling conflicts hinder full attendance at or participation in the case study.

For these and other reasons, it is desired to provide an improved system and method for case study instruction. Such a system and a method should be less expensive than previously existing types of case study instruction. The desired system and method should enhance participation by making case studies available to all students simultaneously, or to each student at the student's leisure.

Case studies according to the desired system and method also should comprise desirable case study features. For example, case studies according to the desired system and method should have the capability to be facilitated. Case studies according to the desired system and method should comprise authentic factual settings. Finally, group participation in case studies should be made possible by the desired system and method for case study instruction.

### SUMMARY

The present invention is an improved system and method for case study instruction. According to the present invention, case studies are executed by one or more learners through a computer network. Learners may be organized into teams, enhancing the learning experience of each learner on the team. Because the case studies according to the present invention are accessible through a computer network, there is no need for a classroom or for co-location of learners. Many implementations of the present invention also do not require learners to access a case study simultaneously. Even if a particular implementation of the present invention requires a plurality of learners to access a case study simultaneously, the plurality of learners may do so from a plurality of physical locations, provided each learner has access to the computer network. In addition, if a particular implementation of the present invention permits, a learner may participate in a case study at any time and from any place, as long as the learner has access to the computer network. Thus, flexibility in case study participation may be enhanced, and the cost of case study instruction may be reduced. In an embodiment of the present invention where the computer network comprises the Internet, a global computer network, a learner may participate in a case study from substantially any place in the world, at substantially any time of the day.

The present invention comprises a host server, a database associated with the host server, at least one client computer, and a network operably connecting the host server and the at least one client computer. Client computer(s) may be operated by learner(s) and/or facilitator(s). Information about at least one case study is retrievably stored on the host server and in the database. In an embodiment of the present invention, the case study information comprises a plurality of display pages.

A case study according to the present invention comprises at least one episode. Each episode comprises at least one event, at least one character profile, and, optionally, at least one resource. Each event optionally comprises one or more activities, including survey activities, discussion forum activities, quiz activities, computer facilitated practice activities, and point-of-view activities.

It is recommended, but not required, that case studies according to the present invention be facilitated. A facilitator according to the present invention operates with a goal of assisting learners in achieving the learning objectives of a case study. The present invention comprises facilitator tools including, in one embodiment, an activity creation facilitator tool, a resource creation facilitator tool, a learner tracking facilitator tool, a discussion capture facilitator tool, as well as facilitator tools specific to each type of case study activity.

The activity creation facilitator tool enables a facilitator to supplement the case study information by adding new information about one or more new activities. New activities may be added by the facilitator at any time, including after learners have begun to execute the case study. Similarly, the resource creation facilitator tool enables a facilitator to supplement the case study information by adding new information about one or more new resources. New resources may be added by the facilitator at any time, including after learners have begun to execute the case study.

In an embodiment, the present invention also comprises means useable by a facilitator and/or a learner for acquiring a report. The reporting means according to this embodiment of the present invention is operable to retrieve a portion of the information from the database, to compile the retrieved information in a format displayable on the applicable client computer, and to display the compiled information on the applicable client computer. The facilitator's aforementioned learner tracking tool comprises a report wherein the compiled information is representative of at least one learner's participation during the case study. The aforementioned activity-specific facilitator tools comprise reporting means operable to compile information from the database into reports pertaining to the case study's activities.

The present invention also comprises means for communicating between the plurality of participants, such means including threaded discussions, instant messaging, chat room, and means for sending one or more e-mail messages to another learner or facilitator. A facilitator may capture all or a portion of the messages posted during a threaded discussion and save them as a computer file using the discussion capture facilitator tool.

In an embodiment, the present invention comprises means useable by a learner or a facilitator for retrievably storing personal messages on the host server and in the database. Means for hindering unauthorized access to such personal messages also is provided according to this embodiment.

In an embodiment, the present invention comprises means useable by a learner and/or a facilitator for retrievably storing an action plan on the host server and in the database. Optionally, means for creating and editing an action plan also may be provided. Means for hindering unauthorized access to such action plans also is provided according to this embodiment.

In an embodiment, the present invention comprises a system and a method for creating information about a case study. The system comprises a host server, a database associated with the host server, at least one client computer, and a network operably connecting the host server and the at least one client computer. When created, information about a case study is retrievably stored on the host server and in the database. In an embodiment of the present invention, the created case study information comprises a plurality of display pages. As before, a case study comprises at least one episode. Each episode comprises at least one event, at least one character profile, and, optionally, at least one resource. Each event optionally comprises one or more activities.

In an embodiment, the database of the present invention is adapted to comprise an activity database, an event database, a scene database, a character profile database, and a resource database. Each such database comprises templates. For example, the activity database comprises activity templates; the event database comprises event templates; the scene database comprises scene templates; the resource database comprises resource templates; and the character profile database comprises character profile templates. Each such template is retrievable from the applicable database by the user using the client computer, populatable with information by the user using data entry means of the client computer, and retrievably storable on the host server and in the database by the user using the client computer.

An embodiment of the present invention comprises a method for creating information about a case study. The method comprises the steps of identifying at least one subject matter expert, identifying at least one learning objective, identifying at least one learner, defining information about at least one character profile, defining information about at least one episode, defining information about at least one event, finalizing the information about the case study, and retrievably storing the finalized information about the case study on the host server and in the database.

Optionally, the method also may comprise, after the step of defining information about the at least one episode, the step of defining information about at least one resource. Optionally, the method also may comprise, after the step of defining information about the at least one event, the step of defining information about at least one activity. Optionally, the method also may comprise, after the step of defining information about the at least one event, the step of defining information about at least one scene. Optionally, the method may further comprise the steps of defining a plan for implementing the case study, registering the at least one learner, introducing the learners to the case study, and executing the case study.

These and other features and advantages of the present invention, and the manner of attaining them, will be more apparent and better understood by reference to the following descriptions of embodiments of the invention taken in conjunction with the accompanying drawings and with the appended claims.

### BRIEF DESCRIPTION OF THE DRAWINGS

FIG. 1 shows a block diagram illustrating an embodiment of the system of the present invention.

FIG. 2 shows a block diagram illustrating another embodiment of the system of the present invention, including a client computer for a facilitator.

FIG. 3 shows a block diagram illustrating an organizational structure of a scenario according to an embodiment of the present invention.

FIG. 4A shows a flow chart illustrating the operation of an embodiment of the present invention in an exemplary scenario comprising three episodes.

FIG. 4B shows a flow chart illustrating the operation of an embodiment of the present invention in an exemplary scenario comprising three episodes and involving a facilitator.

FIG. 5 shows a pictorial view of an exemplary display page comprising a home page for a scenario.

FIGS. 6A-C show pictorial views of display pages comprising episodes according to an embodiment of the present invention.

FIGS. 7A-C show pictorial views of display pages comprising character profiles according to an embodiment of the present invention.

FIGS. 8A-B show pictorial views of display pages comprising resources according to an embodiment of the present invention.

FIGS. 9A-B show a flow chart illustrating the execution of an episode according to an embodiment of the present invention.

FIG. 10 shows a pictorial view of an exemplary display page comprising an episode event according to an embodiment of the present invention.

FIG. 11A shows a pictorial view of an exemplary display page comprising an episode event according to an embodiment of the present invention.

FIG. 11B shows a pictorial view of an exemplary display page comprising an activity description for a discussion forum activity according to an embodiment of the present invention.

FIG. 11C shows a pictorial view of an exemplary display page comprising a learner interface for a discussion forum activity according to an embodiment of the present invention.

FIG. 11D shows a pictorial view of an exemplary display page comprising an activity description for a discussion forum activity according to an embodiment of the present invention.

FIG. 11E shows a pictorial view of an exemplary display page comprising an activity description for a survey activity according to an embodiment of the present invention.

FIG. 11F shows a pictorial view of an exemplary display page comprising a learner interface for a survey activity according to an embodiment of the present invention.

FIG. 11G shows a pictorial view of an exemplary display page comprising survey results for a survey activity according to an embodiment of the present invention.

FIG. 11H shows a pictorial view of an exemplary display page comprising survey results for a survey activity according to an embodiment of the present invention.

FIG. 12A shows a pictorial view of an exemplary display page comprising an episode event according to an embodiment of the present invention.

FIG. 12B shows a pictorial view of an exemplary display page comprising an activity description for a point-of-view activity according to an embodiment of the present invention.

FIG. 12C shows a pictorial view of an exemplary display page comprising a learner interface for a point-of-view activity according to an embodiment of the present invention.

FIG. 13A shows a pictorial view of an exemplary display page comprising an episode event according to an embodiment of the present invention.

FIG. 13B shows a pictorial view of an exemplary display page comprising an activity description for a quiz activity according to an embodiment of the present invention.

FIG. 13C shows a pictorial view of an exemplary display page comprising a learner interface for a quiz activity according to an embodiment of the present invention.

FIG. 14 shows a pictorial view of an exemplary display page comprising a team forum according to an embodiment of the present invention.

FIG. 15 shows a pictorial view of an exemplary display page comprising a common forum according to an embodiment of the present invention.

FIG. 16A shows a pictorial view of an exemplary display page comprising a participant profile according to an embodiment of the present invention.

FIG. 16B shows a pictorial view of an exemplary display page comprising a participant profile maintenance interface according to an embodiment of the present invention.

FIGS. 17A-C show a flow chart illustrating a process used to create a scenario according to an embodiment of the present invention.

FIG. 18 shows a flow chart illustrating a process used to create a scenario according to an embodiment of the present invention.

FIG. 19A shows a pictorial view of an exemplary display page comprising a learner tracking report according to an embodiment of the present invention.

FIG. 19B shows a pictorial view of an exemplary display page comprising a learner tracking report according to an embodiment of the present invention.

FIG. 20A shows a pictorial view of an exemplary display page comprising an activity report according to an embodiment of the present invention.

FIG. 20B shows a pictorial view of an exemplary display page comprising an activity report according to an embodiment of the present invention.

### DESCRIPTION

The present invention is an improved system and method for case study instruction. According to the present invention, case studies called “scenarios” are accessed through a computer network by one or more “learners.” Because the scenarios according to the present invention are accessible through a computer network, certain disadvantages of prior art case study instruction are mitigated. For example, there is no need for a classroom or for co-location of learners. Many implementations of the present invention also do not require learners to access a scenario simultaneously. Even if a particular implementation of the present invention requires a plurality of learners to access a scenario simultaneously, the plurality of learners may do so from a plurality of physical locations, provided each learner has access to the computer network.

In many implementations of the present invention there is no need for learners to adhere to a time schedule. According to such an implementation of the present invention, a learner may participate in a scenario at any time and from any place, as long as the learner has access to the computer network. In an embodiment of the present invention where the computer network comprises the Internet, a global computer network, a learner may participate in a scenario from substantially any place in the world, at substantially any time of the day.

Preferably, a scenario according to the present invention is designed to assist learners in achieving one or more “learning objectives,” which may be defined by a practitioner of the present invention in a particular scenario, according to the needs of the practitioner and/or the learners. Because learning objectives likely will differ from one scenario to the next, the present invention is adaptable to deliver scenarios designed to assist learners in achieving many different learning objectives. For example, the present invention may be adapted to deliver a scenario designed to assist learners in improving “soft skills” or tacit knowledge, such as, for example, judgment, strategic thinking, and problem-solving. In another example, the present invention may be adapted to deliver a scenario designed to assist learners in improving “practical skills” such as, for example, customer service or financial planning. In a third example, the present invention may be adapted to deliver a scenario designed to assist learners in improving “hard skills,” such as those which involve the knowledge and application of concepts, procedures, formulas, and algorithms. Hard skills include, but are not limited to, skills related to the sciences, mathematics, engineering, and information technology. Some examples of hard skills are the skill of programming in Java, the skill of balancing chemical equations, the skill of conjugating foreign language verbs, or the skill of solving physics problems.

Those of ordinary skill in the art will appreciate that there often are no bright line distinctions between “soft skills,” “practical skills,” and “hard skills,” and the present invention does not require learning objectives to be so categorized. The learning needs of a particular learner or group of learners typically are complex. Thus, the learning objectives in a particular scenario may require the present invention to be adapted to deliver a scenario designed to assist learners in improving “soft skills,” “practical skills,” and/or “hard skills,” as well as skills which do not fit squarely into one of these categories.

Practitioners of the present invention are advised to define learning objectives with thoughtfulness and care. Learning objectives provide a foundation for other decisions about how information is presented to learners in a scenario. Practitioners may be tempted to define a lengthy list of learning objectives, including many valuable things learners possibly could learn while participating in a scenario. A focused list of learning objectives is preferred. Too many learning objectives may dilute the scenario's efficacy. While the number of learning objectives is not limited by the present invention, more than three learning objectives in a scenario is not recommended for educational reasons.

Each episode also may have its own learning objectives. Usually these “episode learning objectives” are selected to support the scenario's learning objectives. Accordingly, achievement of an episode learning objective improves the likelihood that the learner will achieve the scenario's learning objectives. As with the learning objectives for the scenario, a focused list of episode learning objectives is preferred. Too many episode learning objectives may dilute the episode's efficacy. While the number of episode learning objectives is not limited by the present invention, more than three episode learning objectives in an episode is not recommended for educational reasons.

Scenarios according to the present invention may be facilitated. According to the present invention, a facilitator is preferred but not required. However, without facilitation, the quality of the learning experience may be considerably reduced. For example, learners may lack focus and direction in the absence of facilitation. In addition, learner questions about the scenario, the learning objectives, and the like, may go unanswered. As a result, learners may become less likely to complete the scenario, reducing the prospect that the scenario's learning objectives will be achieved.

Group participation in scenarios is possible according to the present invention. As further described hereinafter, the present invention permits interaction between learners during the scenario, even if such learners are physically separated, or are accessing the scenario at different times. The benefits of interaction among learners in a case study based form of instruction are known in the art. In an embodiment of the present invention, learners are organized into one or more “teams,” with each team comprising a plurality of learners. Each learner brings the learner's unique knowledge and experience to the team. By discussing the ideas and issues presented in the scenario with other learners on a team, and by otherwise interacting with other learners on a team according to the present invention, each learner may benefit from the knowledge and experience of others on the team.

As in prior art case study instruction, a scenario according to the present invention may comprise facts related to one or more actual occurrences, perhaps embellished by certain hypothetical facts. Alternatively, the scenario may be completely hypothetical. The scenario may comprise one or more “story lines” that interrelate the scenario's facts and occurrences.

The occurrences taking place during a scenario are revealed to learners through one or more “characters.” A character according to the present invention may be a person (non-fictional, fictional, or semi-fictional), a place, an animal, or an inanimate object. Characters often are fictional human beings, but this is not required.

A “profile” for each character may be available to the learners, as is further discussed hereinafter. A character profile may comprise a description of the character, including the character's traits and/or distinguishing features. Characters preferably are fully and complexly defined. Human characters may be portrayed as having sophisticated, complicated, and confused motivations. Preferably, human characters reflect characteristics and behaviors of the learners, permitting learners to draw from personal experiences while executing the scenario. Likewise, it is preferred, but not required, that non-human characters possess traits and features that are familiar to the learners.

Preferably, a scenario presents situations in which the learners can observe individuals like themselves (i.e., the human characters) in recognizable settings and situations (which may comprise one or more non-human characters) dealing with opportunities and problems familiar to the learners. Thus, the interaction of characters in a scenario allows the learners to observe familiar circumstances from the point of view of the characters. By considering how the characters are behaving under the circumstances of a scenario, a learner may engage in self-reflection, thus improving the likelihood that the scenario's learning objectives will be achieved.

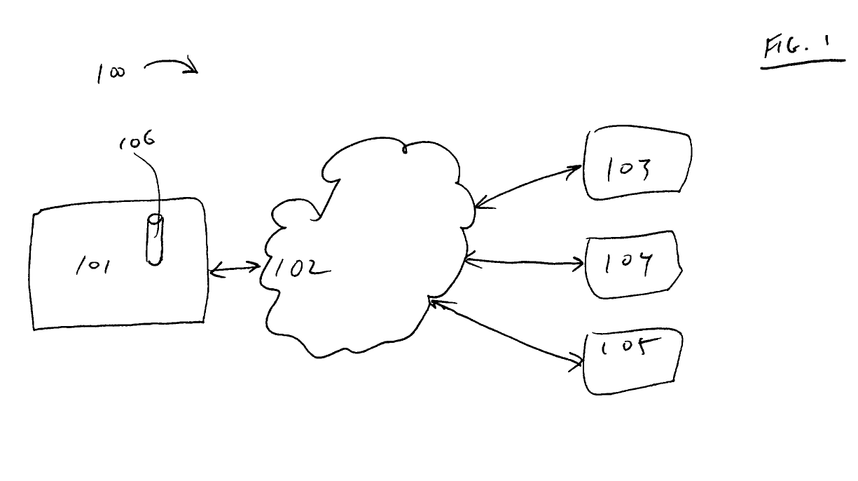

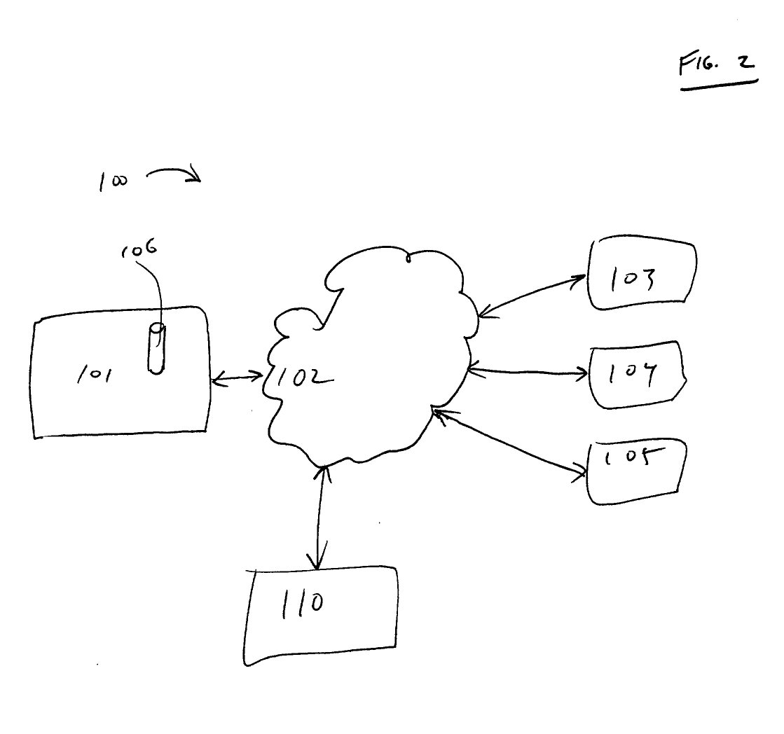

FIG. 1 shows a block diagram of an embodiment of system 100 of the present invention. Shown in FIG. 1 are host server 101, network 102, client computers 103, 104, and 105, and database 106. Host server 101 comprises one or more server computers, computing devices, or systems of a type known in the art. Host server 101 is configured and programmed with such software means as would occur to one of ordinary skill in the art to enable operation of the present invention. Host server 101 is operated by, or under the control of, a “system operator,” which may be, for example, an individual or an organization such as a company or an association. For purposes of clarity, host server 101 is shown in FIG. 1 and referred to herein as a single server. Host server 101 need not, however, be a single server. Host server 101 may comprise a plurality of servers or other computing devices or systems connected by hardware and software means known in the art which collectively are operable to perform the functions allocated to host server 101 according to the present invention.

Database 106 is “associated with” host server 101. According to the present invention, database 106 is associated with host server 101 where, as in the embodiment shown in FIG. 1, database 106 resides on host server 101. Database 106 also is associated with host server 101 where database 106 resides on a server or computing device remote from host server 101, provided the remote server or computing device is capable of bi-directional communication with host server 101. Preferably, the remote server or computing device upon which database 106 resides is operated by, or under the control of, the system operator. Preferably, the remote server or computing device upon which database 106 resides is electronically connected to host server 101 such that the remote server or computing device is capable of continuous bi-directional communication with host server 101.

For purposes of clarity, database 106 is shown in FIG. 1 and referred to herein as a single database. It will be appreciated by those of ordinary skill in the art that database 106 may comprise a plurality of databases connected by software means, which collectively are operable to perform the functions delegated to database 106 according to the present invention. Database 106 may comprise a relational database architecture or other database architecture of a type known in the database art. Database 106 may comprise one of many known database management systems, such as, for example, Microsoft®, Access®), Microsoft®, SQL Server™, IBM® DB2®, or the database management systems available from Oracle® or Sybase®.

Client computers 103, 104, and 105 are computers, computing devices, or systems of a type known in the art, such as a mainframe computer, workstation, personal computer, laptop computer, hand-held computer, wireless mobile telephone, personal digital assistant device, and the like. Each of client computers 103, 104, and 105 is operated by a learner (not shown in FIG. 1). Each of client computers 103, 104, and 105 comprises a video display means (not shown in FIG. 1) upon which information may be displayed in a manner perceptible to the learner, such as, for example, a computer monitor, cathode ray tube, liquid crystal display, light emitting diode display, touchpad or touchscreen display, and/or other means known in the art for emitting a visually perceptible output. Each of client computers 103, 104, and 105 also comprises one or more data entry means (not shown in FIG. 1) operable by the learner, such as, for example, a keyboard, keypad, pointing device, mouse, touchpad, touchscreen, microphone, and/or other data entry means known in the art. Each of client computers 103, 104, and 105 also may comprise an audio display means (not shown in FIG. 1) such as one or more loudspeakers and/or other means known in the art for emitting an audibly perceptible output. Each of client computers 103, 104, and 105 is configured and programmed with such software means as would occur to one of ordinary skill in the art to enable operation of the present invention.

For purposes of clarity, three client computers are shown in FIG. 1. However, it is within the scope of the present invention, and it will be appreciated by those of ordinary skill in the art, that the system of the present invention may have one or two client computers. It also is within the scope of the present invention, and it will be appreciated by those of ordinary skill in the art, that the quantity of client computers in the system of the present invention may be much greater than three.

In addition, the discussion of the function of a client computer in the present invention frequently is described herein by reference to only client computer 103 operated by only one learner. This practice is employed herein merely to simplify the discussion of the present invention, and does not imply that the system of the present invention operates with only a single client computer operated by only a single learner. Indeed, it will be evident from the discussion of the present invention contained herein, and it will be appreciated by those of ordinary skill in the art, that the present invention may operate with a plurality of client computers simultaneously. Each such client computer may be operated by one or more learners.

Host server 101 is operably connected to client computer 103 by a network 102, which in this embodiment comprises the Internet, a global computer network. However, network 102 need not comprise the Internet. Network 102 may comprise any means for electronically interconnecting host server 101 and client computer 102. Thus, it will be appreciated by those of ordinary skill in the art that network 102 may comprise the Internet, the commercial telephone network, one or more local area networks, one or more wide area networks, one or more wireless communications networks, coaxial cable, fiber optic cable, twisted-pair cable, the equivalents of any of the foregoing, or the combination of two or more of the foregoing. In an embodiment where host server 101 and client computer 103 comprise a single computing device operable to perform the functions delegated to host server 101 and client computer 103 according to the present invention, network 102 comprises the hardware and software means interconnecting host server 101 and client computer 103 within the single computing device.

As used herein, the term “display page” means a computer file which is transmitted from host server 101 over network 102 to a client computer, such as, for example, client computer 103. At client computer 103, the display page is interpreted by a software means residing on client computer 103, causing the computer file to be displayed on a video display means electrically connected to client computer 103 and operable to display a display page in a manner perceivable by a learner. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on the video display means electrically connected to client computer 103 in a manner perceivable by a learner. A display page may comprise an electronic form or electronic document. As used herein, an “electronic form” comprises a display page including at least one data request and at least one data entry field corresponding to the at least one data request into which a learner may enter data in an appropriate response to the data request. As used herein, an “electronic document” comprises a display page with no data entry fields. Where network 102 comprises the Internet, a display page may comprise a webpage of a type known in the art.

Each scenario according to the present invention comprises a plurality of display pages residing in database 106. During execution of a scenario, the display pages comprising the scenario are transmitted from host server 101 to client computer 103 through network 102. Typically, the display pages comprising the scenario are transmitted from host server 101 to client computer 103 through network 102 in response to actions taken by a learner operating client computer 103, but this is not required. The display pages comprising the scenario may be transmitted from host server 101 to client computer 103 through network 102 according to push technology, wherein host server 101 delivers display pages to client computer 103 without first requiring a request for the display pages to be delivered from client computer 103 to host server 101.

A display page according to the present invention may include embedded functions comprising software programs, such as, for example, VBScript routines, JScript routines, JavaScript routines, Java applets, or ActiveX components. A display page according to the present invention may be an Active Server Page. A display page according to the present invention may incorporate multimedia features, such as, for example, those made possible through the use of the Flash™ product offered by Macromedia, Inc.

A display page may comprise well known features of graphical user interface technology, such as, for example, “frames,” “windows,” “scroll bars,” “buttons,” “icons,” and “hyperlinks,” and well known features such as a “point and click” interface. Pointing to and clicking on a graphical user interface button, icon, or hyperlink also is called “selecting” the button or hyperlink. Together, a group of buttons or icons (usually displayed adjacently) comprises a graphical use interface “toolbar.” Other well known graphical user interface features, including without limitation “cut and paste” and “copy and paste” functionality, also may be used.

According to an embodiment of the present invention, a learner uses client computer 103 to connect electronically to network 102. Residing on client computer 103 is a software means such as Microsoft® Internet Explorer™ or Netscape® Communicator®, or another software means known in the art that is operable to request and interpret display pages. Residing on client computer 103 and on host server 101 are software means known in the art for communicating with network 102, and software means known in the art for exchanging information over network 102 in a manner comprehended by software means residing on host server 101 and on client computer 103.

During operation of this embodiment of the present invention, communication between host server 101, network 102, and client computer 103 is achieved by means known in the art for communicating with and through a network such as the Internet, such as, for example, communication in accordance with the transmission control protocol (“TCP/IP”), the hypertext transfer protocol (“HTTP”), the file transfer protocol (“FTP”), the wireless access protocol (“WAP”), and/or other communication protocols known in the art. A learner finds a first Uniform Resource Locator (“URL”) address, which is the URL address of a first display page stored on host server 101. The software means of client computer 103 sends an electronic request containing the URL address of the desired display page of host server 101 over network 102. Such electronic request is interpreted by network 102, which processes such request to result in connection to host server 101 as identified by its URL address. At this point, client computer 103 is in bidirectional communication with host server 101. Host server 101 then causes the desired display page to be sent over network 102 for receipt by client computer 103. The desired display page then is displayed on the video display means of client computer 103 in a manner perceivable by a learner. If a display page comprises an electronic form, data entered by a learner at client computer 103 is transmitted to and received by host server 101, with host server 101 responding to such data entry according to the software means residing thereon.

Where the display page comprises a point and click interface, by selecting one or more buttons or hyperlinks, a learner may cause client computer 103 and host server 101 to execute certain computer operations. For example, a display page may comprise one or more buttons and/or hyperlinks that may be operable, when selected by a learner, to cause client computer 103 to transmit an electronic request for another display page to host server 101 through network 102. Such electronic request is interpreted by network 102, which processes such request to result in connection to host server 101. Host server 101 then causes the desired display page to be sent over network 102 for receipt by client computer 103. The desired display page then is displayed on the video display means of client computer 103 in a manner perceivable by a learner.

It will be appreciated by those of ordinary skill in the art that other means known in the art may be used for establishing bi-directional communication between host server 101 and client computer 103. For example, client computer 103 may be in bi-directional communication with a second server computer having a hyperlink to the URL address of a display page stored on host server 101. Selection of that hyperlink by a learner will result in bi-directional communication between client computer 103 and host server 101.

After bi-directional communication is established between client computer 103 and host server 101, the present invention may take on one of several embodiments which enable a learner to interact with host server 101 according to the system shown in FIG. 1 and, in so doing, to engage in a case study based course of instruction comprising one or more scenarios.

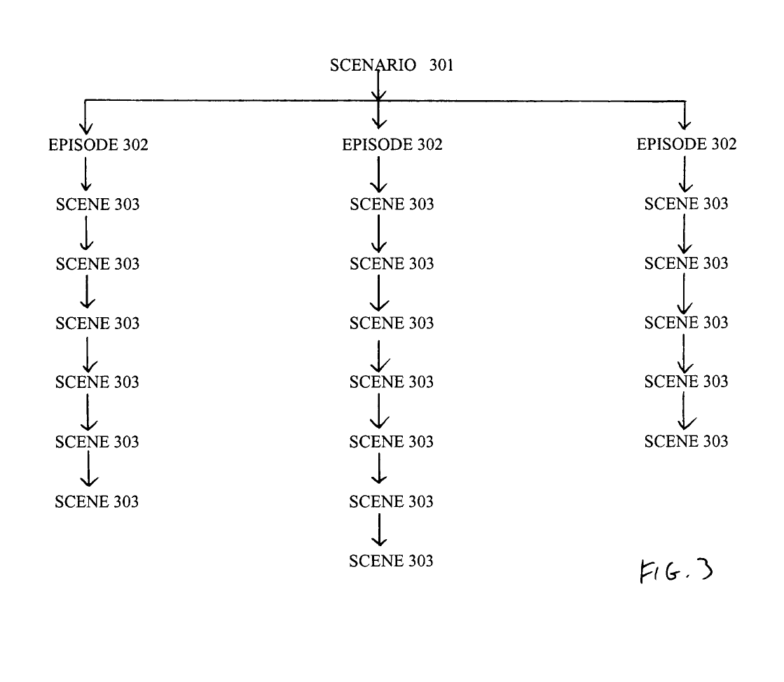

FIG. 2 shows a block diagram illustrating a second embodiment of the present invention. Shown in FIG. 2 is system 100 of FIG. 1. Also shown in FIG. 2 is client computer 110, which is operably connected to host server 101 through network 102. Client computer 110 is a computer, computing device, or system of a type known in the art, such as a mainframe computer, workstation, personal computer, laptop computer, hand-held computer, wireless mobile telephone, personal digital assistant device, and the like. Client computer 110 is operated by a “facilitator” (not shown in FIG. 2). Client computer 110 comprises a video display means (not shown in FIG. 2) upon which information may be displayed in a manner perceptible by the facilitator, and also may comprise an audio display means capable of emitting an audibly perceptible output. Client computer 110 also comprises one or more data entry means (not shown in FIG. 2) operable by the facilitator. Client computer 110 is configured and programmed with such software means as would occur to one of ordinary skill in the art to enable operation of the present invention.

The function served by the facilitator according to the present invention is further described hereinafter. A facilitator typically is a human being; however, it is within the scope of the present invention that all or a portion of the functions delegated to a facilitator according to the present invention may be performed by client computer 110, configured and programmed to accomplish such functions.

Discussion of the function of client computer 110 in the present invention frequently is described herein by reference to only a single client computer operated by one facilitator. This practice is employed herein merely to simplify the discussion of the present invention, and does not imply that the system of the present invention operates with only a single client computer operated by a single facilitator. Indeed, it will be evident from the discussion of the present invention contained herein, and it will be appreciated by those of ordinary skill in the art, that the present invention may operate with a plurality of client computers simultaneously. Each such client computer may be operated by one or more facilitators.

During operation of this embodiment of the present invention, client computer 110 is in bidirectional communication with host server 101 through network 102. Communication between host server 101 and client computer 110 is achieved by means known in the art for communicating over a computer network such as the Internet, such as, for example, communication in accordance with TCP/IP and HTTP. The facilitator operates a software means on client computer 110 to send an electronic request containing the URL address of the desired display page of host server 101 over network 102. Such electronic request is interpreted by network 102, which processes such request to result in connection to host server 101 as identified by its URL address. Host server 101 then causes the desired display page to be sent over network 102 for receipt by client computer 110. The desired display page then is displayed on the video display means of client computer 110 in a manner perceivable by the facilitator. Data entered by the facilitator at client computer 110 is transmitted to and received by host server 101, with host server 101 responding to such data entry according to the software means residing thereon.

Where the display page comprises a point and click interface, by selecting one or more buttons or hyperlinks, the facilitator may cause client computer 110 and host server 101 to execute certain computer operations. For example, a display page may comprise one or more buttons and/or hyperlinks that may be operable, when selected by a facilitator, to cause client computer 110 to transmit an electronic request for another display page to host server 101 through network 102. Such electronic request is interpreted by network 102, which processes such request to result in connection to host server 101. Host server 101 then causes the desired display page to be sent over network 102 for receipt by client computer 110. The desired display page then is displayed on the video display means of client computer 110 in a manner perceivable by the facilitator.

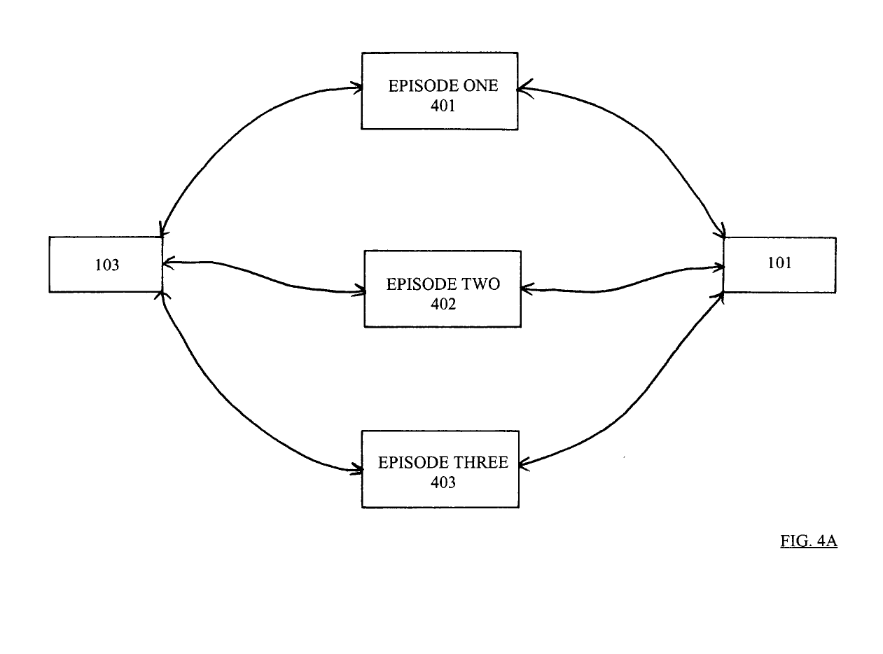

Each scenario according to the present invention is organized into “episodes” and “events.” FIG. 3 shows a block diagram illustrating the organizational structure of a scenario according to an embodiment of the present invention. As shown in FIG. 3, each scenario 301 comprises one or more episodes 302, and each episode 302 comprises one or more events 303.

In the embodiment shown in FIG. 3, scenario 301 is shown as comprising three episodes 302, but this is not required. The number of episodes in a scenario according to the present invention is left to the discretion of the practitioner. A typical scenario according to the present invention comprises three or four episodes. However, it is not required that a scenario be limited to three or four episodes. A scenario may have as few as one episode. Likewise, a scenario may have five or more episodes.

In the embodiment shown in FIG. 3, each episode 302 is shown as comprising five, six, or seven events 303, but this is not required. The number of events in an episode according to a particular scenario is left to the discretion of the practitioner. A typical episode according to the present invention has between about three events to about ten events. However, it is not required that an episode be so limited. A episode may have as few as one event. Likewise, a episode may have eleven or more events.

Each event 303 comprises a portion of an episode. An event 303 may comprise a scene, a scene and one or more activities, or one or more activities with no scene. A “scene” (not shown in FIG. 3) according to the present invention comprises certain of the scenario's facts, occurrences, story line(s), and the like, in a format perceivable by the learner. An “activity” (not shown in FIG. 3) comprises an exercise or task to be performed by a learner.

The facts, occurrences, story line(s), and the like comprising a scene are formatted into “scene content” for delivery to a learner. The forms of scene content according to the present invention are limited only by the technological limitations of the system of the present invention. Thus, the forms of scene content may comprise text, graphics, live video, recorded video, live audio, recorded audio, animation, live action, and/or multimedia, provided the system of the present invention comprises the requisite computer hardware, networking hardware, and software configured and programmed to enable the transmission, delivery, reception, storage, and perceptible display of such forms of scene content.

In an embodiment of the present invention, each event 303 comprises one or more display pages. For example, an event 303 may comprise one or more display pages comprising scene content such as, for example, a transcript of one or more conversations between two or more characters, a series of e-mail messages between two or more characters, a transcript of a voice mail message, an audio file containing a voice mail message or a recorded verbal interaction between characters, a description of a meeting between two or more characters, a multimedia file containing a recorded interaction between characters, a letter or a fax, pages from a character's calendar, a character's diary entries, a character's monologue, a webcast comprising an interview or live occurrence, as well many other forms of scene content.

In an embodiment of the present invention where each event 303 comprises one or more display pages, the present invention can be adapted to deliver scene content in ways which are not constrained within a display page. Thus, scene content may be delivered in ways which may make a scenario become more authentic to a learner. Learning is enhanced as the authenticity of the scenario increases.

A technique for delivering scene content other than through an event display page involves the use of information tools with which a learner already may be familiar. For example, where scene content comprises one or more e-mail messages, rather than recounting the e-mail message(s) in an event display page, the present invention can be adapted to deliver the e-mail messages directly to the learner's e-mail inbox. Likewise, where scene content comprises one or more voice mail messages, rather than delivering the voice mail message(s) as text transcriptions in an event display page or providing an event display page having a link to an audio file containing the voice mail message(s), the present invention can be adapted to deliver the voice mail messages directly to the learner's voice mail inbox. Scene content also may be delivered to a learner's pager, wireless mobile telephone, or personal digital assistant device. The use of familiar information tools improves the authenticity of the scenario.

Scene content can be delivered using other innovative techniques where client computer 103 is adapted to comprise a means for determining its physical location, such as, for example, where client computer 103 is adapted to comprise a Global Positioning System (“GPS”) receiver of a type known in the art, or such other means for determining physical location as would occur to those of skill in the art. For example, a learner may be instructed to move client computer 103 to a specified physical location. After client computer 103 determines that it is positioned in the specified physical location, the present invention can cause scene content pertaining to the specified physical location to be delivered to client computer 103. For example, in a scenario set in a learner's workplace, a particular scene's content may comprise a conversation between two characters which takes place in, for example, a conference room, office, or other location within the workplace. If the learner is positioned in the same setting when the scene content is received by the learner, the authenticity of the scenario is enhanced. Such a technique may be particularly useful in an embodiment of the present invention wherein client computer 103 is a portable computer connected to network 102 by a wireless connection.

The scenario organizational structure of the present invention provides several advantages. First, to improve the likelihood that a scenario will achieve its learning objective(s), it is preferred that the scenario is revealed to a learner in a controlled fashion. Organizing a scenario into episodes and events allows a practitioner of the present invention to permit the system operator and/or the facilitator to reveal only certain episodes or certain events to a learner at one time. If the scenario is facilitated, the facilitator then can direct the learner's attention to the important facts, features, or teaching points of the episode(s) or event(s) under review. The learner is better able to assimilate the new information presented by the episode(s) or event(s) under review with the information previously presented to the learner in the scenario. The learner also is more prone to perceive subtleties that may be present in the episode(s) or event(s), which may have been overlooked if the learner was required to absorb more information.

According to an implementation of the present invention, after an episode is revealed, the learner is given a limited period of time, such as, for example, two weeks, to review the events and scenes, and complete the activities. The duration of this “episode availability period” during which the learner executes a particular episode is at the discretion of the practitioner of a particular implementation of the present invention. The episode availability period may be predetermined by the practitioner and be unchangeable after execution of the scenario begins, or the practitioner may permit the facilitator and/or the system operator to determine the episode availability period spontaneously based on factors including, for example, the rate at which the learners are progressing through the episode. After the episode availability period expires, the next episode is revealed to the learner. At the discretion of the practitioner of a particular implementation of the present invention, the previous episode(s) may remain accessible to the learner, or the previous episode(s) may become inaccessible to the learner. The present invention permits practitioners to allow facilitators and/or system operators to reveal episodes manually, or to reveal episodes automatically based on the passage of a predetermined period of time.

A second advantage of the scenario organizational structure of the present invention arises because a scenario frequently comprises a sequence of occurrences taking place over a period of time (although the design of each particular scenario is left to the discretion of the practitioner of the present invention and, thus, does not always involve a sequence of occurrences taking place over a period of time). Organizing a scenario into episodes and events allows the simulation of a time-based sequence of occurrences to a learner. By releasing episodes and events for review by learners at predetermined points in time, a scenario comprising a sequence of occurrences taking place, for example, over a period of six weeks can be executed by a learner over a period of six weeks. Thus, the occurrences of the scenario can be revealed to the learner in “real-time.” However, it is not required that the scenario be revealed to the learner in real-time, or in relation to any time scale.

A third advantage of the scenario organizational structure of the present invention arises from the technology used in an embodiment of the present invention. As discussed previously herein, a scenario according to the present invention is delivered as a plurality of display pages. Organizing a scenario into episodes and events allows practitioner to organize the scenario into a coherent set of display pages. In an embodiment where network 102 comprises the Internet, it is preferred that each event is represented by one display page, which may comprise hyperlinks or buttons which reveal other display pages.

One or more “resources” (not shown in FIG. 3) are available to a learner in conjunction with each episode 302. A resource comprises background or supporting information relevant to the scenario. A resource typically comprises facts, information, industry best practices, data, or other knowledge which may serve as a reference for a learner as the learner executes the scenario. A resource may comprise, for example, a scholarly article, a glossary of important terms, a link to one or more Internet sites, a webcast comprising an interview or live occurrence, or one or more documents or forms used by an organization with which a learner is familiar. In an embodiment of the present invention, a resource also may comprise an activity according to one of the types of activities discussed hereinafter.

Preferably, a learner may access a resource at any time the learner needs more information to understand the scenario or to achieve the learning objectives. The quantity, type, and availability of resources according to a particular scenario according to the present invention are left to the discretion of the practitioner, and may vary widely from one scenario to another. The forms of resources which may be accessible during a scenario are limited only by the technological limitations of the system of the present invention. Thus, the forms of resources which may be accessible during a scenario may comprise text, graphics, live video, recorded video, live audio, recorded audio, animation, live action, and/or multimedia, provided the system of the present invention comprises the requisite computer hardware, networking hardware, and software configured and programmed to enable the transmission, delivery, reception, storage, and perceptible display of such forms of resources.

In an embodiment of the present invention, each resource comprises one or more display pages. However, the present invention can be adapted to deliver resources in ways which are not constrained within a display page, thereby enhancing the scenario's authenticity. As discussed previously in regard to scene content, where appropriate, resources can be delivered using information tools such as a learner's e-mail inbox, voice mail inbox, pager, wireless mobile telephone, or personal digital assistant device.

Likewise, location-specific resources can be made available where client computer 103 is adapted to comprise a means for determining its physical location such as, for example, a GPS receiver or other means for determining a physical location that would occur to those of skill in the art. After client computer 103 determines that it is positioned in a predetermined physical location, the present invention can cause a resource pertaining to the predetermined physical location to become accessible to a learner using client computer 103. The authenticity of the scenario is enhanced if, when a resource is accessed by the learner, the learner is positioned in the same setting to which the resource pertains. As discussed previously, such a technique may be particularly useful in an embodiment of the present invention wherein client computer 103 is a portable computer connected to network 102 by a wireless connection.

Each event 303 optionally comprises one or more “activities” (not shown in FIG. 3). An activity comprises one or more display pages comprising an exercise or task to be performed by a learner in conjunction with an event 303. Activities preferably are designed to reinforce the learning objectives. An activity may comprise an individual activity to be performed by a learner alone, or may comprise a group activity to be performed by a learner in conjunction with other learners. For example, as part of an activity a learner may be instructed to review a resource, or to complete an individual survey activity, or to discuss a question in an interactive discussion forum activity with other learners from the learner's team, or to accomplish a task in cooperation with other learners on the learner's team to achieve a common goal. Some activities are synchronous, wherein a plurality of learners (usually those on a team) must participate in the activity at the same time or during the same period of time. Other activities may be asynchronous, wherein there is no requirement that learners participate in an activity at the same time or during the same period of time.

Preferably, activities in a particular event are designed to motivate a learner to: (i) review the event's scene content (and perhaps that of one or more previous events) to more fully understand the situation, and the interaction and motivations of the characters; (ii) study the resources closely to more fully understand the issues, facts, data, information, best practices, and other knowledge which may be present therein; and/or (iii) interact with others on the learner's team to share insights, perceptions, knowledge, and wisdom.

Activities preferably require a learner's participation, reducing the chance for a learner to only passively execute the scenario. For example, many activities require a learner to respond to a stimulus, such as a quiz activity or a survey activity. Other activities require a learner to post a message to a threaded discussion session. In addition, activities frequently require a learner to interact with the learner's team members and/or with the facilitator. Activities also may provide a learner with an opportunity to practice the skills the learner is developing through the scenario.

Decisions about quantity, type, and availability of activities according to a particular scenario, as well as the relationship between events and activities according to a particular scenario, are left to the discretion of the practitioner and may vary widely from one scenario to another. In many cases, a practitioner will find that the more interactive the activities, the more a learner is interested and involved in the scenario. However, it is preferred that each event does not comprise an activity. Overuse of activities tends to lengthen the episode and to stifle a learner's motivation. Within an episode, a ratio of one event comprising one or more activities for each event without an activity is preferred. A ratio of two events comprising one or more activities for each event without an activity may be used within an episode. Finally, where an event comprises multiple activities, a practitioner can require a learner to engage in the activities in a particular order. Alternatively, a practitioner can permit a learner to engage in the activities in any order the learner desires.

In an embodiment of the present invention where each event 303 comprises one or more display pages, the present invention can be adapted to deliver activities in ways which are not constrained within a display page. Thus, an activity may be delivered in ways which may make a scenario become more authentic to a learner. As discussed previously in regard to scene content, where appropriate, activities can be delivered using information tools such as a learner's e-mail inbox, voice mail inbox, pager, wireless mobile telephone, or personal digital assistant device.

Likewise, location-specific activities can be made available where client computer 103 is adapted to comprise a means for determining its physical location, such as, for example, a GPS receiver or other means for determining a physical location that would occur to those of skill in the art. After client computer 103 determines that it is positioned in a predetermined physical location, the present invention can cause an activity pertaining to the predetermined physical location to become accessible to a learner using client computer 103. The authenticity of the scenario is enhanced if the learner is positioned in the same setting to which a resource pertains when the activity is accessed by the learner. As discussed previously, such a technique may be particularly useful in an embodiment of the present invention wherein client computer 103 is a portable computer connected to network 102 by a wireless connection.

A type of activity is called a “discussion forum.” As further discussed hereinafter, a discussion forum activity according to the present invention uses threaded discussion technology of a type known in the art in which a learner or a facilitator “posts” one or more “messages” which appear on a discussion form activity display page. In a typical discussion forum activity according to the present invention, learners are presented with an “activity description,” which may consist of a question or statement intended to prompt a discussion among the learners on a team. Preferably, the activity description is designed to focus the discussion around one or more specific topics. Although the design of a particular implementation of a discussion forum activity in a particular scenario is left to the discretion of the practitioner, it is preferred for educational purposes that the activity description in a discussion forum activity comprises no more than three questions or statements. The number of questions or statements also depends on each question's or statement's complexity. Too many questions or statements in a discussion forum activity can be unwieldy for a learner and for the eventual readers, such as, for example, a facilitator. In addition, too many questions or statements may cause the discussion to lose coherence.

Discussion in the discussion forum activity comes in the form of messages posted by learners and facilitators. Such messages are organized into “threads,” wherein each thread comprises at least one “base message.” Learners and facilitators may post one or more “reply messages,” wherein each reply message comprises a response to the base message or to an earlier-posted reply message. Base messages and reply messages are retrievably stored in database 106. When retrieved from database 106 and displayed on the video display means of client computer 103 or client computer 110, the thread comprising the base message and any related reply messages appears with the base message and reply messages organized hierarchically. A discussion forum activity may comprise more than one thread. Base messages and reply messages posted in a discussion forum activity according to the present invention may comprise text created by a learner or a facilitator using one or more data entry means of client computer 103 or client computer 110, respectively, and also may comprise one or more computer files attached to a posted message by a learner or a facilitator.

A particular implementation of a discussion forum activity may involve role playing. The activity description instructs a learner to assume the role of a character, and to post messages expressing the point of view of the assigned character.

An advantage of the discussion forum activity is that it prompts a learner to articulate in writing the learner's opinions, ideas, and questions. This process has instructional value, because by articulating opinions, ideas, and questions in writing, a learner may come to a better understanding of the learning objectives. Moreover, because the messages that a learner posts in a discussion forum activity are visible to other learners on the team, valuable social negotiation occurs.

Another type of activity is called “point-of-view.” This activity is designed to spark debate among the learners. As further discussed hereinafter, a point-of-view activity according to the present invention uses threaded discussion technology of a type known in the art in which a learner or a facilitator posts one or more messages. A point-of-view activity comprises more than one thread. As in the discussion forum activity, messages posted in a point-of-view activity according to the present invention may comprise text created by a learner or a facilitator using one or more data entry means of client computer 103 or client computer 110, respectively, and also may comprise one or more computer files attached to the posted message by a learner or a facilitator.

The design of a particular implementation of a point-of-view activity in a particular scenario according to the present invention is left to the discretion of the practitioner. In a typical point-of-view activity according to the present invention, learners are presented with an activity description comprising at least two “points.” At a minimum, the points comprise (i) an assertion and (ii) a contrary assertion. The learner then is required to post at least one message comprising an argument or opinion countering one or more of the points. The learner's at least one message is called a “counterpoint.”

According to an embodiment of a point-of-view activity, each learner's initial counterpoint is posted without consulting the learner's team members, and without consulting counterpoints previously posted by other learners. After a learner has posted an initial counterpoint in the point-of-view activity, the learner then is exposed to other counterpoints posted by other learners, such as the other learners on the learner's team. Each learner then is able to post more counterpoints in reply to the counterpoints posted by other learners, supporting or countering the viewpoints expressed by the other learners. Thus, a point-of-view activity according to the present invention forces a learner to take a position on an issue and to articulate the learner's reasoning behind the position. Because the other counterpoints initially are hidden from the learner, the learner must rely on the learner's own thoughts and insights in drafting his or her initial counterpoint. The learner cannot merely regurgitate other the ideas of other learners. When properly implemented, a point-of-view activity according to the present invention results in lively discussion that reveals each learner's beliefs.

An implementation of a point-of-view activity involves role playing. The activity description instructs a learner to assume the role of a character, and to post counterpoints from the perspective of the assigned character.

A point-of-view activity preferably relates to the learning objectives from the scenario. For educational reasons, it is preferred that the points presented in the activity description are expressed clearly and are unambiguously opposing. Even if practitioner believes the proper answer lies between the points, it enhances the debate and the learning to have strongly opposing points presented in the activity description.

Another type of activity is called a “survey.” The design of a particular implementation of a survey activity in a particular scenario according to the present invention is left to the discretion of the practitioner. In a typical survey activity according to the present invention, learners are presented with an activity description comprising one or more survey questions. Corresponding to a survey question is a set of two or more possible responses to the survey question (a “multiple choice” survey”). A learner selects at least one response from the set of possible responses as the learner's response to the survey question. A survey activity according to the present invention also may comprise one or more survey questions requiring a learner to rank a list of items according to a learner's feelings or preferences, or to match items from a first list with items from a second list, or to drag a graphical user interface object from one area of a display page to another (called “drag and drop”). A survey activity according to the present invention also may comprise one or more survey questions requiring a learner to provide a textual answer as a response to a survey question. The learner's textual response may comprise a “fill in the blank” answer, or may comprise an essay composed by the learner.

Each learner's survey question response(s) are retrievably stored in database 106. Each learner's survey question response(s) also are retrievably compiled within database 106 with each other learner's survey question responses for analysis and reporting. According to an embodiment of the present invention, after a learner submits the learner's response(s) in a survey activity, the aggregated responses of all learners on the team who have responded thus far are made available to the individual learner. The aggregated responses are retrieved from database 106 and assembled in a display page. The display page comprising the aggregated response is displayed on the video display means of the learner's client computer.

Although the design of a particular survey activity is left to the discretion of the practitioner, preferably a survey activity according to the present invention comprises no more than five questions for educational reasons. A practitioner may achieve greater success if survey questions adopt simple wording, and utilize short and precise sentence structure. Multi-part survey questions and leading survey questions should be avoided when practicing a survey activity according to the present invention.

It will be appreciated by those of ordinary skill in the art that a survey activity is a good mechanism for drawing opinions and attitudes out of a learner. Like other activities according to the present invention, a survey activity preferably requires a learner to review the content of the event and to study the resources. A practitioner may find it useful to use a discussion forum activity and a survey activity in the same event. In the discussion forum activity the practitioner may direct a learner to explain why the learner chose a particular survey activity response. In addition, a practitioner may find it useful to employ multiple instantiations of the same survey activity in multiple events during the scenario. Such a practice allows the facilitator and a learner to see how a learner's or a team's impressions and opinions change as the scenario progresses.

An “evaluation survey” activity is a variation of a survey activity. An evaluation survey activity may be used to obtain a learner's opinion regarding one or more aspects of a scenario. For example, an evaluation survey activity can be used to obtain a learner's opinion regarding the efficacy of the overall scenario or of a particular episode or activity, or the effectiveness of a facilitator. This data may be valuable even if the learner is not aware of the pertinent learning objectives.

The design of a particular implementation of a evaluation survey activity in a particular scenario according to the present invention is left to the discretion of the practitioner. As in a survey activity, in a typical evaluation survey activity according to the present invention, learners are presented with an activity description comprising one or more evaluation survey questions. Corresponding to each evaluation survey question is a set of two or more possible responses to the evaluation survey question. A learner selects at least one response from the set of possible responses as the learner's response to the evaluation survey question. A evaluation survey activity according to the present invention also may comprise one or more evaluation survey questions requiring a learner to rank a list of items according to a learner's feelings or preferences, or to match items from a first list with items from a second list, or to drag and drop an item. A evaluation survey activity according to the present invention also may comprise one or more evaluation survey questions requiring a learner to provide a textual answer as a response to a evaluation survey question. The learner's textual response may comprise a “fill in the blank” answer, or may comprise an essay composed by the learner.

As in a survey activity, in an evaluation survey activity each learner's evaluation survey question response(s) are retrievably stored in database 106. Each learner's evaluation survey question response(s) also are retrievably compiled within database 106 with each other learner's evaluation survey question responses for analysis and reporting. However, unlike a survey activity, in a typical evaluation survey activity the learners' aggregated responses are not made available to any of the learners. Instead, the learners' individual and aggregated responses are accessible only by the facilitator and/or system operator.

Although the design of a particular evaluation survey activity is left to the discretion of the practitioner of the particular implementation of the present invention, a practitioner may achieve greater success if evaluation survey questions adopt simple wording, and utilize short and precise sentence structure. Multi-part evaluation survey questions and leading evaluation survey questions should be avoided when practicing a evaluation survey activity according to the present invention. In addition, a practitioner may find it useful to employ multiple instantiations of the same evaluation survey activity during a scenario. Such a practice allows the facilitator and/or system operator to see how a learner's or a team's impressions and opinions change as the scenario progresses.

According to an embodiment of the present invention, a survey activity optionally may be randomized. When used herein, the terms “random” and “randomly” and “randomized” and “randomization” mean that no apparent pattern is present in the activities associated with such terms. The use of such terms does not necessarily imply the use of a known statistical distribution.

A method of survey activity randomization according to the present invention comprises survey question randomization. As indicated previously herein, in a typical survey activity according to the present invention, learners are presented with an activity description comprising one or more survey questions. In an embodiment of the present invention comprising survey question randomization, database 106 comprises a plurality of survey questions. When an event comprises a survey activity, the survey activity description presented to the learner comprises survey questions selected randomly from database 106. Accordingly, a first survey activity description presented to a first learner may comprise survey questions which are different from those of a second activity description presented to a second learner, even though the activity is part of the same event.

As discussed previously herein, the design of a particular implementation of a survey activity according to the present invention is left to the discretion of the practitioner. Accordingly, a practitioner may determine how, and to what extent, survey question randomization is to be used in an implementation of a scenario according to the present invention. For example, a practitioner may determine that survey question randomization is to be used only in one survey activity in the scenario. Alternatively, a practitioner may determine that survey question randomization is to be used in one survey activity in each episode. In another alternative, a practitioner may determine that survey question randomization is to be used only for survey questions having a multiple-choice format. In yet another alternative, a practitioner may determine that survey question randomization is to be used in every survey activity for survey questions of every format.

Two examples illustrate the operation of, and benefits of, survey question randomization according to the present invention. In the first example, a survey activity comprising five multiple-choice format survey questions is used by the practitioner. However, the practitioner determines that a set of twenty multiple-choice format survey questions are to be available for this survey activity. Accordingly, in an embodiment of the present invention comprising survey question randomization, each time the activity description for this survey activity is presented to a learner, the present invention is operable to select five random survey questions to appear in the activity description from among the set of twenty possible survey questions. Those of ordinary skill in the art will appreciate that a survey activity according to this example provides a large number of possible survey activity descriptions.

In another example, where a survey activity comprises four multiple choice survey questions and one fill-in-the-blank survey question, the same sort of result arises. If, for example, the database of survey questions comprising twenty multiple choice survey questions and ten fill-in-the-blank survey questions which are appropriate for the practitioner's needs with respect to the survey activity, those of ordinary skill in the art will appreciate that a survey activity according to this example provides a very large number of possible survey activity descriptions.

Another type of activity is called a “quiz.” The design of a particular implementation of a quiz activity according to the present invention is left to the discretion of the practitioner. In a typical quiz activity according to the present invention, learners are presented with an activity description comprising one or more quiz questions. As in the survey activity, corresponding to each quiz question is a set of two or more possible responses to the quiz question. Quiz questions may comprise a multiple-choice format or a true-false format. A learner selects at least one response from the set of possible responses as the learner's response to the quiz question.

A quiz activity according to the present invention also may comprise one or more quiz questions requiring a learner to rank a list of items, or to match items from a first list with items from a second list, or to drag and drop an item. A quiz activity according to the present invention also may comprise one or more quiz questions requiring a learner to provide a textual answer as a response to a quiz question. A learner's textual response may comprise a “fill in the blank” answer, or may comprise an essay composed by the learner.

Unlike the responses to survey questions in a survey activity, in a quiz activity according to the present invention there are correct and incorrect responses to the quiz questions. Each learner's quiz question response(s) are retrievably stored in database 106. Each learner's quiz question response(s) also are retrievably compiled within database 106 with each other learner's quiz question responses for analysis and reporting.

According to an embodiment of the present invention, after providing response(s) in a quiz activity, a learner immediately is shown which quiz questions the learner responded to correctly and which quiz questions the learner responded to incorrectly. The learner's quiz activity response(s) are retrieved from database 106 and assembled in a display page. The display page comprising the assembled responses is displayed on the video display means of the learner's client computer. Thus, a quiz activity according to this embodiment allows the learner to measure the learner's knowledge at a particular point during the scenario.

According to an embodiment of the present invention, after a learner completes a quiz activity, the learner is provided an explanation of the correct response to each quiz question. A display page comprising an explanation of each correct response to each quiz question is displayed the video display means of the learner's client computer. Such explanations may serve as a learning and knowledge reinforcement tool, thereby promoting the learning objectives of the scenario.

According to an embodiment of the present invention, a quiz activity optionally may be randomized in several ways. The first method of quiz activity randomization according to the present invention comprises quiz question randomization. As indicated previously herein, in a typical quiz activity according to the present invention, learners are presented with an activity description comprising one or more quiz questions. These quiz questions may comprise questions having a multiple-choice format, a true-false format, a matching format, a drag and drop format, a fill-in-the-blank format, and/or an essay format. In an embodiment of the present invention comprising quiz question randomization, database 106 comprises a plurality of quiz questions corresponding to one or more of the foregoing quiz question formats. When an event comprises a quiz activity, the quiz activity description presented to the learner comprises quiz questions selected randomly from database 106. Accordingly, a first quiz activity description presented to a first learner may comprise quiz questions which are different from those of a second activity description presented to a second learner, even though the activity is part of the same event.

As discussed previously herein, the design of a particular implementation of a quiz activity according to the present invention is left to the discretion of the practitioner. Accordingly, a practitioner may determine how, and to what extent, quiz question randomization is to be used in an implementation of a scenario according to the present invention. For example, a practitioner may determine that quiz question randomization is to be used only in one quiz activity in the scenario. Alternatively, a practitioner may determine that quiz question randomization is to be used in one quiz activity in each episode. In another alternative, a practitioner may determine that quiz question randomization is to be used only for quiz questions having a multiple-choice format. In yet another alternative, a practitioner may determine that quiz question randomization is to be used in every quiz activity for quiz questions of every format.

Two examples illustrate the operation of, and benefits of, quiz question randomization according to the present invention. In the first example, a quiz activity comprising five multiple-choice format quiz questions is used by the practitioner. However, the practitioner determines that a set of twenty multiple-choice format quiz questions are to be available for this quiz activity. Accordingly, in an embodiment of the present invention comprising quiz question randomization, each time the activity description for this quiz activity is presented to a learner, the present invention is operable to select five random quiz questions to appear in the activity description from among the set of twenty possible quiz questions. Those of ordinary skill in the art will appreciate that a quiz activity according to this example provides a large number of possible quiz activity descriptions.

In another example, where a quiz activity comprises two multiple choice quiz questions, two true-false quiz questions, and one fill-in-the-blank quiz question, the same sort of result arises. If, for example, the database of quiz questions comprising twenty multiple choice quiz questions, twenty true-false quiz questions, and ten fill-in-the-blank quiz questions which are appropriate for the practitioner's needs with respect to the quiz activity, those of ordinary skill in the art will appreciate that a quiz activity according to this example provides a very large number of possible quiz activity descriptions.

A second form of quiz activity randomization can be called “within-question” randomization. This form of randomization is most appropriate for multiple-choice quiz questions, but may be adapted for use in other forms of quiz questions where appropriate. In a multiple-choice quiz question, the learner is presented with a set of two or more possible responses to the quiz question. One quiz question response is the correct response. The other quiz question responses are known as “distracters.” There are two types of within-question randomization. In the first type, the quiz question responses are static. Accordingly, in a multiple-choice quiz question having, for example, four possible quiz question responses, these same four possible quiz question responses appear in every instance that the quiz question is presented to the learner. However, the sequence of the four possible quiz question responses is randomly selected at the time the quiz question is presented to the learner. Thus, where a first learner may be presented with the quiz question responses such that the actual correct response is the third quiz question response in the sequence (for example, the response designated as “c”), a second learner may be presented with the quiz question responses where the correct response is displayed as the first possible quiz question response in the sequence (for example, the response designated as “a”).

A related form of within-question randomization results in different distracters randomly appearing in the set of quiz question responses. For example, for a particular quiz question having one correct response, ten distracter responses may be developed and stored in a database. At the time the quiz question is presented to the learner, three distracters are selected from the database. This second form of within-question randomization may be used in conjunction with the first form of within-question randomization, to further enhance the randomness of the quiz activity.

A quiz activity according to the present invention also may comprise an “adaptive” quiz. Similar to a quiz activity comprising quiz question randomization, where a quiz activity comprises an adaptive quiz, a first quiz activity description presented to a first learner may comprise quiz questions which are different from those of a second activity description presented to a second learner, even though the activity is part of the same event.

An adaptive quiz according to the present invention uses branching based on a learner's response to a quiz question. Thus, for example, in a quiz activity comprising four quiz questions, the second quiz question presented to the learner varies depending on the learner's response to the first quiz question. Likewise, the third quiz question presented to the learner varies depending on the learner's response to the second quiz question, and the fourth quiz question presented to the learner varies depending on the learner's response to the third quiz question.

The system of the present invention is operable to retrieve the appropriate next quiz question from database 106 in view of to a learner's response to a then-current quiz question. For example, if the learner first encounters a quiz question of medium difficulty (as defined by the practitioner of the particular implementation of the present invention) and answers it correctly, the learner then automatically is presented with a quiz question of higher difficulty retrieved from database 106. On the other hand, if the learner answers the first quiz question incorrectly the learner then automatically is presented with a quiz question of lesser difficulty retrieved from database 106. The determination of which quiz question is next presented to the learner can be governed by mathematical algorithms or based on a logical analysis of the content and/or difficulty of the previous quiz question and the set of possible quiz question responses.

In an embodiment of the present invention, an adaptive quiz comprises a factual setting. The quiz question responses comprise possible actions to be taken according to the factual setting. Based on the learner's choice from the set of quiz question responses, the factual setting changes and the learner is given another set of quiz question responses comprise possible actions to be taken based on the new factual scenario. Operation of this embodiment of an adaptive quiz continues in this way until the levels of branching are exhausted. The determination of which factual setting is next presented to the learner can be governed by mathematical algorithms or based on a logical analysis of the content of the previous factual and the set of possible quiz question responses.

Another type of activity is called “computer-facilitated practice” or “CFP.” As with other activities, the design of a particular implementation of a CFP activity according to the present invention is left to the discretion of the practitioner. In a typical CFP activity according to the present invention, learners engage in practice sessions involving sets of stimulus-response pairs. Within one or more display pages displayed on a learner's client computer, the learner is presented a series of stimuli. Each stimulus item has one correct response. According to the present invention, CFP activity items may comprise a multiple-choice format, a true-false format, a ranking format, an item matching format, a drag and drop format, and/or a “fill in the blank” format.

When a stimulus item is presented, the learner can: (1) respond to the stimulus item by, for example, typing a response into a data entry field available on the display page or by selecting a response from a set of possible responses displayed on the display page; or (2) request that the correct response be displayed to the learner on the video display means of the learner's client computer. If the learner types or selects the correct response, an acknowledgement of the learner's correct response is displayed on the video display means of the learner's client computer, and/or is audibly delivered to learner by the client computer. The learner's response also is retrievably stored in database 106 for analysis and reporting. The learner then is presented with the next stimulus item in the series.

If the learner types or selects an incorrect response, or if the learner requests the correct response, feedback is provided to the learner on the video display means of the learner's client computer (and/or is audibly delivered to the learner by the client computer), and the stimulus item is marked for review. The learner's response, or the learner's request for the correct response, also is retrievably stored in database 106 for analysis and reporting. The learner then is presented with the next stimulus item in the series.

In an embodiment of a CFP activity according to the present invention, an incorrect response by a learner constitutes one of two types of errors: (i) a Discrimination Error, also called a Within-List Error, and (ii) an Out-of-List Error. In an example of a Discrimination Error, given a CFP activity on chemical elements, if a stimulus item is “What is the symbol for helium?,” and the item is of a fill in the blank format, if the learner responds “H,” the learner has committed a Discrimination Error. This is considered a Discrimination Error because both “H and “He” are actual symbols for chemical elements, but the learner has failed to correctly discriminate between them.

In an example of an Out-of-List Error, where a stimulus item is “What chemical element is represented by the symbol ‘H’?,” and the item is of a fill in the blank format, if the learner responds “water,” the learner has committed an Out-of-List Error. This is considered an Out-of-List Error because “water” is not the name of any chemical element.

In an embodiment of a CFP activity according to the present invention, database 106 contains a list of all possible responses to all possible stimulus items, and also contains the correct response for each stimulus item. When the learner's response to a stimulus item is processed by host server 101, the learner's response is compared against the correct response for the stimulus item stored in database 106. If the learner's response is not the correct response, host server 101 and database 106 automatically search within database 106 to determine whether the learner's erroneous response is found among the list of all possible responses to all possible stimulus items stored in database 106. If so, the learner's erroneous response is treated as a Discrimination Error. If not, the learner's erroneous response is treated as an Out-of-List Error.

The feedback differs for the two types of errors. For Discrimination Errors, the feedback points out the confusion. Thus, if the learner says “H” is the symbol for “helium,” a possible sequence would be:

| | |
|---|---|
| Stimulus Item: | What is the symbol for helium? |
| Response: | H |
| Feedback: | No. “H” is the symbol for hydrogen. “He” is the symbol |
| | for helium. |

This feedback can appear in varying forms. The point is that the Discrimination Error is pointed out and the correct answer is provided.

Conversely, if the learner makes an Out-of-List Error, the feedback is simply the correct answer. Thus, if the learner says “water” is represented by the symbol “H,” a possible sequence would be:

| | |
|---|---|
| Stimulus Item: | What chemical element is represented by the symbol H? |
| Response: | Water |
| Feedback: | No. Hydrogen is the chemical element is represented by |
| | the symbol H. |

In an alternative embodiment, in response to a Discrimination Error, partial feedback is given and the question is asked again, interrupting the increasing interval review process (discussed hereinafter). Thus, if the learner says “H” as the symbol for “helium,” a possible sequence would be:

| | |
|---|---|
| Stimulus Item: | What is the symbol for helium? |
| Response: | H |
| Partial Feedback: | No. “H” is the symbol for hydrogen. What is the |
| | symbol for helium? |

In this embodiment, if the learner makes a second error, regardless of its classification as a Discrimination Error or Out-of-List Error, Out-of-List Error feedback is provided:

| | |
|---|---|
| Response: | Hm |
| Feedback: | No. “He” is the symbol for helium. |

When a stimulus item is marked for review, the stimulus item enters an increasing interval review sequence. A typical increasing interval review sequence according to the present invention comprises 2-later, 4-later, and 6-later review. That is, the stimulus item will appear two stimulus items later, then four stimulus items later, and then six stimulus items later during the CFP activity session (assuming there are no further errors with other stimulus items). Other increasing interval review sequences may be used by the practitioner in a particular implementation of a CFP activity according to the present invention. For example, a practitioner may specify an increasing interval review sequence comprising 3-later, 6-later, and 9-later review; or an increasing interval review sequence comprising 2-later, 4-later, and 8-later review. A practitioner also may specify an increasing interval review sequence comprising more than or less than three phases of review.

A CFP activity according to the present invention comprises a stimulus item retirement criterion. In a typical CFP activity according to the present invention, after a stimulus item is responded to correctly two consecutive times in a CFP activity session, it is retired from the CFP activity session. Thus, the stimulus item retirement criterion for a typical CFP activity is 2. However, if so desired by the practitioner, a particular implementation of a CFP activity according to the present invention may comprise a stimulus item retirement criterion which is more than or less than 2.

In an embodiment, each stimulus item in a CFP activity according to the present invention comprises a retirement criterion counter. At the beginning of a CFP activity session, the retirement criterion counter for each stimulus item has a value of 0. In operation, if a stimulus item is responded to correctly the first time it is presented to the learner, the retirement criterion counter is advanced to 1, and the stimulus item is placed at the end of the stimulus item queue. If the same stimulus item is responded to correctly the next time it is presented to the learner, the retirement criterion counter is advanced to 2, and, if the retirement criterion also is 2, the stimulus item is retired from the CFP activity session.

However, if a stimulus item is marked for review the first time it is presented to the learner, the retirement criterion counter remains at 0, and the item is placed into increasing interval review. As discussed previously, during increasing interval review, the stimulus item is reviewed two stimulus items later, four stimulus items later, and then six stimulus items later. If the stimulus item is responded to correctly each time it is presented to the learner during increasing interval review, the retirement criterion counter is advanced to 1, and the stimulus item is returned to the end of the stimulus item queue. If the same stimulus item is responded to correctly the next time it is presented to the learner, its retirement criterion counter is advanced to 2, and, if the retirement criterion also is 2, the stimulus item is retired from the CFP activity session.

If a stimulus item's retirement criterion counter has a value of 1, and the stimulus item is marked for review the next time it is presented to the learner, the retirement criterion counter is reset to 0, and the item is placed into increasing interval review. If the stimulus item is responded to correctly each time it is presented to the learner during increasing interval review, the retirement criterion counter is advanced to 1, and the stimulus item is returned to the end of the stimulus item queue. If the same stimulus item is responded to correctly the next time it is presented to the learner, the retirement criterion counter is advanced to 2, and, if the retirement criterion also is 2, the stimulus item is retired from the CFP activity session. However, if the same stimulus item is marked for review the next time it is presented to the learner, the retirement criterion counter is reset to 0, and the item again is placed into increasing interval review.

The CFP activity session continues until all stimulus items are retired. According to an embodiment of a CFP activity according to the present invention, a learner must complete a CFP activity in one sitting. If the learner leaves the CFP activity before it is completed, the learner must begin the CFP activity from the beginning.

A typical CFP activity session comprises between about 12 to about 20 stimulus items, although there may be more stimulus items or fewer stimulus items in a particular implementation of a CFP activity within a scenario. A practitioner utilizing a CFP activity in a particular scenario according to the present invention may achieve greater success by using fewer stimulus items (for example, between about 12 to about 15 stimulus items) if the practitioner perceives that the learner(s) is/are unfamiliar with the subject matter of the stimulus items. Conversely, if a practitioner perceives that the learner(s) is/are familiar with some or all of the subject matter of the stimulus items, a practitioner may wish to use more stimulus items (for example, between about 16 to about 20 stimulus items) in the CFP activity.

In an embodiment of a CFP activity according to the present invention, the display page comprising the stimuli comprises a dynamic progress measurement indicator. The dynamic progress measurement indicator displays to a learner a “percentage completed” during the CFP activity session. By analyzing information retrieved from database 106, the present invention is capable of calculating the percentage completed, taking into consideration the fact that stimulus items marked for review create additional stimulus items through increasing interval review, and that some stimulus items may be returned to the session after they are retired if the remaining stimulus items in the CFP activity session do not allow for a complete review of the stimulus items marked for review.

Because stimulus items marked for review create additional stimulus items through increasing interval review, and because some stimulus items may be resurrected if the remaining stimulus items in the CFP activity session do not allow for a complete review of the stimulus items marked for review, it is possible that a learner's percentage completed may decrease at times during the course of a CFP activity session. Under certain conditions, this phenomenon can appear even if a learner responds correctly to a stimulus item. To avoid a possibly adverse effect on the learner's morale arising out this phenomenon, an embodiment of the present invention's dynamic progress measurement indicator is adapted to display only increases in the percentage completed measurement. The actual percentage completed is maintained in database 106, but if the percentage completed decreases during the course of a CFP activity session, the dynamic progress measurement indicator is operable to display the greater of (i) the actual percentage completed, or (ii) the highest record percentage completed.

An embodiment of a CFP activity according to the present invention comprises a difficulty measurement which is retrievably recorded in database 106 for each stimulus item presented during a CFP activity session. A stimulus item's “difficulty” is measured as a ratio of the number of times the stimulus item is marked for review per the number of times the stimulus item is presented during the CFP activity session. The higher the ratio, the more difficult the stimulus item. The present invention is adaptable to calculate a difficulty measurement for a stimulus item according to several methods such as: (i) based on the experience of a learner during a then-current CFP activity session; (ii) based on the experience of a learner during one or more previous CFP activity sessions where the learner encountered the same stimulus item; (iii) based on the experience of a plurality of learners during a then-current scenario where the plurality of learners encountered the same stimulus item; (iv) or based on the experience of a plurality of learners during one or more previous scenarios where the plurality of learners encountered the same stimulus item. The total time to complete a CFP activity session also is retrievably stored in database 106 according to an embodiment of the present invention.

TABLE I shows a hypothetical learner's performance in a hypothetical CFP activity session comprising fourteen stimulus items. The first column of TABLE I shows the specific stimulus item presented to a learner on the video display means of the learner's client computer during a particular iteration of the CFP activity session. Each row of TABLE I shows how the queue of stimulus items was arranged at the time the stimulus item shown in the first column (i.e., the first queue position) is displayed on the video display means of the learner's client computer. By reading down the first column, one can determine the exact sequence of items that was presented to the hypothetical learner. Thus, as shown in TABLE I, the learner was presented stimulus item a, then stimulus item b, then stimulus item c, then stimulus item b again, then stimulus item d, and so on.

In the example shown in TABLE I, each stimulus item comprises a retirement criterion of 2. A lower case letter in the first queue position indicates that the response to the stimulus item submitted by the learner was a correct response. A capital letter in the first queue position indicates that that the response submitted by the learner was incorrect, or that the learner requested the correct response. The first time a stimulus item is responded to correctly, it is returned to the end of the queue. Because the retirement criterion is 2, the second consecutive time a stimulus item is responded to correctly, it is retired from the CFP activity session.

The principles of a CFP activity according to this embodiment of the present invention can be demonstrated by observing the path of several stimulus items in TABLE I. In the following discussion, the positioning of the stimulus item within TABLE I is referred to using the following notation: (x, y). In this notation, “x” corresponds to the row within TABLE I in which the stimulus item is found, and “y” corresponds to the column within TABLE I in which the stimulus item is found. In addition, the stimulus items referred to in the following discussion are shown in TABLE I in an italicized and underscored format. This formatting is used for the reader's convenience only.

The first stimulus item under observation in this example is stimulus item a. Stimulus item a is the first stimulus item presented to the learner, as shown at position (1,1) in TABLE I. Stimulus item a is represented in position (1,1) by a lowercase letter, indicating that the learner responded to stimulus item a correctly. In view of the correct response to stimulus item a, the CFP activity advances the retirement criterion counter for stimulus item a to 1, and places stimulus item a at the end of the stimulus item queue, as shown in TABLE I as position (2,14). Stimulus item a advances through the queue until, at position (19,1), it again is presented to the learner. Stimulus item a is represented in position (19,1) by a lowercase letter, indicating that the learner responded to stimulus item a correctly a second consecutive time. Thus, its retirement criterion counter is advanced to 2, and stimulus item a is retired from the CFP activity session.

The next stimulus item under observation in this example is stimulus item b. Stimulus item b is the next stimulus item presented to the learner, as shown at position (2,1) in TABLE I. Stimulus item b is represented in position (2,1) by an uppercase letter, indicating that the learner either responded incorrectly to stimulus item b, or requested the correct answer to stimulus item b. Thus, the CFP activity according to the present invention initiates increasing interval review of stimulus item b.

Increasing interval review begins with the 2-later review phase. As represented in TABLE I, stimulus item b is placed into the second position in the stimulus item queue, as shown at position (3,2). After stimulus item c (shown at position (3,1)) is presented to the learner, stimulus item b is presented to the learner at position (4,1). As shown at position (4,1) stimulus item b is represented by a lowercase letter, indicating that the learner responded to stimulus item b correctly. Thus, stimulus item b enters the 4-later review phase of increasing interval review. As represented in TABLE I, stimulus item b is placed into the fourth position in the stimulus item queue, as shown at position (5,4).

Stimulus item b advances through the queue until, at position (8,1), it again is presented to the learner. Stimulus item b is represented in position (8,1) by a lowercase letter, indicating that the learner responded to stimulus item b correctly. Stimulus item b then enters the 6-later review phase of increasing interval review. As represented in TABLE I, stimulus item b is placed into the sixth position in the stimulus item queue, as shown at position (9,6). Stimulus item b advances through the queue until, at position (14,1), it again is presented to the learner. Stimulus item b is represented in position (14,1) by a lowercase letter, indicating that the learner responded to stimulus item b correctly.

In view of the correct response to stimulus item b at each phase of increasing interval review, the CFP activity advances the retirement criterion counter for stimulus item b to 1, and places stimulus item b at the end of the stimulus item queue, as shown in TABLE I as position (15,14). Stimulus item b advances through the queue until, at position (33,1), it again is presented to the learner. Stimulus item b is represented in position (33,1) by a lowercase letter, indicating that the learner responded to stimulus item b correctly. Thus, its retirement criterion counter is advanced to 2, and stimulus item b is retired from the CFP activity session.

The next stimulus item under observation in this example is stimulus item m. Stimulus item m is first presented to the learner at position (16,1) in TABLE I. Stimulus item m is represented in position (16,1) by an uppercase letter, indicating that the learner either responded incorrectly to stimulus item m, or requested the correct answer to stimulus item m. Thus, the CFP activity initiates increasing interval review of stimulus item m.

Increasing interval review begins with the 2-later review phase. As represented in TABLE I, stimulus item m is placed into the second position in the stimulus item queue, as shown at position (17,2). After stimulus item n (shown at position (17,1)) is presented to the learner, stimulus item m is presented to the learner at position (18,1). As shown at position (18,1) stimulus item m is represented by a lowercase letter, indicating that the learner responded to stimulus item m correctly. Thus, stimulus item m enters the 4-later review phase of increasing interval review. As represented in TABLE I, stimulus item m is placed into the fourth position in the stimulus item queue, as shown at position (19,4).

Stimulus item m advances through the queue until, at position (22,1), it again is presented to the learner. Stimulus item m is represented in position (22,1) by an uppercase letter, indicating that the learner either responded incorrectly to stimulus item m, or requested the correct answer to stimulus item m. Thus, the CFP activity according to the present invention re-initiates increasing interval review of stimulus item m. As represented in TABLE I, stimulus item m is placed into the second position in the stimulus item queue, as shown at position (23,2). Stimulus item m is presented to the learner at position (24,1). As shown at position (24,1) stimulus item m is represented by a lowercase letter, indicating that the learner responded to stimulus item m correctly. Thus, stimulus item m enters the 4-later review phase of increasing interval review, and is placed into the fourth position in the stimulus item queue, as shown at position (25,4).

Stimulus item m advances through the queue until, at position (28,1), it again is presented to the learner. Stimulus item m is represented in position (28,1) by a lowercase letter, indicating that the learner responded to stimulus item m correctly. Stimulus item m then enters the 6-later review phase of increasing interval review, and is placed into the sixth position in the stimulus item queue, as shown at position (29,6).

Stimulus item m advances through the queue until, at position (36,1), it again is presented to the learner. Stimulus item m is represented in position (36,1) by a lowercase letter, indicating that the learner responded to stimulus item m correctly. In view of the correct response to stimulus item m at each phase of increasing interval review, the CFP activity advances the retirement criterion counter for stimulus item m to 1, and places stimulus item m at the end of the stimulus item queue, as shown in TABLE I as position (37,6). Stimulus item m advances through the queue until, at position (42,1), it again is presented to the learner. Stimulus item m is represented in position (42,1) by a lowercase letter, indicating that the learner responded to stimulus item m correctly. Thus, its retirement criterion counter is advanced to 2, and stimulus item m is retired from the CFP activity session.

The final stimulus item under observation in this example is stimulus item i. Stimulus item i is first presented to the learner at position (11,1) in TABLE I. Stimulus item i is represented in position (11,1) by a lowercase letter, indicating that the learner responded to stimulus item i correctly. In view of the correct response to stimulus item i, the CFP activity advances the retirement criterion counter for stimulus item i to 1, and places stimulus item i at the end of the stimulus item queue, as shown in TABLE I as position (12,14).

Stimulus item i advances through the queue until, at position (29,1), it again is presented to the learner. Stimulus item i is represented in position (29,1) by an uppercase letter, indicating that the learner either responded incorrectly to stimulus item i, or requested the correct answer to stimulus item i. Thus, the CFP activity resets the retirement criterion counter to 0, and initiates increasing interval review of stimulus item i.

Increasing interval review begins with the 2-later review phase. As represented in TABLE I, stimulus item i is placed into the second position in the stimulus item queue, as shown at position (30,2). After stimulus item j (shown at position (30,1)) is presented to the learner, stimulus item i is presented to the learner at position (31,1). As shown at position (31,1) stimulus item i is represented by a lowercase letter, indicating that the learner responded to stimulus item i correctly. Thus, stimulus item i enters the 4-later review phase of increasing interval review. As represented in TABLE I, stimulus item i is placed into the fourth position in the stimulus item queue, shown at position (32,4).

Stimulus item i advances through the queue until, at position (35,1), it again is presented to the learner. Stimulus item i is represented in position (35,1) by a lowercase letter, indicating that the learner responded to stimulus item i correctly. Stimulus item i then enters the 6-later review phase of increasing interval review.

However, as shown in row 35 of TABLE I, at the time stimulus item i enters the 6-later review phase, only three stimulus items remain in the CFP activity session. The other stimulus items have been retired. To enable 6-later review of stimulus item i, three retired stimulus items are “resurrected” and placed in front of stimulus item i in the queue. As shown in TABLE I, stimulus item b, stimulus item a, and stimulus item c, are inserted in positions (36,3), (36,4), and (36,5), respectively. Stimulus item i then is placed into the sixth position in the stimulus item queue, as shown at position (36,6).

The stimulus items to be resurrected in the event that insufficient stimulus items remain in the queue may be selected from among the retired stimulus items according to one of several methods. In an implementation, such stimulus items are selected according to their difficulty index, with the most difficult items selected from the retired stimulus items. In another implementation, such stimulus items are selected randomly from the retired stimulus items. In another implementation, the first such stimulus items to have been retired during the CFP activity session are selected. Other selection methods may be employed by the practitioner according to a particular implementation of a CFP activity. If each resurrected stimulus item is responded to correctly the next time it is presented to the learner (as shown in TABLE I), the stimulus item is “re-retired.” However, if a resurrected stimulus item is responded to incorrectly, or if the learner requests the correct response to a resurrected stimulus item, the CFP activity resets the retirement criterion counter for the resurrected stimulus item to 0, and initiates increasing interval review of the resurrected stimulus item

Stimulus item i advances through the queue until, at position (41,1), it again is presented to the learner. Stimulus item i is represented in position (41,1) by a lowercase letter, indicating that the learner responded to stimulus item i correctly. In view of the correct response to stimulus item i at each phase of increasing interval review, the CFP activity advances the retirement criterion counter for stimulus item i to 1, and places stimulus item i at the end of the stimulus item queue. Because only two stimulus items remain in the CFP activity session, the end of the stimulus item queue is shown in TABLE I as position (42,2). Stimulus item i advances through the queue until, at position (43,1), it again is presented to the learner. Stimulus item i is represented in position (43,1) by a lowercase letter, indicating that the learner responded to stimulus item i correctly. Thus, the retirement criterion counter is advanced to 2, and stimulus item i is retired from the CFP activity session.

Finally, in an unusual situation where the final remaining stimulus item must be repeated twice or three times due to the absence of retired stimulus items that are candidates for resurrection, rather than repeating the final remaining stimulus item two or three time, the retirement criterion counter is advanced to 2, and the stimulus item is retired from the CFP activity session.

The CFP activity of the present invention may be adapted for use with either “generalized” or “non-generalized” subject matter, or both. “Non-generalized” subject matter involves specific, usually discrete, facts or information. For example, in a CFP activity according to the present invention, a stimulus item comprising non-generalized subject matter might comprise the following question: “What is the capital of Ohio?” The set of possible responses would include the correct response which is, of course, “Columbus.” This stimulus-response pair is non-generalized in that it is not suggestive of any underlying concept. In other words, a correct response to the stimulus item “What is the capital of Ohio?” does not aid a learner in arriving at a correct response to the stimulus item “What is the capital of Indiana?”, even though both stimulus items relate to the identification of state capitals. Each stimulus item merely represents a specific fact the learner must memorize.

Conversely, generalized subject matter involves generalizations or concepts which underlie facts or information. In a CFP activity according to the present invention, generalized subject matter comprises “critical features” and “variable features.” Critical features are common to every instantiation of the generalized subject matter. Variable features may differ between instantiations of the generalized subject matter. For example, if the generalized subject matter is a coffee cup, critical features may be a receptacle capable of retaining a volume of coffee, and which is fillable and drainable through an opening. All coffee cups have the same critical features. Variable features of a coffee cup include a handle, the volume of the receptacle, the size of the opening for filling and/or draining the receptacle, the material from which the receptacle is constructed, the color of the receptacle, the shape of the receptacle, etc. A coffee cup can possess the variable features in many varieties and combinations, and still be a coffee cup as long as the critical features are present. This example is merely illustrative of the concept of generalized subject matter, and is not reflective of the level of complexity of generalized subject matter for which a CFP activity of the present invention may be adapted. As noted previously herein, the design of a particular implementation of a CFP activity according to the present invention is left to the discretion of the practitioner. If the practitioner so desires, generalized subject matter may comprise, for example, complex mathematical or scientific principles.

In a CFP activity according to the present invention comprising generalized subject matter, one or more stimulus items may be adapted so that the correct response to each of the plurality of stimulus item reflects consistent critical features of the generalized subject matter, but also so that the correct response to each of the one or more stimulus items includes variable features that change from one stimulus item to the next. For example, in a CFP activity according to the present invention, one or more stimulus items comprising generalized subject matter may comprise the following statement: “Select the parabolic equation from the equations listed below.” The set of possible responses would include a correct response, such as “y=x².” However, “y=x²”, is but one of an infinite number of equations which may be a possible correct response to this stimulus item. For example, any of the following equations also could be a correct response:

y=−x²

y=x²+3

y=−x²+5

y=(x−2)²

y=(x−7)²+2

y=−(x−4)²

y=−(x−1)²+6

The difference between the application of a CFP activity according to the present invention to generalized and non-generalized subject matter becomes most apparent when a stimulus item is marked for increasing interval review. For a stimulus item comprising non-generalized subject matter, the set of possible responses always will include the same correct response. For example, if the stimulus item is “What is the capital of Ohio?” the set of possible responses always includes “Columbus.” If the learner responds incorrectly to this stimulus item the first time it is presented, it is marked for increasing interval review. When the stimulus item is next presented during 2-later review, the set of possible responses still includes the correct response “Columbus.” The same is true in 4-later and 6-later review.

For a stimulus item comprising generalized subject matter, the concept underlying the response is consistent between multiple instances of the stimulus item, but the correct response to the stimulus item may differ each time. For example, if the stimulus item is “Select the parabolic equation from the equations listed below,” the first set of responses may include as the correct response “y=x².” If the learner responds incorrectly to this stimulus item the first time it is presented, it is marked for increasing interval review. However, when this same question appears in 2-later, 4-later and 6-later review, a different correct response may appear for the same stimulus item. For example, when the stimulus item is next presented in 2-later review, the set of possible responses may include the correct response “y=x²+4,” instead of “y=x².” When the stimulus item is presented in 4-later review, the set of possible responses may include an alternative correct response, such as “y=−(x−5)².” Likewise, in 6-later review the set of possible responses may include another alternative correct response, such as “y=−x².” A learner would need to respond correctly to all three increasing interval review stimulus items before the retirement criterion counter for the stimulus item is incremented. Thus, the learner has to demonstrate a grasp of the underlying critical features of the generalized subject matter before the stimulus item is retired.

A CFP activity may be adapted for other forms of generalized subject matter. For example, in a reading comprehension practice session, the stimulus item might be: “Identify the subject of the following sentence: ‘Jim went to the store.’” The correct response, of course, is “Jim.” But if this stimulus item is repeated during increasing interval review, the learner may focus inappropriately on the finding the response “Jim” as opposed to understanding the underlying grammatical/syntactical structure of this sentence.

To avoid this problem and to aid the learner in understanding the generalized concept, elements of the stimulus item may change each time the stimulus item is present to the learner. For example, when the stimulus item is presented in 2-later review, the stimulus item may be the following: “Identify the subject of the following sentence: ‘Marc biked to the theater.’” When the stimulus item is presented in 4-later review, the stimulus item may be the following: “Identify the subject of the following sentence: ‘Carmen and Leslie rode to the park.’” In 6-later review the stimulus item may be the following: “Identify the subject of the following sentence: ‘Ruth ran to the train station.’” The set of possible responses would be adapted accordingly.

In an embodiment, a CFP activity may have stimulus items comprising both generalized and non-generalized subject matter. In addition, a CFP activity may use randomization. For example, a CFP activity comprising a plurality of possible responses may employ an adaptation of the “within-question” randomization techniques described elsewhere herein to vary the set of possible responses in multiple instances of the same stimulus item.

A CFP activity also may use randomization to vary the stimulus item itself where the stimulus item is directed toward generalized subject matter. For example, the stimulus item: “Identify the subject of the following sentence: ‘Jim went to the store.’” can be restructured using variables as follows: “Identify the subject of the following sentence: ‘[noun] [verb] to the [object].’” Retrievably stored in database 106 are a plurality of values for each variable. For example, for the variable [noun], database 106 could contain the possible values {Jim, Mary, Ruth, Marc, Carmen and Leslie, Paul}. For the variable [verb], database 106 could contain the possible values {went, rode, biked, skipped, ran, walked}. For the variable [object], database 106 could contain the possible values {store, shopping mall, theater, school, park, train station}. When the stimulus item is presented to the learner, the system of the present invention is operable to randomly retrieve one value from the database for each variable to construct the stimulus item.

TABLE I
COMPUTER FACILITATED PRACTICE ACTIVITY SESSION

| | QUEUE POSITION OF STIMULUS ITEM | | | | | | | | | | | | | | |
|---|---|---|---|---|---|---|---|---|---|---|---|---|---|---|---|
| | # | 1 | 2 | 3 | 4 | 5 | 6 | 7 | 8 | 9 | 10 | 11 | 12 | 13 | 14 |
| STIMULUS- | 1 | a | b | c | d | e | f | g | h | i | j | k | l | m | n |
| RESPONSE | 2 | B | c | d | e | f | g | h | i | j | k | l | m | n | a |
| ITERATION | 3 | c | b | d | e | f | g | h | i | j | k | l | m | n | a |
| | 4 | b | d | e | f | g | h | i | j | k | l | m | n | a | c |
| | 5 | d | e | f | b | g | h | i | j | k | l | m | n | a | c |
| | 6 | e | f | b | g | h | i | j | k | l | m | n | a | c | d |
| | 7 | f | b | g | h | i | j | k | l | m | n | a | c | d | e |
| | 8 | b | g | h | i | j | k | l | m | n | a | c | d | e | f |
| | 9 | g | h | i | j | k | b | l | m | n | a | c | d | e | f |
| | 10 | h | i | j | k | b | l | m | n | a | c | d | e | f | g |
| | 11 | i | j | k | b | l | m | n | a | c | d | e | f | g | h |
| | 12 | j | k | b | l | m | n | a | c | d | e | f | g | h | i |
| | 13 | k | b | l | m | n | a | c | d | e | f | g | h | i | j |
| | 14 | b | l | m | n | a | c | d | e | f | g | h | i | j | k |
| | 15 | l | m | n | a | c | d | e | f | g | h | i | j | k | b |
| | 16 | M | n | a | c | d | e | f | g | h | i | j | k | b | l |
| | 17 | n | m | a | c | d | e | f | g | h | i | j | k | b | l |
| | 18 | m | a | c | d | e | f | g | h | i | j | k | b | l | n |
| | 19 | a | c | d | m | e | f | g | h | i | j | k | b | l | n |
| | 20 | c | d | m | e | f | g | h | i | j | k | b | l | n | |
| | 21 | d | m | e | f | g | h | i | j | k | b | l | n | | |
| | 22 | M | e | f | g | h | i | j | k | b | l | n | | | |
| | 23 | e | m | f | g | h | l | j | k | b | l | n | | | |
| | 24 | m | f | g | h | i | j | k | b | l | n | | | | |
| | 25 | f | g | h | m | i | j | k | b | l | n | | | | |
| | 26 | g | h | m | l | j | k | b | l | n | | | | | |
| | 27 | h | m | i | j | k | b | l | n | | | | | | |
| | 28 | m | i | j | k | b | l | n | | | | | | | |
| | 29 | I | j | k | b | l | m | n | | | | | | | |
| | 30 | j | i | k | b | l | m | n | | | | | | | |
| | 31 | i | k | b | l | m | n | | | | | | | | |
| | 32 | k | b | l | i | m | n | | | | | | | | |
| | 33 | b | l | i | m | n | | | | | | | | | |
| | 34 | l | i | m | n | | | | | | | | | | |
| | 35 | i | m | n | | | | | | | | | | | |
| | 36 | m | n | b | a | c | i | | | | | | | | |
| | 37 | n | b | a | c | i | m | | | | | | | | |
| | 38 | b | a | c | i | m | | | | | | | | | |
| | 39 | a | c | i | m | | | | | | | | | | |
| | 40 | c | i | m | | | | | | | | | | | |
| | 41 | i | m | | | | | | | | | | | | |
| | 42 | m | i | | | | | | | | | | | | |
| | 43 | i | | | | | | | | | | | | | |

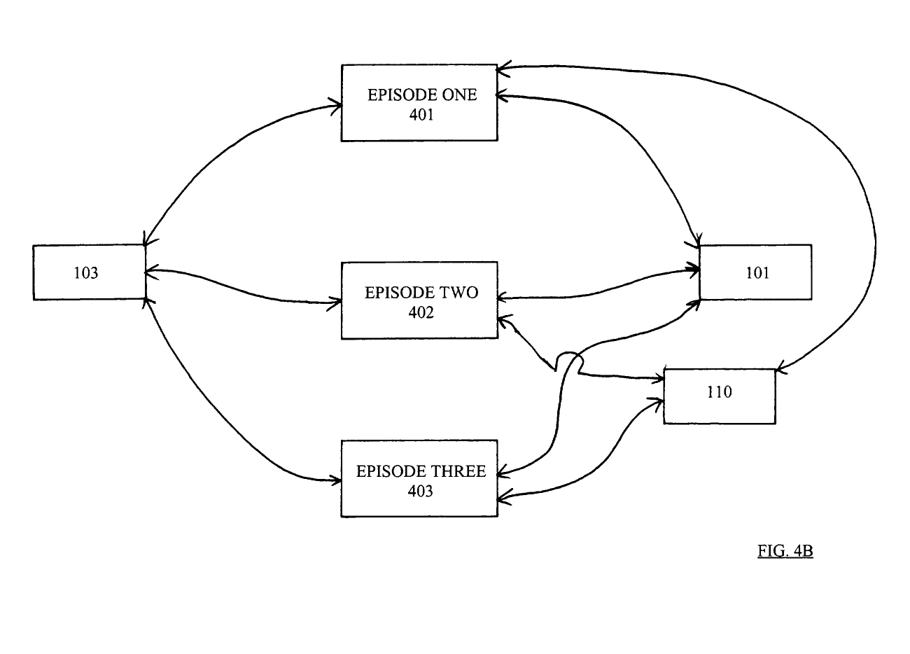

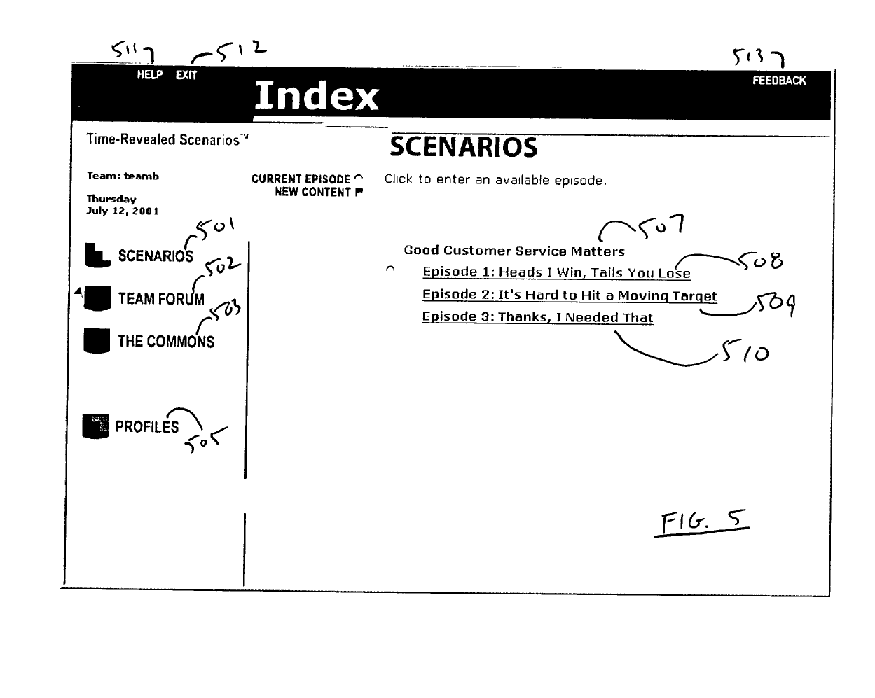

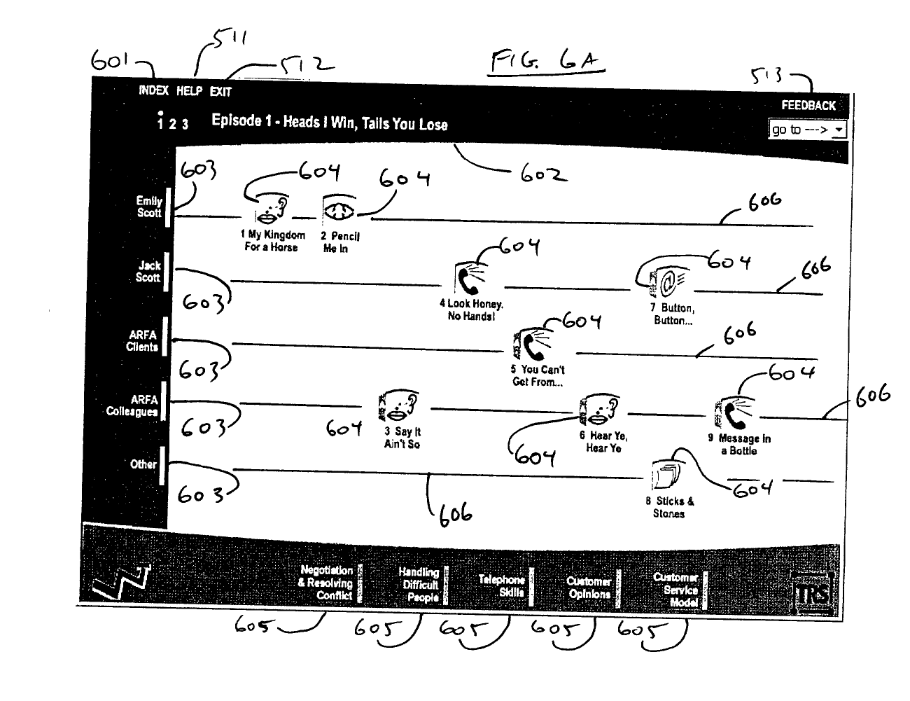

Referring now to FIG. 4A, there is shown a flow chart illustrating the operation of an embodiment of the method of the present invention. Shown in FIG. 4A is a scenario according to the present invention comprising three episodes. Also shown in FIG. 4A is host server 101 and client computer 103. In the step shown as block 401 of FIG. 4A, host server 101 and a learner (not shown) operating client computer 103, having previously established bidirectional communication between host server 101 and client computer 103 through network 102 (which in this embodiment comprises the Internet), interact to complete the first episode of the scenario. During this interaction, display pages comprising the episode are transmitted from host server 101 through network 102 and received by client computer 103. At client computer 103, the display pages are displayed on the video display means of client computer 103. Such display pages comprise, for example, events, resources, activities, and character profiles pertaining to the first episode of the scenario. As further discussed herein, each display page comprising an event comprises content relevant to the first episode of the scenario, with a learner responding to such content in accordance with the instructions which may be contained therein.

After completing the first episode of the scenario (shown in FIG. 4A as block 401), in the step shown as block 402, host server 101 and the learner operating client computer 103 interact to complete the second episode of the scenario. As before, during this interaction, display pages comprising the episode are transmitted from host server 101 through network 102 and received by client computer 103. At client computer 103, the display pages are displayed on the video display means of client computer 103. Such display pages comprise, for example, events, resources, activities, and character profiles pertaining to the second episode of the scenario. Each display page comprising an event comprises content relevant to the second episode of the scenario, with the learner responding to such content in accordance with the instructions which may be contained therein.

Finally, in the step shown as block 403 of FIG. 4A, host server 101 and the learner operating client computer 103 interact to complete the third episode of the scenario. As before, during this interaction, display pages comprising the episode are transmitted from host server 101 through network 102 and received by client computer 103. At client computer 103, the display pages are displayed on the video display means of client computer 103. Such display pages comprise, for example, events, resources, activities, and character profiles pertaining to the third episode of the scenario. Each display page comprising an event comprises content relevant to the third episode of the scenario, with the learner responding to such content in accordance with the instructions which may be contained therein.

FIG. 4B shows a flow chart illustrating the operation of a second embodiment of the method of the present invention. Shown in FIG. 4B are blocks 401, 402, and 403 as shown in FIG. 4A. As before each block represents one episode of a scenario according to the present invention. Also shown in FIG. 4B is host server 101 and client computer 103 as shown in FIG. 4A. FIG. 4B also shows client computer 110 operated by a facilitator.

According to this embodiment, in the step shown as block 401 of FIG. 4B, host server 101 and a learner (not shown) operating client computer 103, having previously established bi-directional communication between host server 101 and client computer 103 through network 102 (which in this embodiment comprises the Internet), interact to complete the first episode of the scenario. In addition, host server 101 and the facilitator (not shown) operating client computer 110, having previously established bi-directional communication between host server 101 and client computer 110 through network 102, also interact during the first episode of the scenario, as further discussed herein. During this interaction, display pages are transmitted from host server 101 through network 102 and received by client computer 103 and client computer 110. At client computer 103 and client computer 110, the display pages are displayed on the video display means thereof in a manner perceivable by the learner or the facilitator, as the case may be. The facilitator operating client computer 110 also is able to interact with the learner operating client computer 103 as the learner completes the first episode of the scenario.

FIG. 4B also shows the facilitator operating client computer 110 interacting with host server 101, and with the learner operating client computer 103, during the second episode of the scenario (shown in the step shown as block 402 of FIG. 4B), and during the third episode of the scenario (shown in the step shown as block 403 of FIG. 4B).

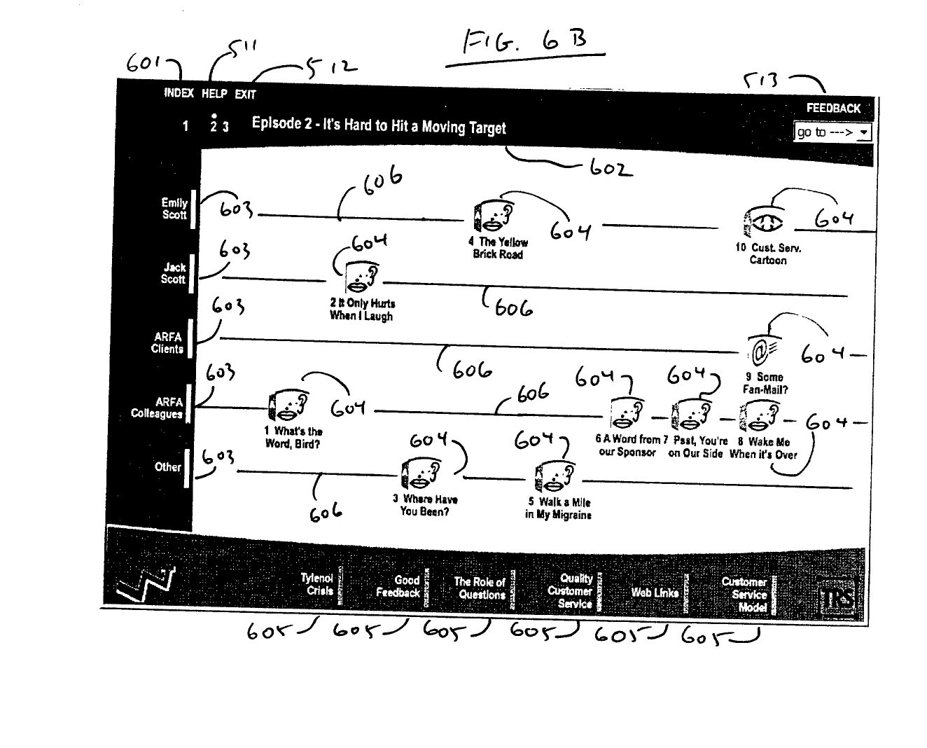

Referring now to FIG. 5, according to an embodiment of the present invention, after host server 101 and client computer 103 are in bidirectional communication, the first display page transmitted from host server 101 to client computer 103 through network 102 and displayed on the video display means of client computer 103 after a learner requests access to the scenario hosted by host server 101 comprises a “home page” for the scenario. FIG. 5 shows a pictorial view of an exemplary display page comprising a possible home page for a scenario according to one possible implementation of this embodiment. It will be appreciated by these of ordinary skill in the art that the display page shown in FIG. 5, and the other display pages shown and described hereinafter, are provided to show one possible implementation of the principles of the present invention which are represented by the display page. The design of the display pages comprising a scenario according to a particular implementation of the present invention are left to the discretion of the practitioner, and may vary widely from an implementation to another.

Shown in FIG. 5 are graphical user interface button 501 labeled “SCENARIOS,” graphical user interface button 502 labeled “TEAM FORUM,” graphical user interface button 503 labeled “THE COMMONS,” graphical user interface button 505 labeled “PROFILE,” graphical user interface button 511 labeled “HELP,” graphical user interface button 512 labeled “EXIT,” and graphical user interface button 513 labeled “FEEDBACK.” Graphical user interface buttons 511, 512, and 513 comprise a toolbar.

Selecting any of these graphical user interface buttons causes host server 101 and client computer 103 to execute computer instructions causing another display page to be transmitted from host server 101 to client computer 103 through network 102, and to be displayed on the video display means of client computer 103. For example, selecting button 501 causes a display page such as the home page shown in FIG. 5 to be displayed. Selecting button 502 causes a display page comprising a feature of the present invention called a “team forum” (discussed further hereinafter) to be displayed. Selecting button 503 causes a display page comprising a feature of the present invention called a “common forum” (discussed further hereinafter) to be displayed. Selecting button 505 causes a display page comprising information about a participant's profile (discussed further hereinafter) to be displayed. Selecting button 511 causes a display page comprising helpful information about the present invention or about the scenario to be displayed. Selecting button 512 causes a display page to be displayed which permits a learner to leave the scenario and to end bidirectional communication between client computer 103 and host server 101. Selecting button 513 causes a display page to be displayed which permits a learner to deliver feedback to the system operator or the facilitator. Buttons 511, 512, and 513 appear on a plurality of display pages in this implementation of the present invention, and always comprise the same functionality.

Also shown in FIG. 5 are scenario title 507, labeled “Good Customer Service Matters,” and hyperlinks 508, 509, and 510. Hyperlinks 508, 509, and 510 correspond to episode 1, episode 2, and episode 3 of the scenario, respectively. Selecting any of hyperlink 508, hyperlink 509, or hyperlink 510 causes host server 101 and client computer 103 to execute computer instructions causing another display page to be transmitted from host server 101 to client computer 103 through network 102, and to be displayed on the video display means of client computer 103. Such a display page is called an “episode display page.” The episode display page displayed after selection of hyperlink 508 comprises the first episode of the scenario. Thus, selecting hyperlink 508 corresponds to beginning the step shown as block 401 in FIG. 4A or FIG. 4B. Likewise, selecting hyperlink 509 corresponds to beginning the step shown as block 402 in FIG. 4A or FIG. 4B., and selecting hyperlink 510 corresponds to beginning the step shown as block 403 in FIG. 4A or FIG. 4B.

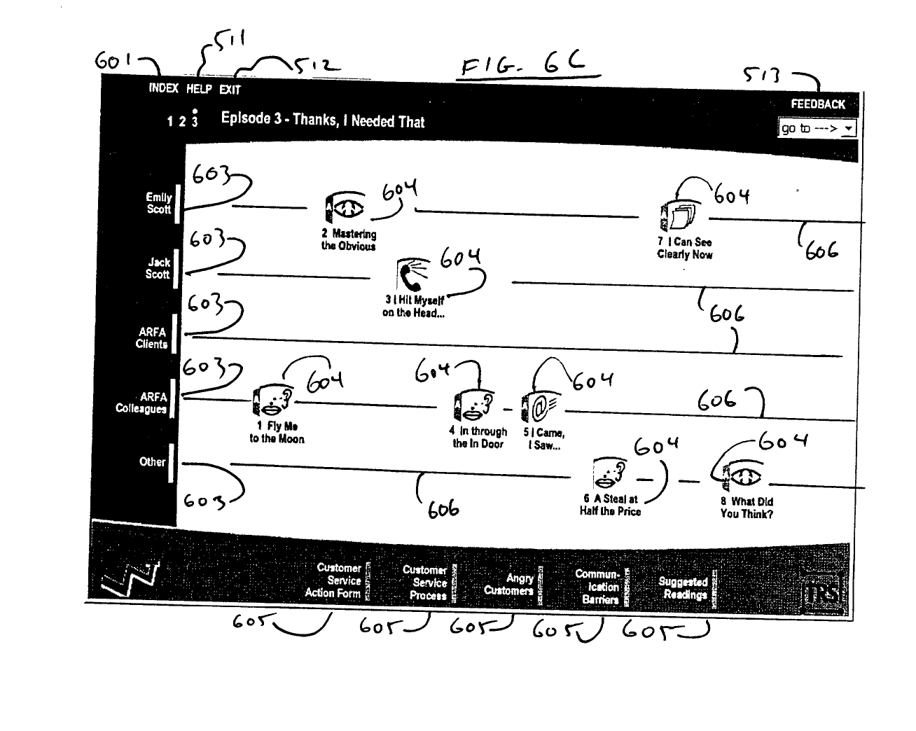

FIG. 6A shows a pictorial view of an episode display page which may be displayed when a learner selects hyperlink 508 of FIG. 5. Shown in FIG. 6A is title bar 602, labeled “Episode 1—Heads I Win, Tails You Lose.” Also shown in FIG. 6A is a toolbar comprising graphical user interface buttons 511, 512, 513, and 601, labeled “INDEX.” Selecting button 601 causes host server 101 and client computer 103 to execute computer instructions causing a display page comprising a home page for the scenario to be transmitted from host server 101 to client computer 103 through network 102, and to be displayed on the video display means of client computer 103.

Also shown in FIG. 6A is a character profile toolbar, comprising a plurality of graphical user interface character profile buttons 603 corresponding to characters in the scenario. Shown are graphical user interface character profile buttons 603 labeled “Emily Scott,” “Jack Scott,” “ARFA Clients,” “ARFA Colleagues,” and “Other.”

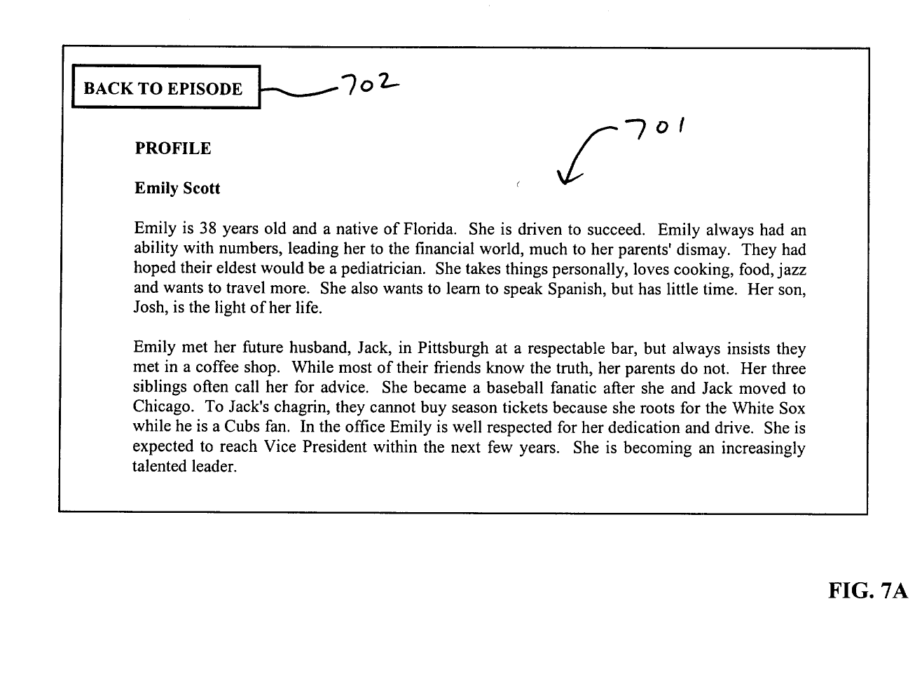

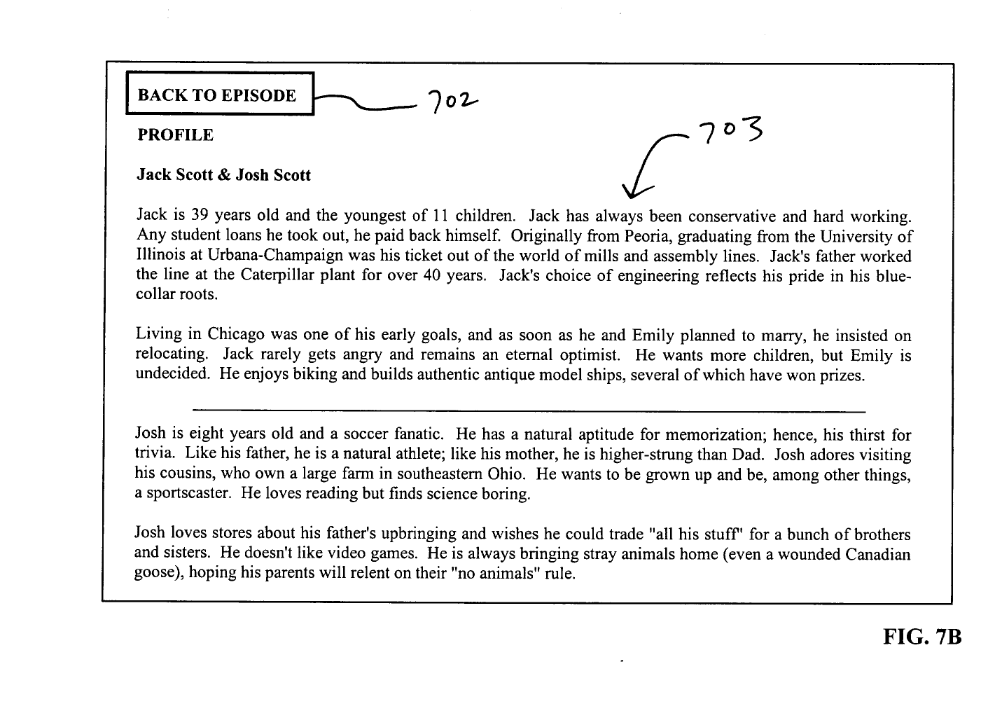

Referring now to FIG. 7A, there is shown a pictorial view of an exemplary display page which may be transmitted from host server 101 to client computer 103 through network 102, and displayed on the video display means of client computer 103 if a learner selects the character profile button 603 labeled “Emily Scott.” Shown in FIG. 7A is character profile 701 and graphical user interface button 702 labeled “BACK TO EPISODE.” Selecting button 702 causes the previous display page, such as, for example, the episode display page shown in FIG. 6A, to be displayed on the video display means of client computer 103.

Likewise, FIGS. 7B and 7C shows a pictorial views of display pages which may be displayed when a learner selects the character profile button 603 labeled “Jack Scott” or “ARFA Colleagues,” respectively. Shown in FIG. 7B are character profile 703 and graphical user interface button 702. Shown in FIG. 7C are character profile 704 and graphical user interface button 702.

Referring back to FIG. 6A, a plurality of episode event buttons 604 are shown. Each episode event button, if selected, causes a display page to be transmitted from host server 101 to client computer 103 through network 102, and to be displayed on the video display means of client computer 103. The display page displayed on client computer 103 after selection of an episode event button comprises the first display page of an event.

In the episode display page shown in FIG. 6A, nine episode event buttons 604 are shown. Each episode event button 604 corresponds to one episode event. Episode event buttons 604 are arranged chronologically on the display page, with those representing episode events occurring earlier in time placed to the left of those representing episode events occurring later in time. This arrangement is preferred, but not required. Each episode event button also is arranged along a timeline 606 which relates to a character profile button 603. Preferably, the episode event button is arranged along a timeline 606 which relates to a character profile button 603 associated with a character playing an important role in the episode event.

Also shown in FIG. 6A is a “knowledge layer” comprising a plurality of graphical user interface resource buttons 605. If selected, a graphical user interface resource button 605 causes a display page comprising at least one resource to be transmitted from host server 101 to client computer 103 through network 102, and to be displayed on the video display means of client computer 103.

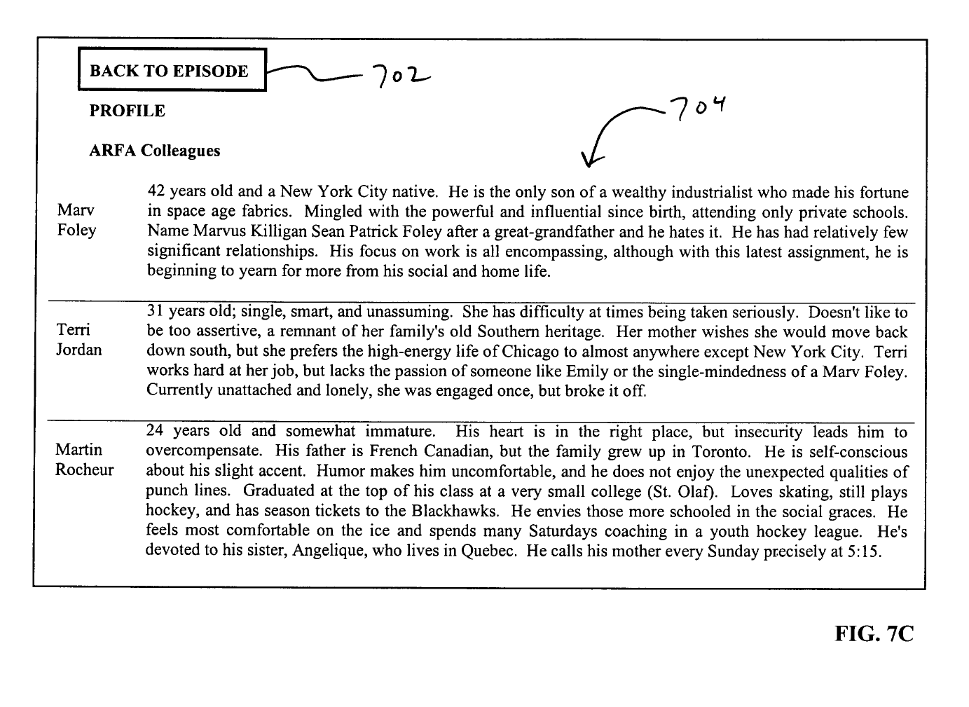

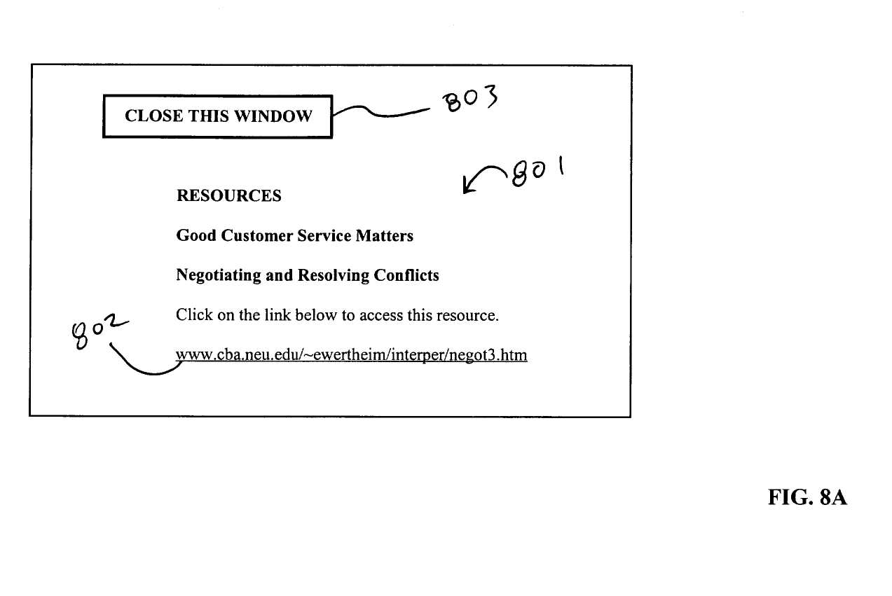

Referring now to FIG. 8A, there is shown a pictorial view of an exemplary display page which may be displayed on the video display means of client computer 103 when a learner selects the resource button labeled “Negotiating and Resolving Conflicts.” Shown in FIG. 8A is resource block 801 comprising resource hyperlink 802, and graphical user interface button 803 labeled “CLOSE THIS WINDOW.”

When selected by a learner, resource hyperlink 802 causes a request for a display page hosted by a third party computer server to be transmitted to such third party computer server through network 102. Network 102 and the third party computer server respond to such request, and the requested display page is transmitted to client computer 103 through network 102, and is displayed on the video display means of client computer 103.

FIG. 8B shows a pictorial view of an exemplary display page comprising resource 804, which may be displayed on the video display means of client computer 103 when a learner selects the resource button labeled “Customer Service Model.” In the display page shown in FIG. 8B, no hyperlink is required to request a display page comprising the resource from a third party computer server. Also shown is graphical user interface button 803.

Referring back to FIG. 6B, there is shown a pictorial view of an episode display page which may be displayed on client computer 103 when a learner selects the hyperlink 509 of FIG. 5. Similarly, FIG. 6C shows a pictorial view of an episode display page which may be displayed on client computer 103 when a learner selects hyperlink 510 of FIG. 5.

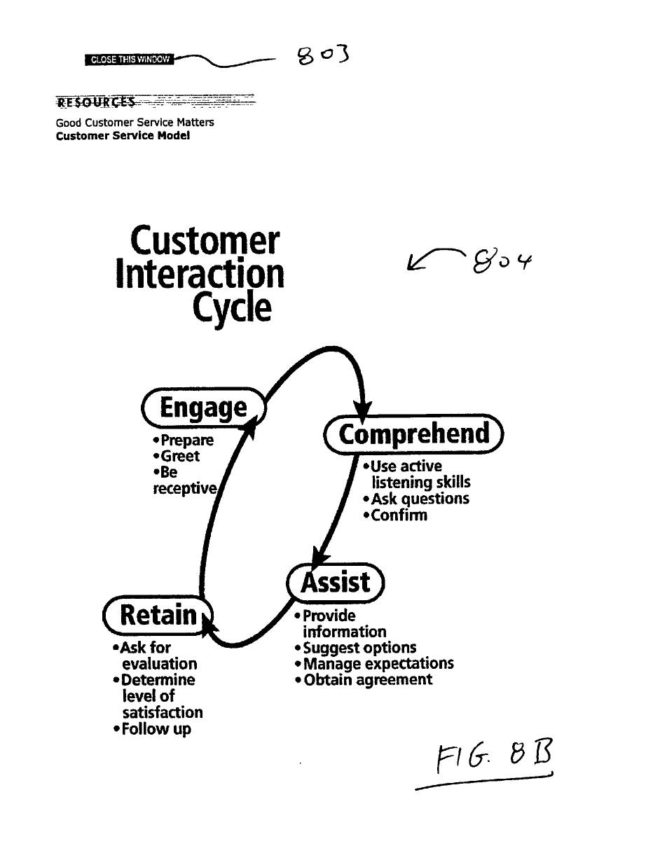

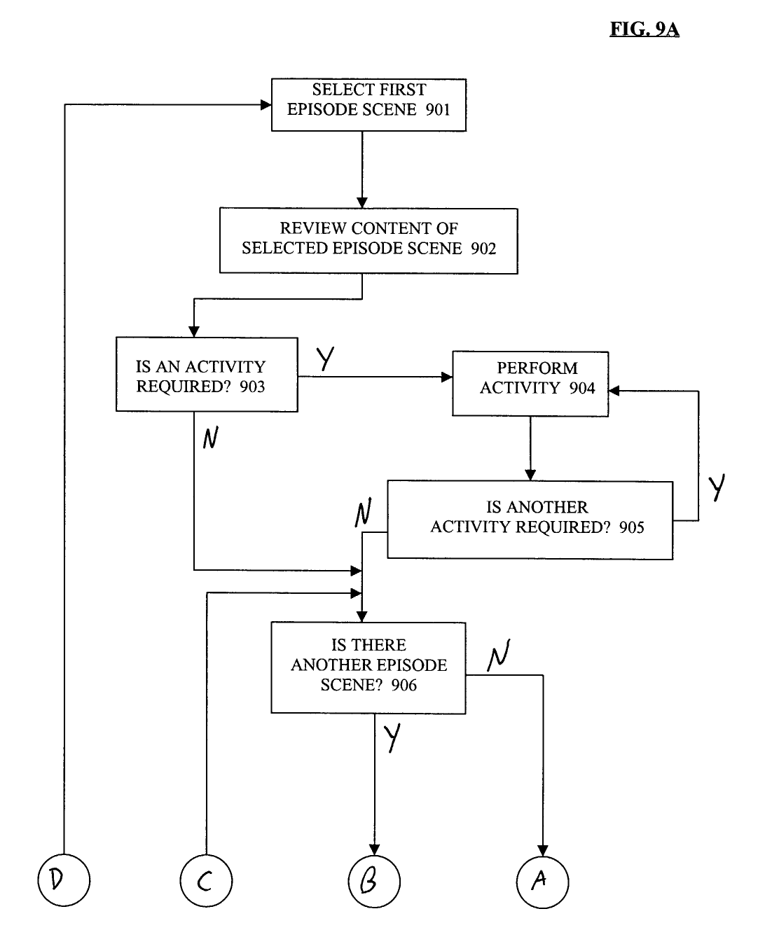

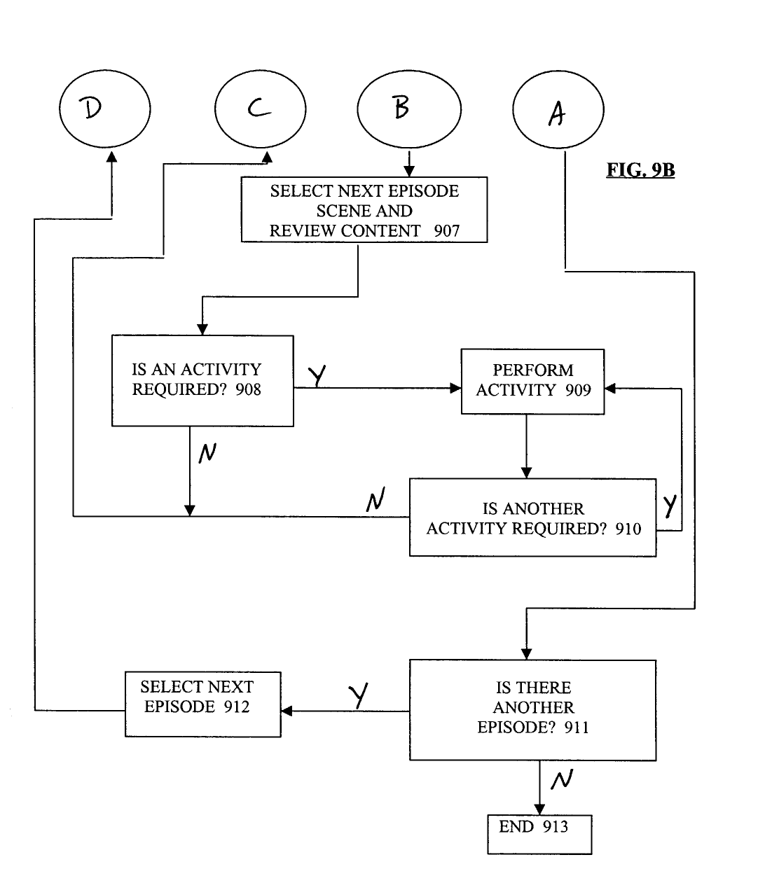

Referring now to FIGS. 9A-B, there is shown a flow chart illustrating a method which may be followed by a learner to complete an episode according to an embodiment of the present invention. In the step shown as block 901, the learner selects a first episode event. Referring back to FIG. 6A, the step shown as block 901 corresponds with, for example, the selection of the episode event button 604 labeled “1. My Kingdom for a Horse.”

In the step shown as block 902, the learner reviews the content of the episode event selected in block 901. In the step shown as block 903, the learner determines whether a first activity is to be performed in conjunction with the episode event. If so, in the step shown as block 904 the learner performs such activity in accordance with the instructions provided. After completion of the activity, in the step shown as block 905 the learner determines whether another activity must be performed to complete the episode event. If there is another activity to be performed, the flow returns to the step shown as block 904, where the learner performs such other activity in accordance with the instructions provided. The flow then returns to the step shown as block 905, where the user again determines whether another activity is required to complete the episode event.

However, if in the step shown as block 903 the learner determines that the event does not require a first activity, or if in the step shown as block 905 the learner determines that the event does not require another activity, the flow proceeds to the step shown as block 906. In the step shown as block 906, the learner determines whether another episode event is required to complete the episode. If not, the flow proceeds to the step shown as block 911, where the user determines whether another episode is available. If not, the scenario ends in the step shown as block 913. If another episode is available, in the step shown as block 912 the learner selects and performs the next episode by, for example, following the method shown in FIGS. 9A-B.

Referring back to the step shown as block 906, if the learner determines that another episode event is required, the learner reviews the content of the episode event in the step shown as block 907, and determines, in the step shown as block 908, whether a first activity is required. If a first activity is required, in the step shown as block 909 the learner performs the activity and then determines, in the step shown as block 910, whether another activity is required. If there is another activity to be performed, the flow returns to the step shown as block 909 where the learner performs such other activity in accordance with the instructions provided. The flow then returns to the step shown as block 910, where the user again determines whether another activity is required to complete the episode event.

However, if in the step shown as block 908 the learner determines that the event does not require a first activity, or if in the step shown as block 910 the learner determines that the event does not require another activity, the flow proceeds to the step shown as block 906. In the step shown as block 906, the learner determines whether another episode event is required to complete the episode. Depending on the presence or absence of another episode event, the flow proceeds either to the step shown as block 907 or to the step shown as block 911, as previously described herein.

Referring now to FIG. 10, there is shown a pictorial view of an exemplary display page comprising an episode event. The display page shown in FIG. 10 comprises a display page which may be displayed on the video display means of client computer 103 if the learner selects the episode event button 604 labeled “1. My Kingdom for a Horse” in FIG. 6A, selection of which corresponds to the step shown as block 901 of FIG. 9.

Shown in FIG. 10 are buttons 511, 512, 513, 601, 702, and a knowledge layer comprising a plurality of resource buttons 605. Each comprises the functionality previously described herein. Also shown in FIG. 10 is background section 1001, and content section 1002. Together, background section 1001, and content section 1002 comprises the scene content.

Background section 1001 comprises information which establishes the context within which the episode event takes place. Background section 1001 comprises character hyperlink 1003, labeled “Emily,” and character hyperlink 1004 labeled “Jack.” If a learner selects character hyperlink 1003, a display page comprising the character profile corresponding to the label (such as that shown in FIG. 7A) is displayed. Likewise, if a learner selects character hyperlink 1004, a display page comprising the character profile corresponding to the label (such as that shown in FIG. 7B) is displayed. Content section 1002 comprises a dialogue between two characters. After reading the scene content, the learner may select button 702 to return to the episode display page.

In addition to or in lieu of button 702, a display page comprising an episode event according to the present invention may comprise one or more graphical user interface buttons comprising functionality enabling a learner to request a display page comprising the episode event immediately preceding and/or immediately succeeding the episode event then displayed on the client computer's video display means. Such buttons may be labeled, for example, “BACK” and “FORWARD,” or “PREVIOUS EVENT” and “NEXT EVENT.”

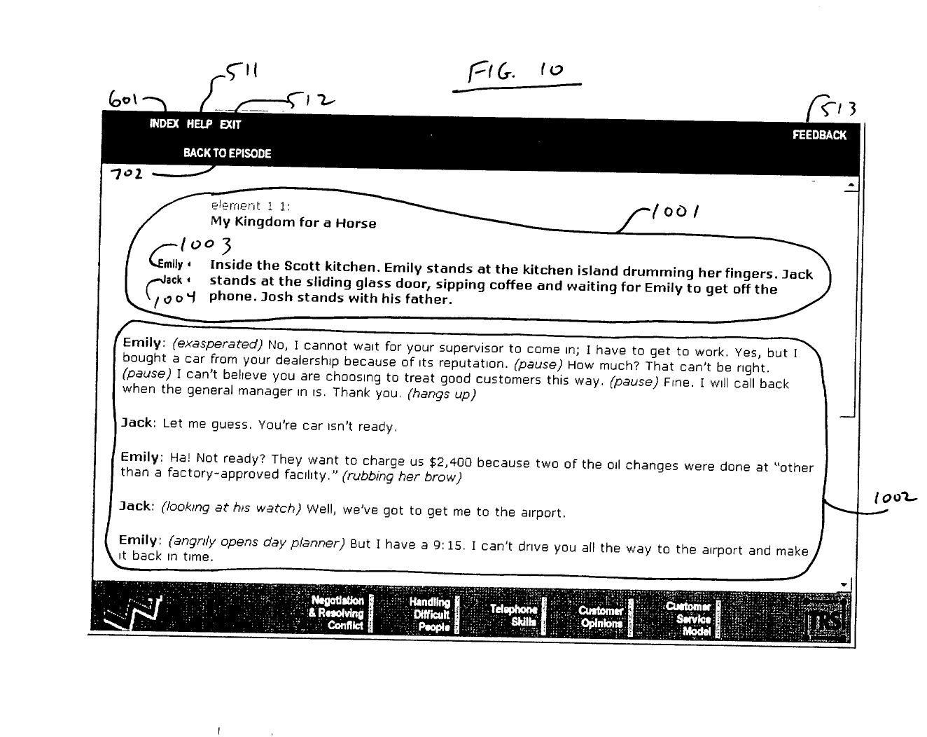

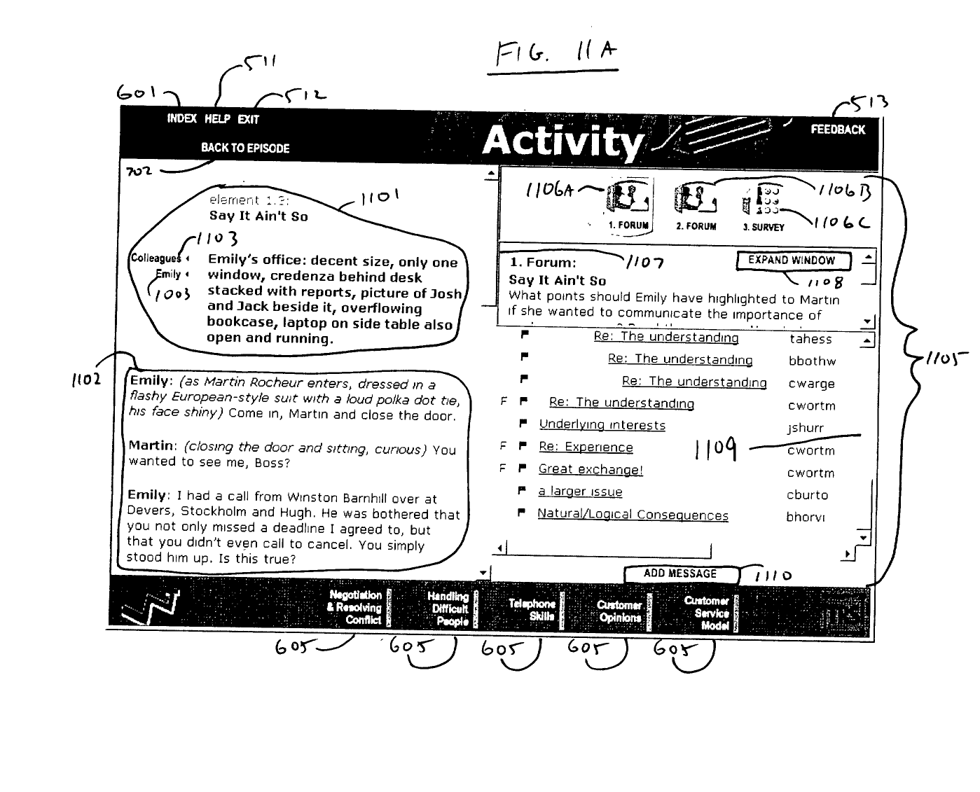

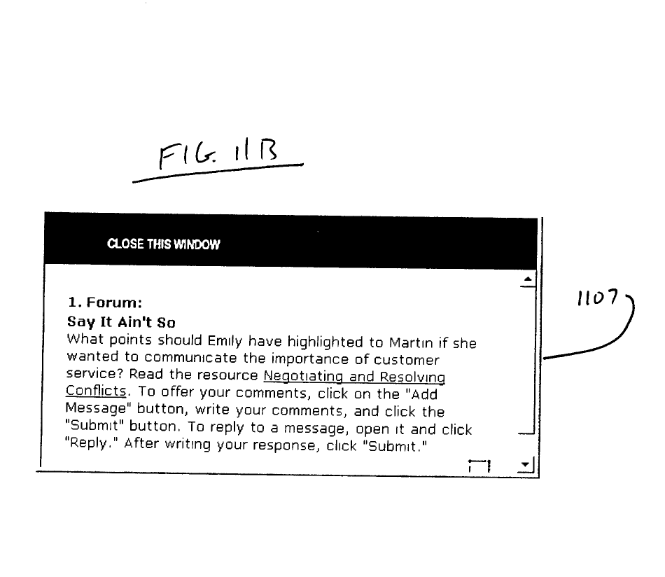

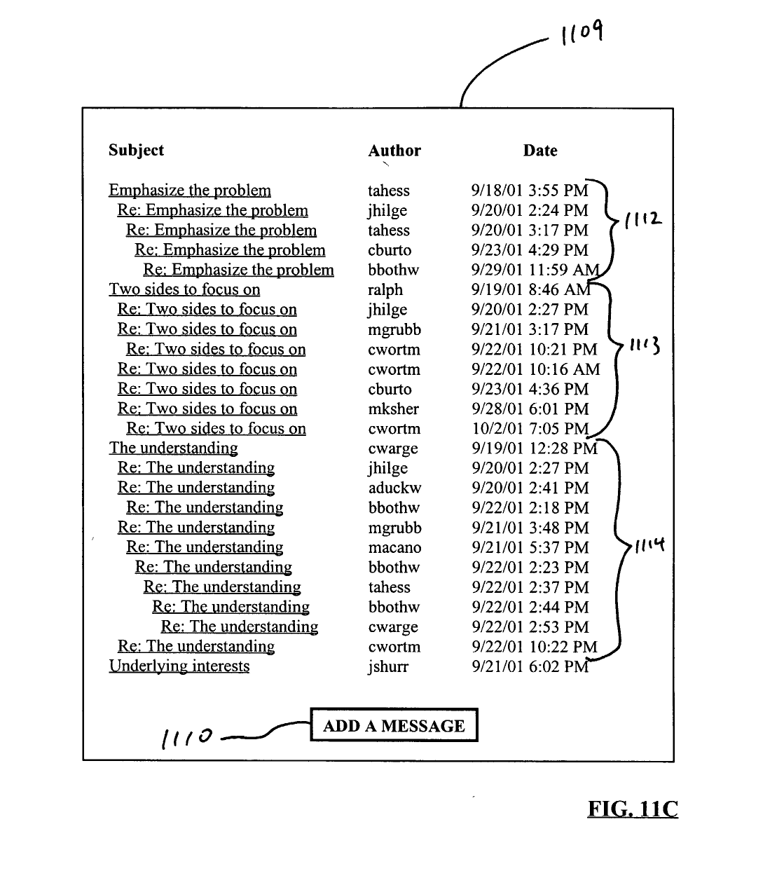

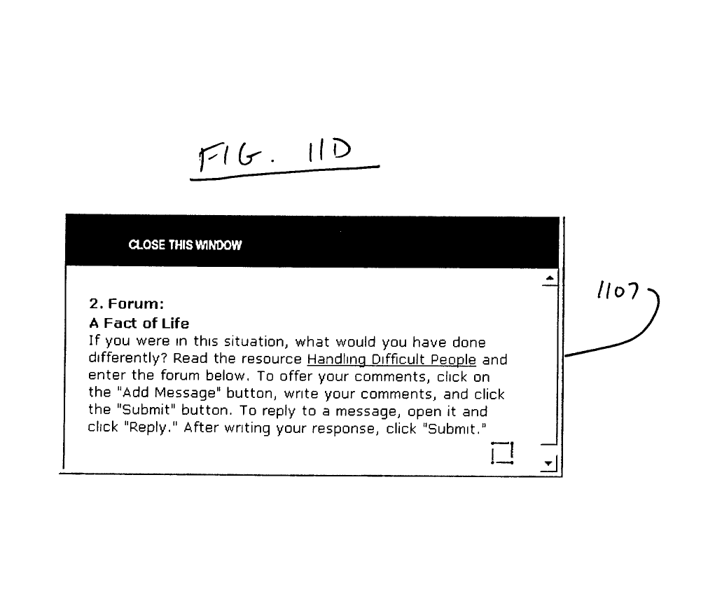

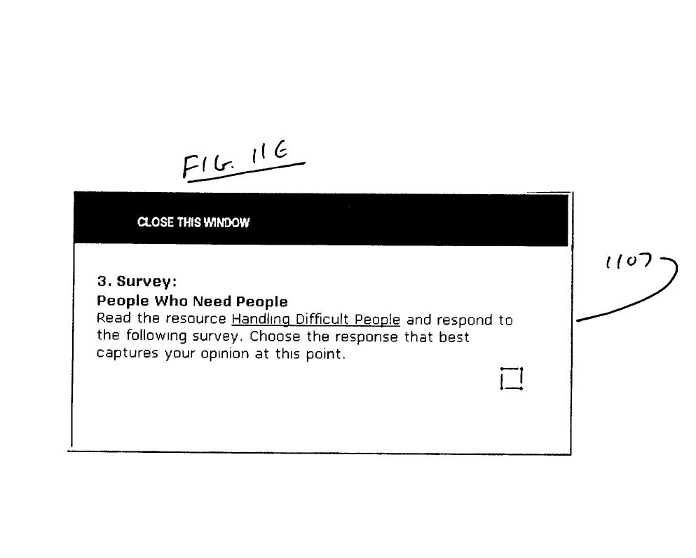

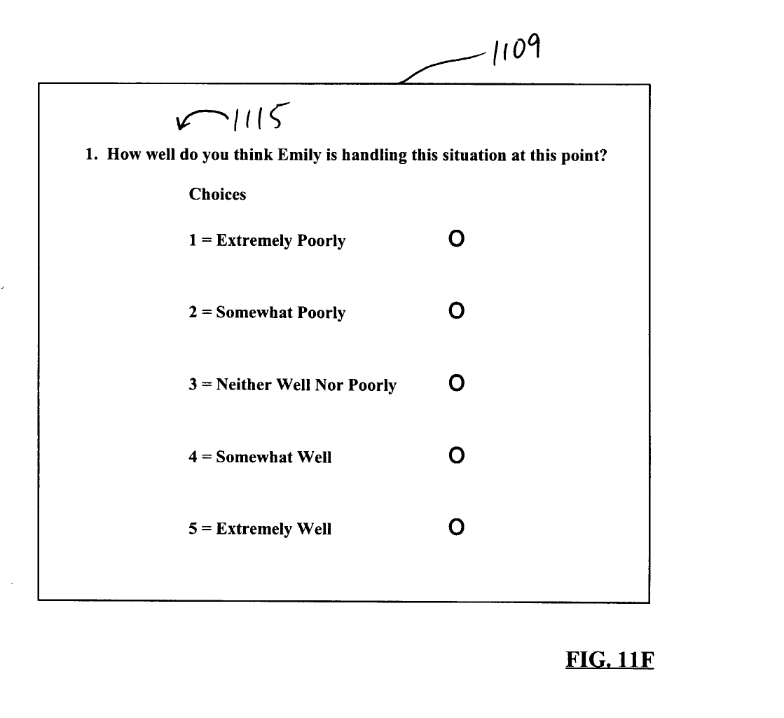

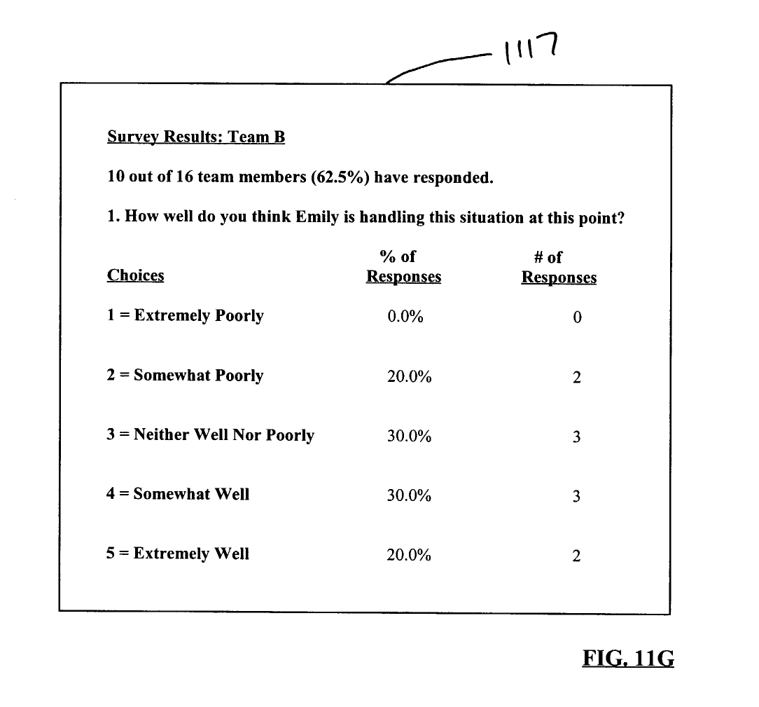

FIG. 11A shows a pictorial view of an exemplary display page comprising an episode event according to the present invention. The display page shown in FIG. 11A comprises a display page which may be displayed on the video display means of client computer 103 if a learner selects the episode event button 604 labeled “3. Say It Ain't So” in FIG. 6A. Shown in FIG. 11A are buttons 511, 512, 513, 601, 702, and a knowledge layer comprising a plurality of resource buttons 605. Each comprises the functionality previously described herein. Also shown in FIG. 11A is background section 1101 comprising character hyperlinks 1003 and 1103, and content section 1102 comprising a dialogue between two characters. Together, background section 1101 and content section 1102 comprise the scene content.

Also shown in FIG. 11A is activity section 1105. The episode event shown in FIG. 11A comprises three activities. Activity section 1105 comprises graphical user interface button 1106A labeled “FORUM,” graphical user interface button 1106B labeled “FORUM,” graphical user interface button 1106C labeled “SURVEY,” activity description window 1107, and graphical user interface button 1108 labeled “EXPAND WINDOW.” Each of buttons 1106A, 1106B, and 1106C corresponds to a different activity to be completed as part of the episode event. Also shown in activity section 1105 is learner interface 1109 and graphical user interface button 1110 labeled “ADD MESSAGE.”

Shown in FIG. 11B is a pictorial view of an exemplary display page comprising activity description window 1107. The display page shown in FIG. 11B may be displayed on the video display means of client computer 103 if a learner selects button 1108 in FIG. 11A. After reading the activity description in activity description window 1107, the learner may return to the episode event display page.

FIG. 11C shows a pictorial view of an exemplary display page comprising learner interface 1109. Learner interface 1109 comprises a discussion forum activity. Shown in FIG. 11C are button 1110 and discussion threads 1112, 1113, and 1114. Each message in each discussion thread comprises a hyperlink which, if selected, reveals the content of the message and a reply message feature operable to enable the user to compose and post a reply message. A learner may begin a new discussion thread by posting a base message, or may post a reply message to one of the active discussion threads in learner interface 1109. Selecting button 1110 enables a learner to post a base message to the discussion forum activity shown in learner interface 1109. To post a reply message, the learner selects the hyperlink comprising the message to which the learner wishes to reply, and then uses the reply message feature thereof to compose and post a reply message.

FIG. 11D shows a pictorial view of an exemplary display page comprising activity description window 1107 comprising an activity description for a discussion forum activity. The display page shown in FIG. 11D is displayed on the video display means of client computer 103 if a learner selects button 1106B from FIG. 11A, and then selects button 1108 from FIG. 11A. After reading the activity description in activity description window 1107, the learner may return to the episode event display page.

FIG. 11E shows a pictorial view of an exemplary display page comprising activity description window 1107 comprising an activity description for a survey activity. The display page shown in FIG. 11E is displayed on the video display means of client computer 103 if a learner selects button 1106C from FIG. 11A, and then selects button 1108 from FIG. 11A. After reading the activity description in activity description window 1107, the learner may return to the episode event display page.

Shown in FIG. 11F is a pictorial view of an exemplary display page comprising learner interface 1109 corresponding to the activity description in activity description window 1107 of FIG. 11E. Shown in FIG. 11F is survey question 1115, comprising a set of five possible responses. A learner will select one response to the survey activity. Each such survey question response comprises a graphical user interface button or hyperlink, or other feature of graphical user interface technology operable, when selected by a learner, to cause the learner's selected survey question response to be retrievably stored in database 106. As previously discussed herein, within database 106, each learner's selected survey question response(s) are compiled with each other learner's selected survey question responses for analysis and reporting.

Shown in FIG. 11G is a pictorial view of survey results display page 1117 comprising results corresponding to survey question 1115 of FIG. 11F. As discussed previously herein, after a learner responds to a survey question, the aggregated survey question responses from all learners on the team are made available to the individual learner. The aggregated responses are retrieved from database 106 and assembled in a display page, such as the display page shown in FIG. 11G. The display page comprising the aggregated responses is displayed on the video display means of client computer 103.

Shown in FIG. 11H is a pictorial view of survey results display page 1119 comprising results corresponding to survey question 1115 of FIG. 11F. The display page shown in FIG. 11H comprises a display page displayed only on client computer 110 operated by a facilitator. Like the display page shown in FIG. 11G, the display page shown in FIG. 11H comprises the aggregated survey question responses from all learners on a team responding thus far. In addition, because the display page is intended for review by a facilitator, the display page shown in FIG. 11H comprises the aggregated survey question responses from all learners on all teams participating in the scenario responding thus far. The aggregated responses are retrieved from database 106 and assembled in a display page, such as the display page shown in FIG. 11H. The display page comprising the aggregated responses is displayed on the video display means of the facilitator's client computer 110. The facilitator is able to see how many learners have responded to the survey activity for all teams participating in the survey activity, and how the responses are distributed across the possible survey responses for all teams completing the survey activity.

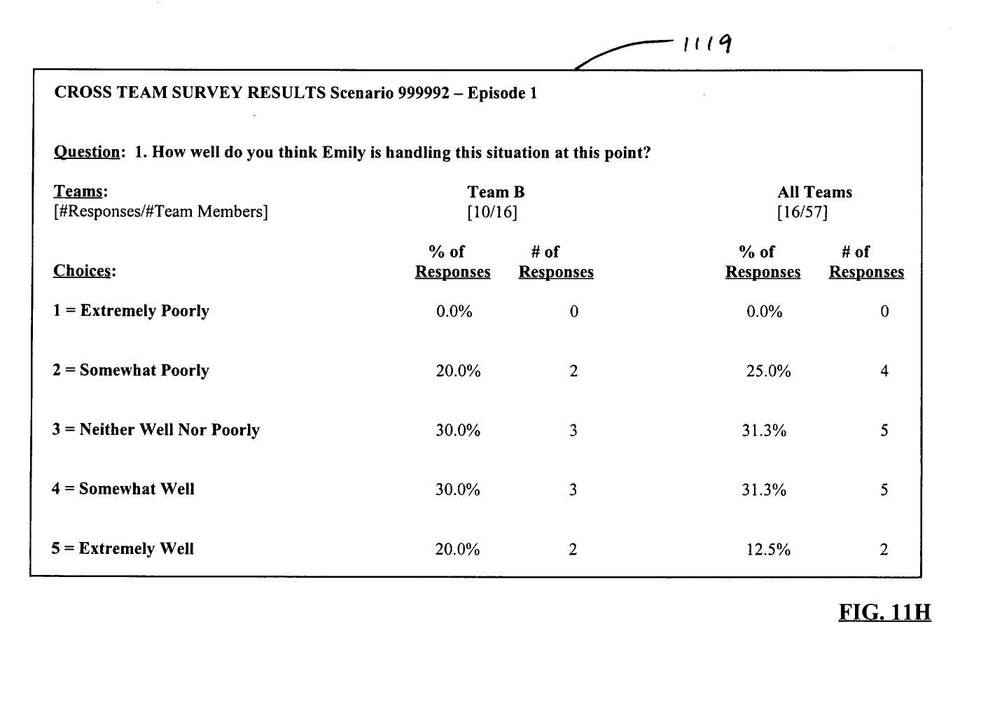

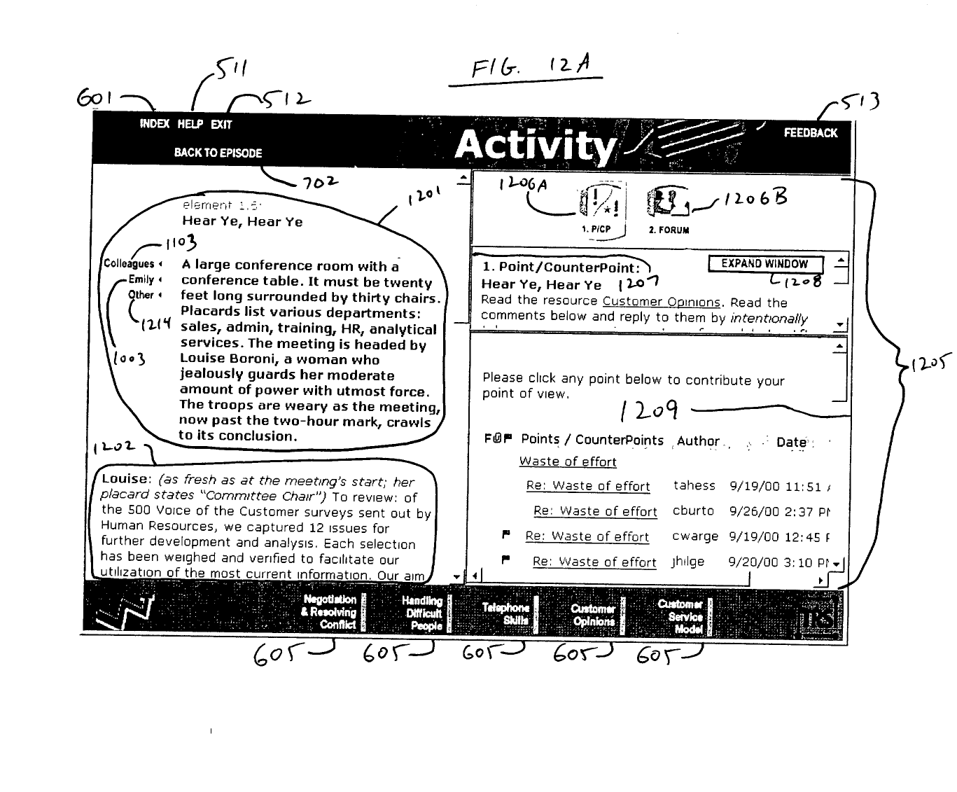

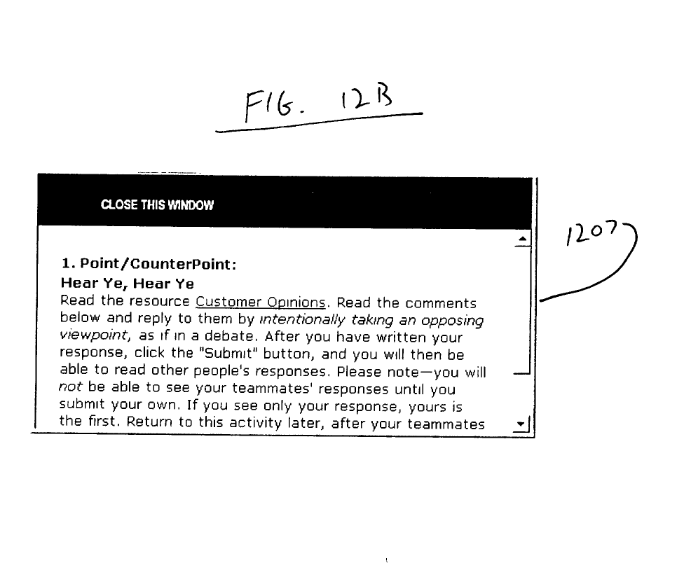

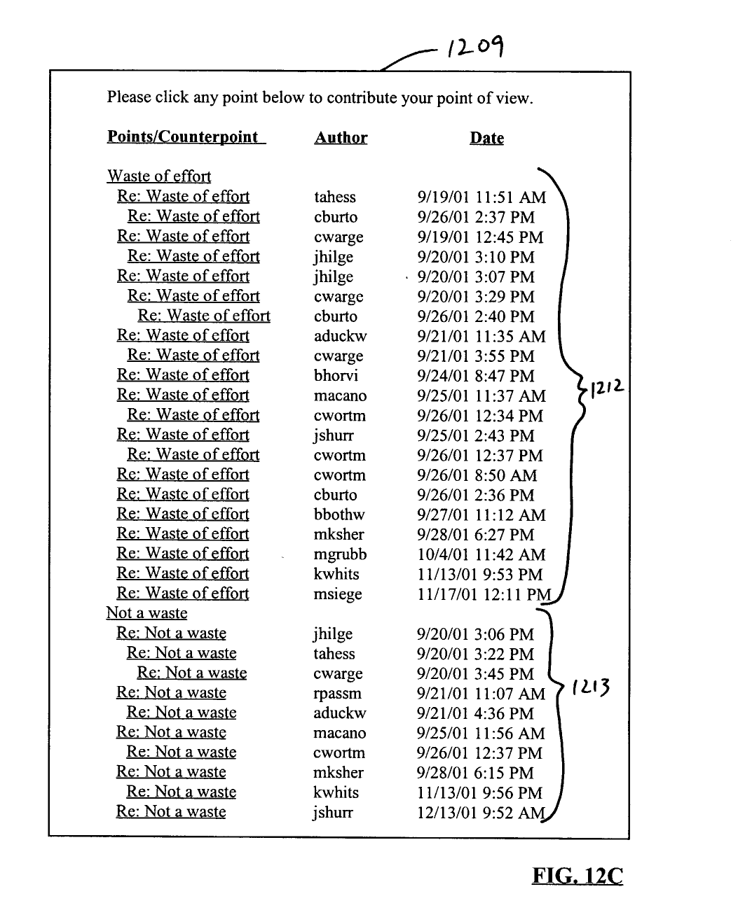

FIG. 12A shows a pictorial view of an exemplary display page representing an episode event according to the present invention. The display page shown in FIG. 12A comprises a display page which may be displayed on the video display means of client computer 103 if a learner selects the episode event button 604 labeled “6. Hear Ye, Hear Ye” in FIG. 6A. Shown in FIG. 12A is background section 1201, comprising character hyperlinks 1003, 1103, and 1214. Also shown in FIG. 12A is content section 1202, comprising a dialogue between two characters. Together, background section 1201 and content section 1202 comprise the scene content. Graphical user interface buttons 511, 512, 513, 601, 702, and a knowledge layer comprising a plurality of resource buttons 605 also are shown, each comprising the functionality previously described herein.

Also shown in FIG. 12A is activity section 1205. The episode event shown in FIG. 12A comprises two activities. Activity section 1205 comprises graphical user interface button 1206A labeled “P/CP,” graphical user interface button 1206B labeled “FORUM,” activity description window 1207, graphical user interface button 1208 labeled “EXPAND WINDOW,” and learner interface 1209. Each of buttons 1206A and 1206B corresponds to a different activity to be completed as part of the episode event.

Shown in FIG. 12B is a pictorial view of an exemplary display page comprising activity description window 1207, which may be displayed on the video display means of client computer 103 if a learner selects button 1208. After reading the activity description in activity description window 1207, the learner may return to the episode event display page.

FIG. 12C shows a pictorial view of an exemplary display page comprising learner interface 1209. Learner interface 1209 comprises a point-of-view activity. Shown in FIG. 12C are discussion threads 1212 and 1213. Discussion thread 1212 comprises a base message comprising a “point.” Discussion thread 1213 comprises a base message comprising another “point.” A learner may post a “counterpoint” message in reply to one or both of the active discussion threads in learner interface 1209.

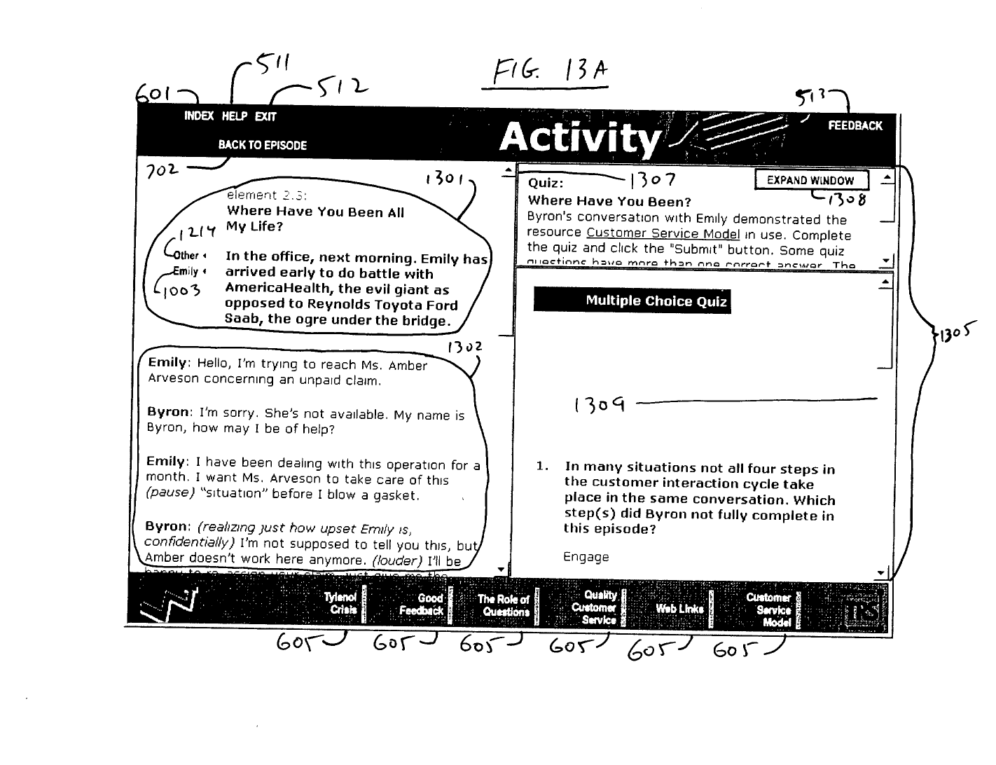

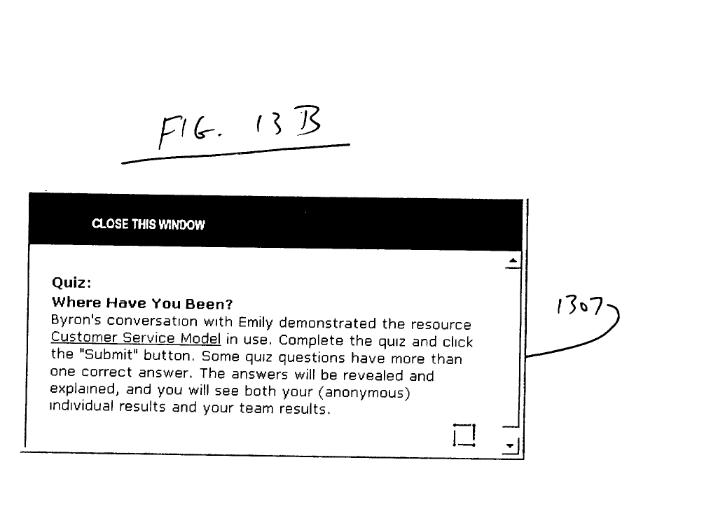

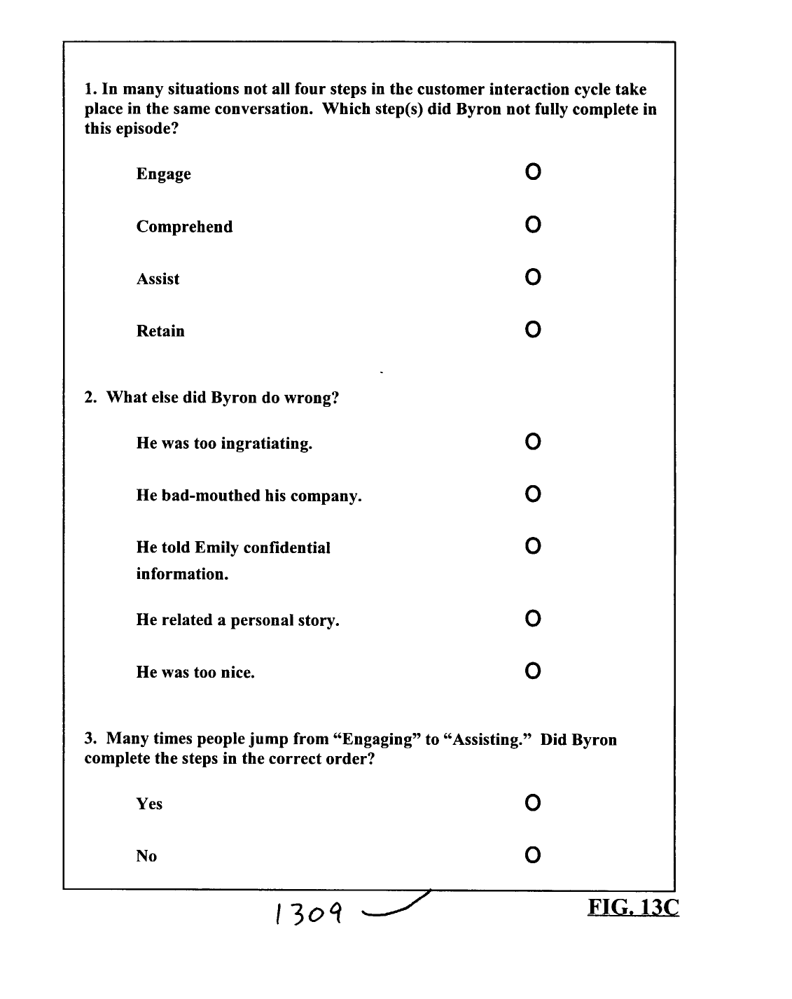

FIG. 13A shows a pictorial view of an exemplary display page comprising an episode event according to the present invention. The display page shown in FIG. 13A comprises a display page which may be displayed on the video display means of client computer 103 if a learner selects the episode event button 604 labeled “3. Where Have You Been All My Life?” in FIG. 6B. Shown in FIG. 13A is background section 1301, comprising character hyperlinks 1003 and 1214. Also shown in FIG. 13A is content section 1302, comprising a dialogue between two characters. Together, background section 1301 and content section 1302 comprise the scene content. Graphical user interface buttons 511, 512, 513, 601, 702, and a knowledge layer comprising a plurality of resource buttons 605 also are shown, each comprising the functionality previously described herein.

Also shown in FIG. 13A is activity section 1305, comprising one activity. Activity section 1305 comprises activity description window 1307, graphical user interface button 1308 labeled “EXPAND WINDOW,” and learner interface 1309.

Shown in FIG. 13B is a pictorial view of an exemplary display page comprising activity description window 1307, which may be displayed on the video display means of client computer 103 if a learner selects button 1308. After reading the activity description in activity description window 1307, the learner may return to the episode event display page.

FIG. 13C shows a pictorial view of an exemplary display page comprising learner interface 1309. Learner interface 1309 comprises a quiz activity. Shown in FIG. 13C are three quiz questions. Each quiz question comprise two or more quiz question responses. Each such quiz question response comprises a graphical user interface button or hyperlink or other feature of graphical user interface technology operable, when selected by a learner, to cause the learner's quiz question responses to be retrievably stored in database 106. As previously discussed herein, within database 106, each learner's quiz question responses are compiled with each other learner's quiz question responses for analysis and reporting.

Referring back to FIG. 5, if a learner or a facilitator (each a “participant”) selects graphical user interface button 502, a display page comprising a “team forum” is displayed. A team forum comprises a threaded discussion similar to a discussion forum activity. However, discussion threads in a team forum ordinarily are not directed to responding to a given activity description. Instead, discussion threads may be based on any topic. Each learner in a team may post base messages and reply messages in a team forum. Each facilitator may post base messages and reply messages in any team forum.

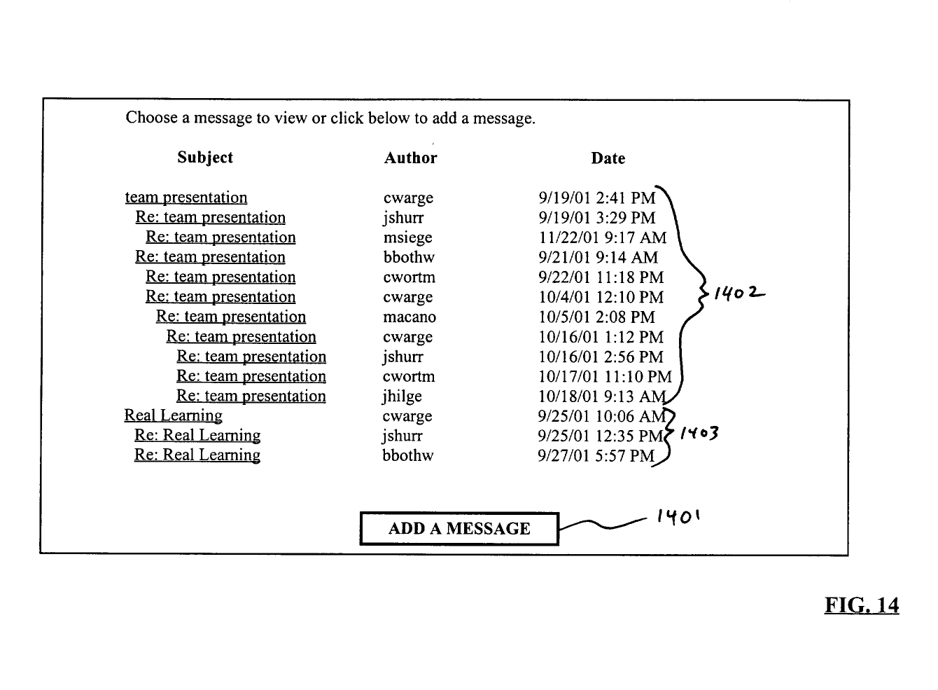

FIG. 14 shows a pictorial view of an exemplary display page comprising a possible implementation of a team forum according to the present invention. The display page shown in FIG. 14 may be displayed when a participant selects graphical user interface button 502 in FIG. 5. The present invention is operable to identify the team to which the learner is assigned according to the learner's participant profile information. Thus, the present invention prevents the learner from accessing another team's team forum.

Shown in FIG. 14 are graphical user interface button 1401, labeled “ADD MESSAGE,” and discussion threads 1402 and 1403. Each message in each discussion thread comprises a hyperlink which, if selected, reveals the content of the message. Also revealed is a reply message function operable to enable the user to compose and post a reply message.

A participant may begin a new discussion thread in the team forum by posting a base message, or may post a reply message to one of the active discussion threads in the team forum. Selecting button 1401 enables a learner to post a base message to the team forum. To post a reply message, the participant selects the hyperlink comprising the message to which the participant wishes to reply, and then uses the reply message function thereof to compose and post a reply message. A participant's message in a team forum may comprise text, and also may comprise one or more attached computer files.

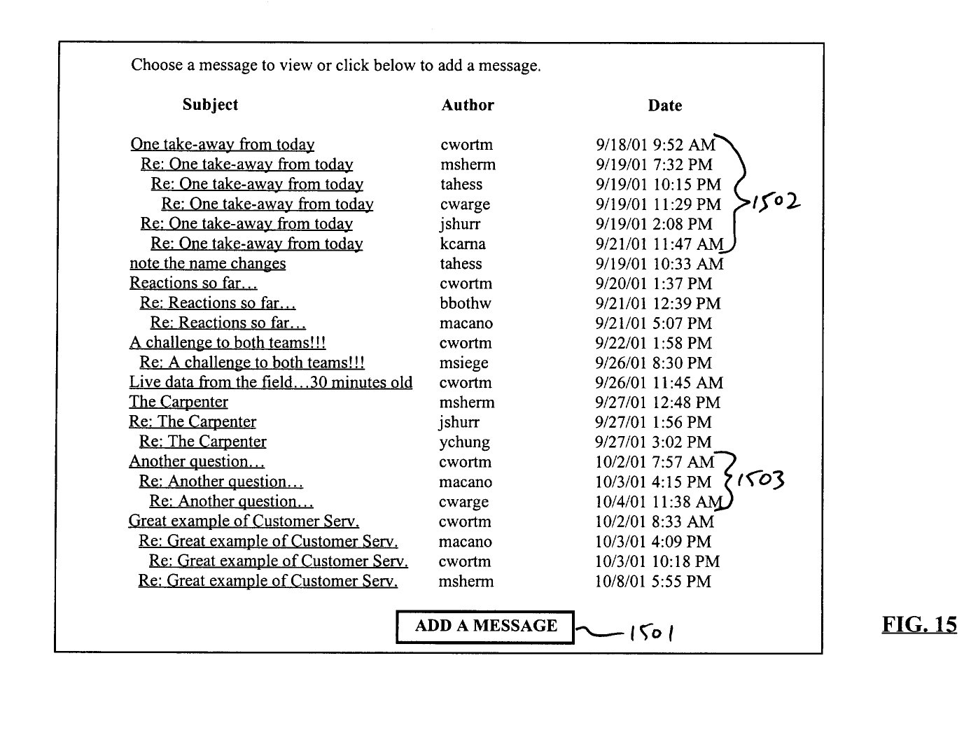

Referring back to FIG. 5, if a participant selects graphical user interface button 503, the participant is able to participate in a cross-team threaded discussion called a “common forum.” FIG. 15 shows a pictorial view of an exemplary display page comprising a common forum according to the present invention, which may be displayed when a participant selects graphical user interface button 503 in FIG. 3. Shown in FIG. 15 are graphical user interface button 1501, labeled “ADD MESSAGE,” and discussion threads 1502 and 1503. Each message in each discussion thread comprises a hyperlink which, if selected, reveals the content of the message. Also revealed is a reply message feature operable to enable a participant to compose and post a reply message.

A participant may begin a new discussion thread in a common forum by posting a base message, or may post a reply message to one of the active discussion threads in a common forum. Selecting button 1501 enables a participant to post a base message to a common forum. To post a reply message, a participant selects the hyperlink comprising a message to which the participant wishes to reply, and then uses the reply message function thereof to compose and post a reply message. A participant's message in a common forum may comprise text, and also may comprise one or more attached computer files.

The present invention comprises other means for communication among participants. For example, an embodiment of the present invention comprises instant messaging of a type known in the art, wherein two or more participants can communicate, provided the client computers operated by the communicating participants are concurrently in bi-directional communication with host server 101. In another example, an embodiment of the present invention comprises one or more chat rooms of a type known in the art, wherein two or more participants can communicate. In yet another example, an embodiment of the present invention comprises the ability for a participant to launch an external e-mail software of a type known in the art, thus enabling a participant to send an e-mail message to another participant or to the facilitator. Concurrent bi-directional communication is not required for e-mail communication among participants.

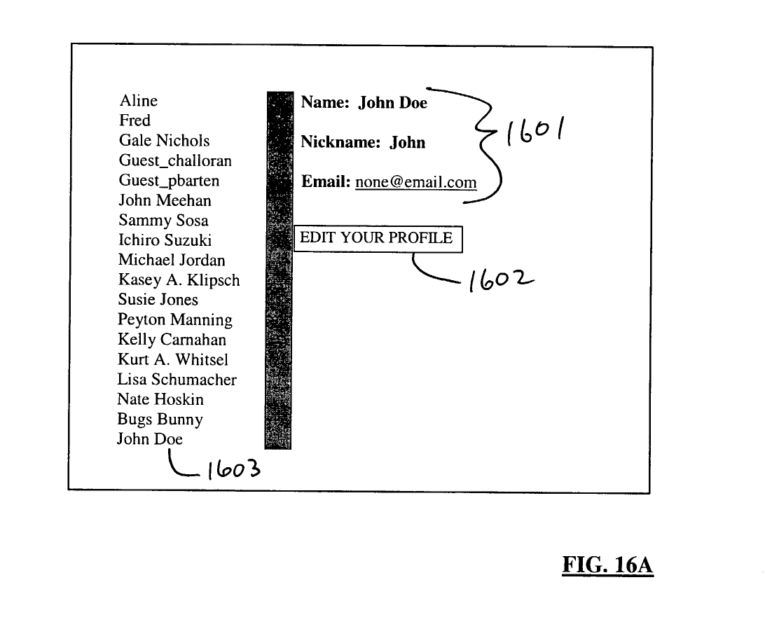

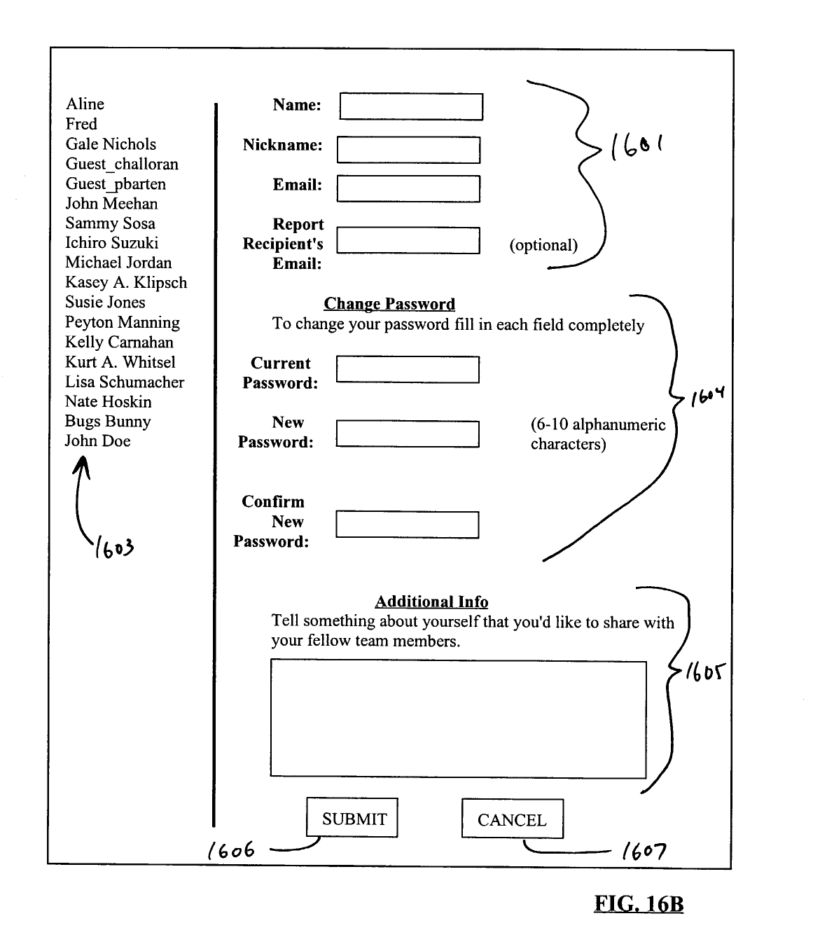

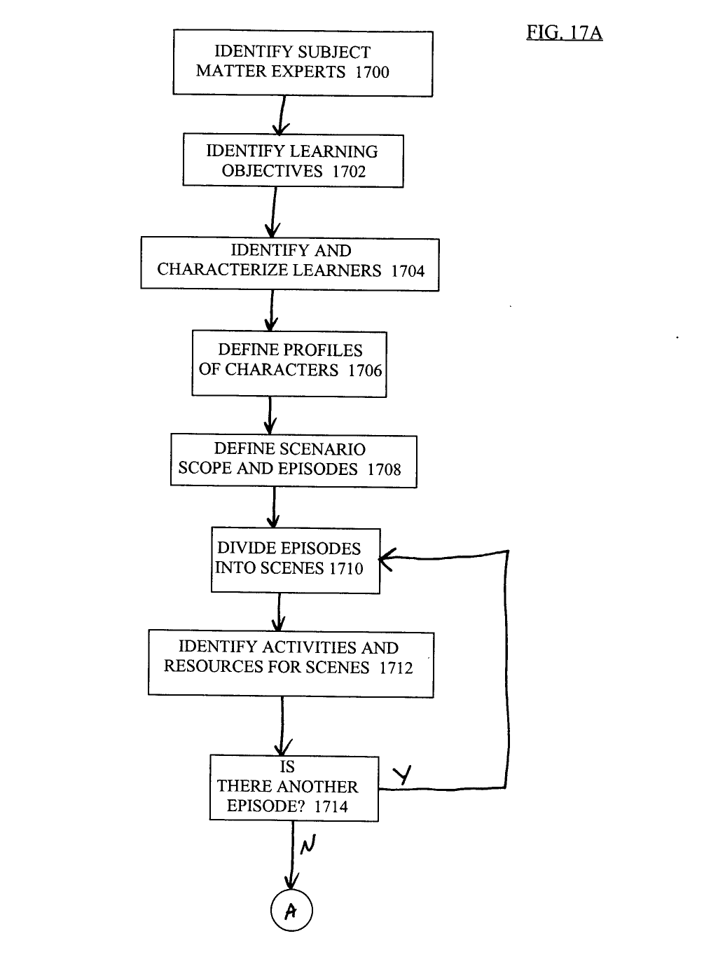

Referring back to FIG. 5, if a learner selects graphical user interface button 505, a participant profile display page such as that shown in FIG. 16A is displayed. Shown in FIG. 16A are participant profile information section 1601, graphical user interface button 1602 labeled “EDIT YOUR PROFILE,” and a plurality of participant hyperlinks 1603. Selecting any participant hyperlink 1603 causes profile information about a participant to be retrieved from database 106 and displayed on client computer 103.

FIG. 16B shows an example of a pictorial view of an exemplary display page comprising a participant profile maintenance interface which may be displayed when a participant selects graphical user interface button 1602. Each participant may update his or her own profile information. In addition, a facilitator may be authorized to update a learner's profile information. Shown in FIG. 16B is an electronic form comprising profile information section 1601, participant hyperlinks 1603, password change section 1604, additional information section 1605, graphical user interface button 1606 labeled “SUBMIT,” and graphical user interface button 1607 labeled “CANCEL.” Also shown in each of profile information section 1601, password change section 1604, and additional information section 1605 are data entry fields. A participant may change certain information using this display page by, for example, entering appropriate new information in one or more of the data entry fields. When the participant selects button 1606, any such new information is retrievably stored in database 106.

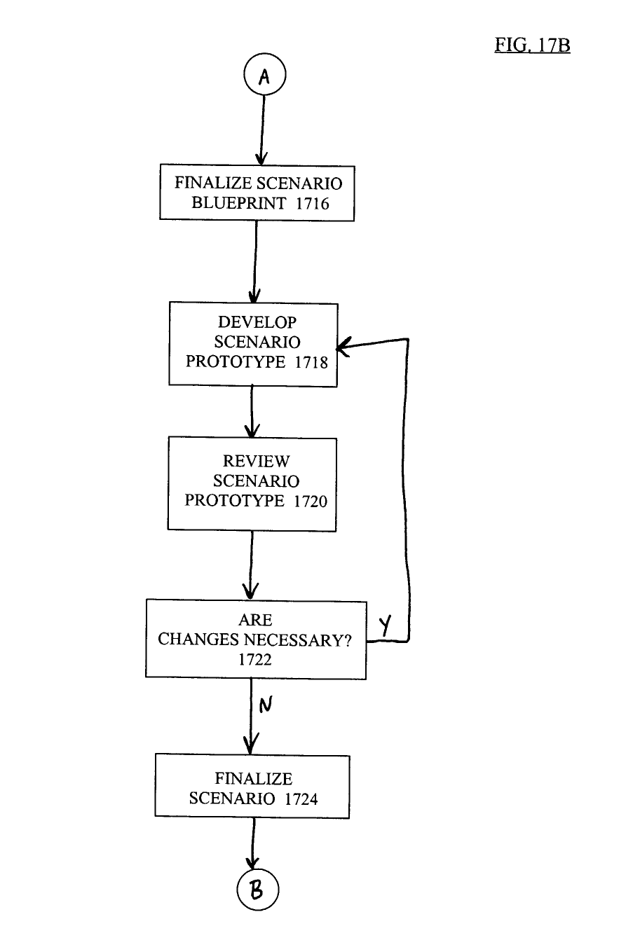

FIGS. 17A-C show a flow chart illustrating a process for developing a scenario according an embodiment of the present invention. In the step shown as block 1700, one or more subject matter experts (each an “SME”) are identified. As the name implies, each SME possesses expertise or knowledge in the subject matter of the scenario. A typical purpose of a scenario according to the present invention is to transfer certain expertise or knowledge from one or more SMEs to one or more learners, and to do so in a way which engages each learner in an interesting, interactive learning process which improves the likelihood that the transferred expertise is assimilated and retained by each learner.

Although an SME may be identified from many sources, frequently an SME has some form of previously established relationship with the learners, or possesses knowledge of the environment, circumstances, and/or issues facing the learners. For example, where the learners are a plurality of employees of a particular company, one or more SMEs may be selected from the company's management, or may be one or more outside consultants hired by the company's management, or may be both.

It is preferred that scenarios according to the present invention are relevant to a learner and involve an environment, circumstances, and issues familiar to a learner. The input of an SME in the scenario development improves the likelihood that the scenario is relevant and involves an environment, circumstances, and issues familiar to a learner. For example, where the learners are a plurality of employees of a particular company and an SME is from the company's management, the SME can recommend the appropriate use of company or industry jargon in a scenario, or propose that the company's interdepartmental politics be embodied into one or more event in the scenario, or ensure that internal company procedures, if used, are accurately depicted in the scenario. Other subtleties which may be known only to those in a previously existing relationship with a particular group of learners may be introduced into a scenario based on input from an SME.

In the step shown as block 1702, one or more learning objectives is/are defined. A practitioner of the present invention is advised to budget sufficient time and to devote sufficient attention to this important step in the scenario development process. Preferably, learning objectives are defined by the SME. Because learning objectives provide a foundation for future decisions about what information is included in a scenario, and how information is presented to learners in a scenario, the quality of the learning objectives defined in the step shown as block 1702 is a predictor of the future success of the scenario. Well-defined learning objectives improve the likelihood of a successful scenario. Ill-defined learning objectives reduce the likelihood of a successful scenario. As discussed previously herein, a focused list of learning objectives is preferred. Too many learning objectives may dilute the scenario's efficacy. More than three learning objectives in a scenario is not recommended for educational reasons.

In the step shown as block 1704, learners are identified and characterized. In another embodiment of the present invention, this step may be performed before the step of identifying the SME. In either case, as discussed previously herein, it is preferable that the characters reflect characteristics and behaviors of the learners, or are familiar to the learners. The learners then are able to draw from personal experiences while executing the scenario. In the step shown as block 1706, profiles of the scenario characters are developed and documented.

In the step shown as block 1708, the overall scope of the scenario is defined. Defining the scope includes the steps of developing an outline of the scenario's story line and a list of the episode(s) comprising the scenario, and making a preliminary allocation of portions of the story line to each episode.

In the step shown as block 1710, the first episode is divided into one or more events. A portion of the story line is allocated to each event. In the step shown as block 1712, scenes, resources, and activities are identified for each event within the first of the at least one episodes.

In the step shown as block 1714, the practitioner determines whether there is another episode in the scenario. If so, flow reverts to the step shown as block 1710, where the next episode is divided into one or more events, a portion of the story line is allocated to each event. The flow proceeds to the step shown as block 1712, where scenes, resources, and activities are identified for each event within the episode, and then returns to the step shown as block 1714.

If the practitioner determines in the step shown as block 1714 that no additional episodes are in the scenario, the product of all iterations through blocks 1710 and 1712 is compiled into a “scenario blueprint,” an activity shown in the step shown as block 1716. A “scenario blueprint” according to the present invention comprises a written document which describes the scenario, including all episodes, events, scenes, resources, activities, and character profiles, as well as the relationship between the scenario's episodes, events, scenes, resources, activities, and character profiles. The scenario blueprint comprises a level of detail sufficient for the practitioner to begin creating display pages.

In the step shown as block 1718, the scenario blueprint is developed into a scenario prototype. The scenario prototype according the present invention comprises display pages based on the information from the scenario blueprint. In the step shown as block 1720, the scenario prototype is reviewed. During this review, the scenario prototype is examined for compliance with the scenario blueprint. In addition, the display pages comprising the scenario prototype are reviewed for quality and consistency. The overall scenario also is examined for coherence, and to determine whether the scenario will accomplish the learning objective(s) when it is executed by a learner.

In the step shown as block 1722, the practitioner determines whether modifications to the scenario prototype are necessary based on the results of the scenario prototype review performed in the step shown as block 1720. If so, flow reverts to the step shown as block 1718, where additional scenario prototype development is performed. The flow proceeds to the step shown as block 1720 for review of the improved scenario prototype, and then returns to the step shown as block 1722. The steps comprising blocks 1718, 1720, and 1722 may be repeated as necessary until the practitioner is satisfied with the scenario. When the practitioner determines in the step shown as block 1722 that no additional scenario prototype development is required, the scenario is finalized, an activity accomplished during the step shown as block 1724.

In the step shown as block 1726, a scenario implementation plan is developed. According to the present invention, a scenario implementation plan comprises a plan for accomplishing certain logistical and administrative tasks which may be required before a scenario can be executed by learners and facilitators. The implementation plan may comprise plans for introducing learners to the scenario, for registering learners, and for assigning learners to teams.

The implementation plan also may comprise an identification of the date that each episode will first become available to learners, and the duration of time that each episode will remain available. The implementation plan also may comprise the definition of a reward or incentive structure to encourage learner participation in the scenario. The implementation plan may be developed at any time before the step of learner registration, shown in FIG. 17 in the step shown as block 1728. In another embodiment, the implementation plan is developed concurrently with the development of the scenario.

In the step shown as block 1728, learners are registered. In an embodiment of the present invention, a learner registers by first establishing bidirectional communication between client computer 103 and host server 101. An electronic form comprising one or more data requests and one or more corresponding data entry fields then is displayed on the video display means of client computer 103. The learner responds to the data requests by entering appropriate information into the one or more data entry fields. When the learner is satisfied with the learner's responses to the data requests, the learner submits the electronic form, which is transmitted to host server 101. The participant profile information entered by the learner then is retrievably stored in database 106 by a software means residing on host server 101. After the learner's participant profile information is stored on host server 101, the learner is “registered.”

The participant profile information to be obtained from a learner in a particular implementation of a scenario according to the present invention is left to the discretion of the practitioner. However, in a typical implementation of a scenario according to the present invention, certain basic profile information is required for communicating with the learner. For example, in a typical implementation, the name of the learner and the learner's e-mail address are obtained and retrievably stored in database 106.

A plurality of other participant profile information about each learner may be collected and retrievably stored in database 106 if desired. For example, in an implementation of the present invention a practitioner may desire to collect participant profile information comprising the job title or management level of each learner, the organizational unit to which each learner is assigned, the geographic location where each learner lives and/or works, each learner's gender, each learner's age, each learner's years of service to the organization, each learner's education level, and/or such other elements of learner information as would occur to those of skill in the art. Detailed participant profile information enhances the ability of a practitioner of the present invention to assign learners to teams. The team assignment criteria can be more precisely defined if more profile information is collected from learners.

If the scenario comprises teams, the learner is assigned to a team during the step shown as block 1728, and the learner's team assignment is retrievably stored in database 106 and associated with the learner's other participant profile information. In an embodiment of the present invention, the process for assigning learners to teams comprises the steps of (i) evaluating the learner's participant profile information against team assignment criteria; and (ii) assigning a learner to a team according to the foregoing evaluation. In an embodiment of the present invention, host server 101 and database 106 are programmed and configured to automatically perform this step after participant profile information is received from a learner during registration.

Team assignment criteria used in a particular implementation of a scenario according to the present invention is left to the discretion of the practitioner of the present invention. For example, a practitioner may determine that the team assignment criteria should be a simple “first-come, first-served” rule. Thus, where a team is to have ten learners, the first ten registered learners form the first team, the next ten registered learners form the next team, and so forth. The evaluation of participant profile information is cursory where the team assignment criteria is first-come, first-served.

Alternatively, the practitioner may employ team assignment criteria requiring a deeper evaluation of participant profile information. For example, where learners are employees of a company, the team assignment criteria may be such that learners are assigned to a team according to the company's organizational structure. Based on participant profile information comprising the organizational unit to which each learner is assigned, the team assignment criteria can cause employees from the same organizational unit within the company to be assigned to the same team. Alternatively, the team assignment criteria can cause employees from the same organizational unit within the company to be precluded from being assigned to the same team.

In another example, the team assignment criteria may be such that learners are assigned to a team according to the learners' job title or management level. Based on participant profile information comprising the job title or management level of each learner, the team assignment criteria can cause employees having the same job title or management level to be assigned to the same team. Alternatively, the team assignment criteria can cause employees having the same job title or management level to be precluded from being assigned to the same team. Numerous other examples of the application of team assignment criteria are possible. In addition, team assignment criteria may be based on the combination of any number of participant profile information elements.

A practitioner of the present invention may tailor the team assignment criteria to the needs of a particular scenario. Thus, if a practitioner of a first scenario desires teams comprising learners with diverse backgrounds, the practitioner may develop a team assignment criteria tailored to achieve this result. If a practitioner of a second scenario desires teams comprising learners with homogeneous backgrounds, the practitioner may develop a team assignment criteria tailored to achieve this result.

In another example, during registration each learner may specify characteristics the learner desires for the learner's teammates. The present invention is operable, based upon the characteristics specified by a learner, to assign each learner to a team comprising other learners possessing the desired characteristics.

Referring back to FIG. 17, in the step shown as block 1730, learners are introduced to the scenario. The agenda comprising the introduction to the scenario is left to the discretion of the practitioner of the present invention. The introduction may comprise a training session instructing learners in the operation of the scenario. Where learners are employees of the same company, the introduction may comprise a message from company management, including a description of the reward or incentive structure for participation by a learner in the scenario. Finally, in the step shown as block 1732, the learner executes the scenario.

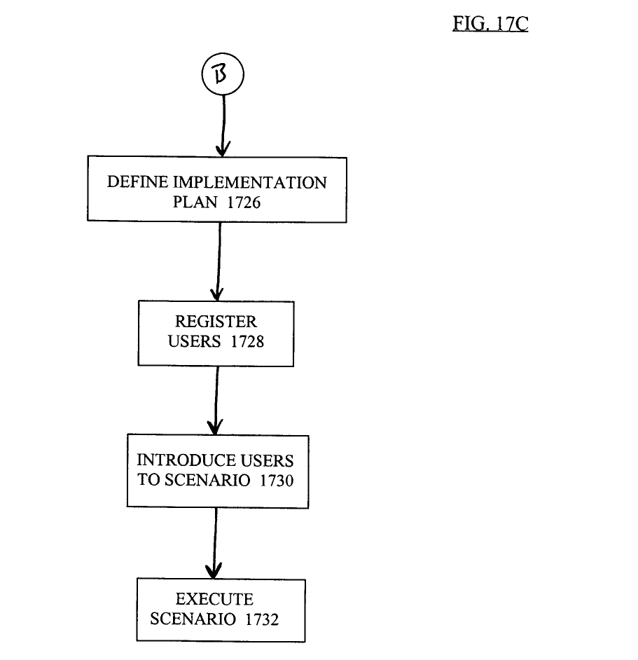

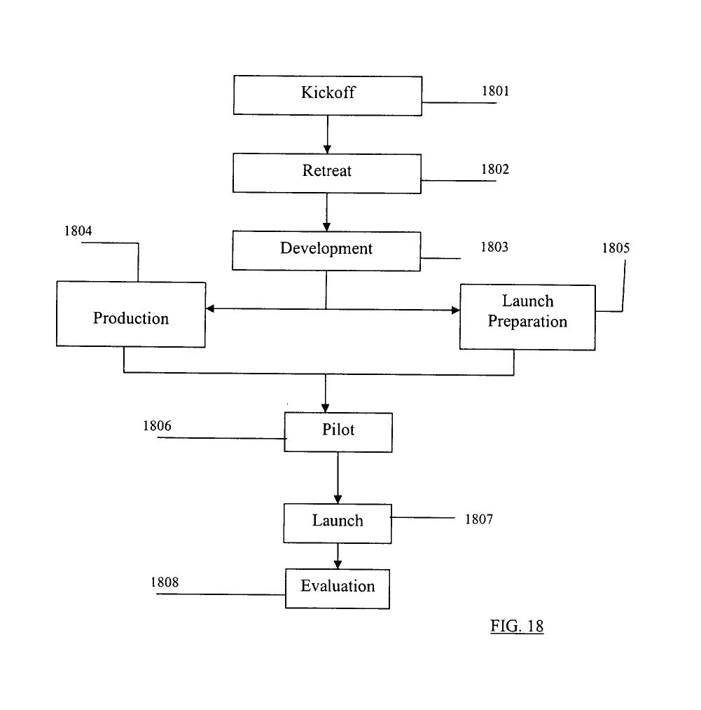

FIG. 18 shows a flow chart illustrating an alternate process for creating a scenario according to an embodiment of the present invention. In the embodiment shown in FIG. 18, the system operator and an entity sponsoring the scenario (the “sponsor”) collaborate during creation of the scenario. The method shown in FIG. 18 is useful when the scenario will be executed by, for example, learners having a common employer or belonging to a common organization. The common employer or common organization is the sponsor in these cases.

In the step shown in FIG. 18 as block 1801, scenario creation begins with a “kick-off” stage. In one implementation, the kick-off stage comprises a meeting between representatives of the system operator and representatives of the sponsor, but this is not required. Collaboration between representatives of the system operator and representatives of the sponsor takes place in the kick-off stage, but the kick-off stage can comprise telephone conferences, exchanges of e-mail, or other methods for collaborative communication as would occur to those of skill in the art.

The system operator organizes and leads the kick-off stage. During the kick-off stage, the system operator provides the representatives of the sponsor with information about scenarios according to the present invention. Such information describes the components and features of a scenario (i.e., episodes, events, scenes, resources, activities, characters, etc.) and the scenario creation process to the representatives of the sponsor.

The sponsor and the system operator determine a schedule for scenario creation, frequently based on a scenario launch date desired by the sponsor. The sponsor and the system operator develop a first draft of the learning objectives during the kick-off stage, and also define the scope of the scenario and identify project risks. The sponsor identifies SMEs during the kick-off stage. The kick-off stage concludes with the system operator disseminating information regarding the rest of the scenario creation process.

In the step shown as block 1802, representatives of the system operator and representatives of the sponsor participate in the retreat stage. Ordinarily, the representatives of the sponsor participating in the retreat stage are the SMEs. In preparation for the retreat stage, the SMEs (or other representatives of the sponsor) become familiar with the components and features of a scenario according to the present invention. The retreat stage typically is facilitated by representatives of the system operator. In one implementation, the retreat stage comprises a meeting between representatives of the sponsor and SMEs or other representatives of the system operator, but this is not required. The retreat stage may comprise any means known in the art through which representatives of the system operator and representatives of the sponsor may collaboratively communicate.

During the retreat stage, the learning objectives are refined and the framework of the scenario's episodes, events, and scenes is established. Characters are identified and drafts of character profiles are created. Resources are identified and drafts of activities are created. At the conclusion of the retreat stage, the system operator compiles the results of the retreat stage into a scenario blueprint. The scenario blueprint is the foundation for later stages in the scenario creation process according to this embodiment.

Using the scenario blueprint, the scenario undergoes further development in the step shown as block 1803. During the scenario development stage, the scenario blueprint is finalized by the system operator and distributed to the SMEs or other representatives of the sponsor. The SMEs or other representatives of the sponsor review the scenario blueprint for consistency with the learning objectives. Also during this stage, scene content is scripted by the system operator and reviewed by the SMEs or other representatives of the sponsor. Finally, the parties collaborate regarding a strategy for implementing the scenario among the learners.

The production stage and the launch preparation stage follow the development stage. The production stage, shown as block 1804 in FIG. 18, and the launch preparation stage, shown as block 1805 in FIG. 18, are conducted concurrently in this embodiment of scenario creation according to the present invention.

In the step shown as block 1804, the scenario is produced. Production of the scenario entails converting the scenario blueprint and other written documentation generated during the earlier stages into a scenario in a format deliverable through computer network 102 to learners and facilitators operating client computers. For example, where computer network 102 comprises the Internet, the production stage entails creating display pages comprising episodes, events, scene content, activities, character profiles, resources, and the like. A prototype of the scenario is reviewed by the SMEs or other representatives of the sponsor, and feedback is provided to the system operator. Additional scenario production may be necessary following review by the SMEs or other representatives of the sponsor. The scenario may go through more than one iteration of scenario production and sponsor representative review before it is ready for pilot execution of the scenario (discussed hereinafter).

In the step shown as block 1805, the system operator and the sponsor prepare for launch of the scenario among the learners. The sponsor identifies learners to participate in the pilot version of the scenario during this stage. The sponsor also identifies one or more facilitators, if the scenario is to be facilitated. Further, the sponsor develops and implements a plan for raising the awareness of the scenario among the learners. Finally, the system operator and the sponsor verify that the necessary computer and networking hardware and software is present to enable execution of the scenario.

In the step shown as block 1806 in FIG. 18, a pilot execution of the scenario is performed. Pilot learners execute the scenario, providing feedback to the system operator and the SMEs or other representatives of the sponsor. The scenario may be modified or enhanced by the system operator based upon the results of the pilot.

In the step shown as block 1807 in FIG. 18, the scenario is launched among all learners. As the launch stage begins, the system operator communicates to the learners the expectations and responsibilities for participation in the scenario. Learners and facilitators are registered, as discussed previously herein. Learners may be assigned to teams, as discussed previously herein. The learners and facilitators then execute the scenario.

Optionally, in the step shown as block 1808, the scenario is assessed and evaluated by the learners and facilitators. Assessment and evaluation may comprise an evaluation survey of the type discussed herein. In addition, certain learners, facilitators, SMEs, and/or other representatives of the sponsor may be made available to the system operator for interviews and other in-depth feedback techniques.

As discussed previously herein, the execution of a scenario according to the present invention may be facilitated. A facilitator according to the present invention operates with a goal of assisting learners in achieving the learning objectives of a scenario. A facilitator preferably knows the scenario thoroughly before learners are exposed to the scenario. Accordingly, in advance of the step shown as block 1730 of FIG. 17 or the step shown as block 1807 in FIG. 18, a preferred facilitator (i) understands the episodes, character profiles, events, resources, and activities comprising the scenario; (ii) understands the relationship between each such episode, character profile, event, resource, and/or activity; and (iii) understands the purpose each such episode, character profile, event, resource, and/or activity serves in advancing the learners toward achievement of the learning objectives.

A facilitator according to the present invention is responsible for keeping the execution of the scenario on schedule. For example, a facilitator may mandate or negotiate a deadline for an episode or activity. If a learner or a team of learners misses a deadline or otherwise falls behind schedule, or if a learner or a team of learners appears to the facilitator to be in danger of missing a deadline or of falling behind schedule, the facilitator may intervene and require a learner or team of learners to take appropriate corrective action. Conversely, the facilitator may use positive feedback to recognize a learner or a team of learners that abides by the schedule and complies with deadlines.

A facilitator according to the present invention also is responsible for guiding learner participation in the scenario. In so doing, a facilitator preferably establishes rapport with the learners and attempts to create a sense of community and trust among the learners. In contrast to a conventional classroom case study, in a scenario according to the present invention, learners are required to share thoughts and insights in writing, and in a medium that permits other learners to critique and judge. This may cause hesitance in some learners. To effectively guide learner participation and to encourage learner risk-taking, a facilitator needs to help each learner feel that the learner is part of a community and that the learner has something worthwhile to contribute to other learners participating in the scenario. A facilitator's ability to establish rapport with the learners, and to establish a sense of community and trust among the learners, improves the likelihood that the learners will achieve the learning objectives of the scenario. As will be appreciated by those of skill in the art, each learner is unique and, accordingly, each team of learners is unique. Thus, no single strategy for establishing rapport with the learners and for establishing a sense of community and trust among the learners is successful in every scenario. The strategy for establishing rapport with the learners and for establishing a sense of community and trust among the learners is adapted to the circumstances of a particular scenario.

A facilitator most frequently interacts with learners during a discussion forum activity or a point-counterpoint activity. A facilitator should encourage appropriate use of the discussion forum activity or point-counterpoint activity. Neither should be used for personal messages among the learners or to deal with administrative matters. Within a discussion forum activity or point-counterpoint activity, a facilitator preferably should keep learners focused on the topic presented in the activity description. A facilitator should monitor the messages posted in a discussion forum activity or a point-counterpoint activity, and intervene when posted messages are not relevant to the activity.

To aid in building rapport with the learners and establishing a sense of community and trust among the learners, it is recommended that the facilitator participates frequently in those discussion forum activities or point-counterpoint activities arising early in a scenario. According to this strategy, a facilitator may achieve success in establishing rapport with the learners and in establishing a sense of community and trust among the learners by drawing the attention of other learners to a good message posted by a learner in a discussion forum activity or in a point-counterpoint activity, and/or by encouraging other learners to reply to a certain message posted by a learner in a discussion forum activity or in a point-counterpoint activity. Such actions may demonstrate to learners that the facilitator is there as a resource and a support for their learning, and also that the facilitator has expectations of the learners both in terms of quantity of participation, and quality of messages.

Although a facilitator should intervene in a discussion forum activity or point-counterpoint activity as necessary to encourage thoughtful discussion, a facilitator should not dominate the activity with the facilitator's opinions or beliefs. A facilitator should provide appropriate feedback to learners during a discussion forum activity or a point-counterpoint activity. In a discussion forum activity or a point-counterpoint activity, a facilitator may ask a learner “follow-up” questions to clarify the learner's comments, or may encourage a learner to think more deeply about a point, or may urge a learner to find the lessons embedded in a scenario, episode, event, or activity. A facilitator also may delete any message posted by a learner which, in the discretion of the facilitator, is inappropriate.

A facilitator preferably encourages learners to use resources. A message posted by a learner in a discussion forum activity or point-counterpoint activity is more valuable if the learner uses the resources while creating the message. A facilitator should look for references to resources in a learner's posted messages. Some activities ask learners to look at a specific resource. The facilitator should provided feedback to a learner regarding the learner's use of resources in such activities.

Referring back to FIGS. 2 and 4B, shown therein is client computer 110 operated by a facilitator. According to the present invention, a facilitator may use client computer 110 to access and review display pages comprising episodes, events, character profiles, resources, and activities in the same manner as a learner using client computer 103. A facilitator also may use client computer 110 to engage in activities in the same manner as a learner using client computer 103. However, according to an embodiment of the present invention, a facilitator possesses greater scenario display page access privileges than does a learner. For example, at any time a facilitator according to this embodiment may use client computer 110 to access all display pages comprising the scenario, including all display pages comprising episodes, events, character profiles, resources, and activities. As previously discussed herein, a learner may use client computer 103 to access only those display pages which the facilitator or system operator permit the learner to access.

In addition, the embodiments of the present invention shown in FIG. 2 and FIG. 4B are operable to recognize the facilitator as a facilitator, such as, for example, through the use of a username and password which are unique to the facilitator. After recognition of the facilitator, this embodiment is operable to deliver certain display pages, called “facilitator display pages,” from host server 101 through network 102 to client computer 110 operated by the facilitator. Such display pages are not accessible to those who are not identified as a facilitator, such as, for example, those whose username and password do not match the username and password which are unique to the facilitator.

Certain facilitator display pages comprise functionality called “facilitator tools.” In an embodiment, the present invention comprises an activity creation facilitator tool, a resource creation facilitator tool, a learner tracking facilitator tool, a schedule manager facilitator tool, a message creation facilitator tool, a discussion capture facilitator tool, as well as facilitator tools specific to each type of scenario activity.

The activity creation facilitator tool enables a facilitator to create one or more new activities for one or more events in the scenario. New activities may be created by the facilitator at any time, including after learners have begun to execute the scenario. For example, if a facilitator perceives the need for another activity to reinforce one or more of the scenario's learning objectives, the facilitator may create such an activity and associate it with one or more events.

To use the activity creation facilitator tool, the facilitator first establishes bi-directional communication between client computer 110 and host server 101. After bi-directional communication is established, the facilitator accesses the display pages comprising the activity creation facilitator tool. In an embodiment, the activity creation facilitator tool comprises an activity database comprising preformatted activity templates. Each such template corresponds to a different type of scenario activity. For example, an activity database may comprise a discussion forum template, a survey template, a point-counterpoint template, a CFP template, a quiz template, an evaluation survey template, as well as an activity template for each other type of activity. Multiple templates also may be available for each type of activity. In operation, the facilitator retrieves an activity template from the activity database, populates the activity template with information to create an activity, and then saves the newly created activity on host server 101 and/or in database 106. The facilitator also may associate the newly created activity with one or more events, or may defer associating the newly created activity with one or more events until a future time. The association between the newly created activity and an event, when accomplished, is stored on host server 101 and/or in database 106. The activity database also may comprise an “activity library,” which comprises activities previously developed by the facilitator or by others. The facilitator may re-use an activity from the activity library, or may develop a new activity based on an activity from the activity library.

The resource creation facilitator tool enables a facilitator to create one or more new resources for the scenario. New resources may be created by the facilitator at any time, including after learners have begun to execute the scenario. For example, if a facilitator perceives the need for another resource to reinforce one or more of the scenario's learning objectives, the facilitator may create such a resource and associate it with one or more episodes.

To use the resource creation facilitator tool, the facilitator first establishes bi-directional communication between client computer 110 and host server 101. After bi-directional communication is established, the facilitator accesses display pages the comprising the resource creation facilitator tool. In an embodiment, the resource creation facilitator tool comprises a resource database comprising preformatted resource templates. Each preformatted resource template corresponds to a different form of content which may be used in a resource, such as, for example, digital documents, Internet hyperlinks, online tutorials, and the like. In operation, the facilitator retrieves a resource template from the resource database, populates the resource template with information to create a resource, and then saves the resource on host server 101 and/or in database 106. The facilitator also may associate the newly created resource with one or more episodes, or may defer associating the newly created resource with one or more episodes until a future time. The association between the newly created resource and an episode, when accomplished, is stored on host server 101 and/or in database 106. The resource database also may comprise a “resource library,” which comprises resources previously developed by the facilitator or by others. The facilitator may re-use a resource from the resource library, or may develop a new resource based on a resource from the resource library.

The learner tracking facilitator tool enables a facilitator to monitor the participation level of learners during execution of a scenario. The present invention is operable to collect information about each learner's interactions with the scenario. For example, each time a learner uses the learner's username and password to access the scenario, a record comprising this occurrence is retrievably stored in database 106. Each time a learner accesses an event for the first time, a record comprising this occurrence is retrievably stored in database 106. Each time a learner accesses a resource, a record comprising this occurrence is retrievably stored in database 106. Each time a learner completes an activity, a record comprising this occurrence is retrievably stored in database 106. Each message posted in a discussion forum activity or a point-of-view activity, and each response in a survey activity or quiz activity is retrievably stored in database 106. Records pertaining to each CFP activity performed by a learner also are retrievably stored in database 106. The learner tracking facilitator tool according to the present invention is operable to retrieve certain of this information from database 106, and compile it in a display page which is transmitted through network 102 and displayed on the video display means of client computer 110.

According to an embodiment of the learner tracking facilitator tool according to the present invention, after the facilitator operating client computer 110 establishes bi-directional communication with host server 101, the facilitator may request a display page comprising the learner tracking facilitator tool to be transmitted from host server 101 through network 102 to client computer 110, and to be displayed on the video display means of client computer 110. The display page comprising the learner tracking facilitator tool is operable to enable the facilitator to request at least one learner tracking report.

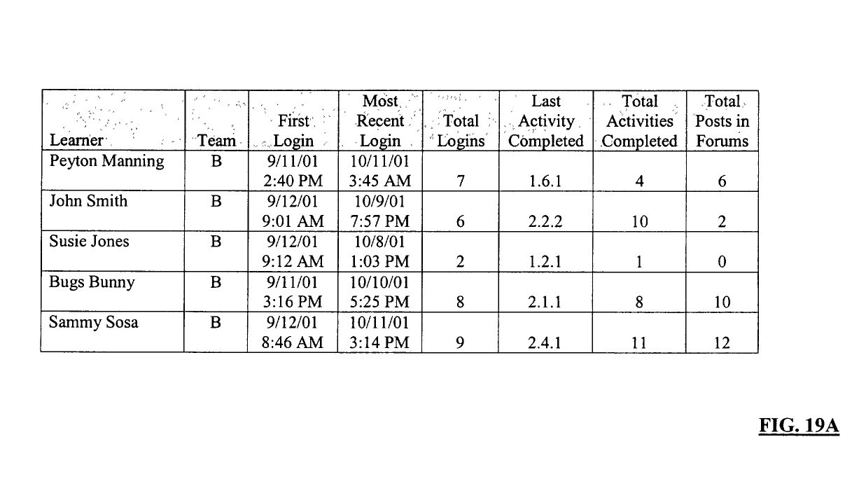

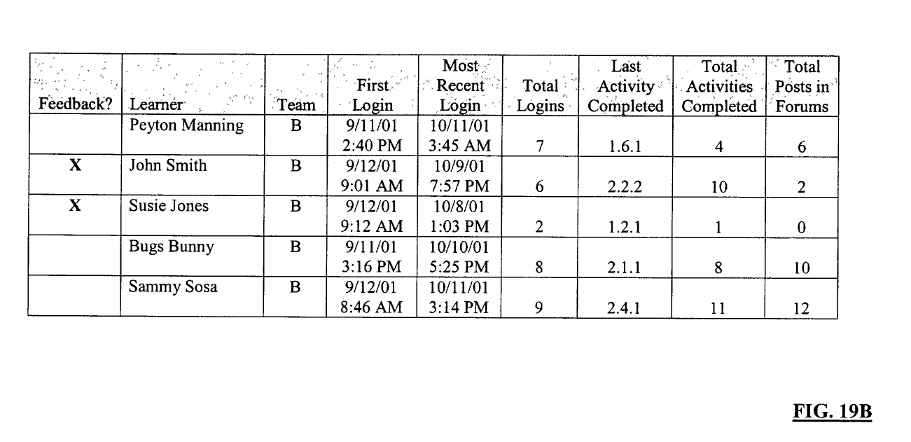

The format of the learner tracking report in a particular embodiment of the learner tracking facilitator tool is left to the discretion of the practitioner. In one implementation, the learner tracking report comprises a table having the following column headings: learner name, learner team name, learner's first login (date and, optionally, time), learner's most recent login (date and, optionally, time), learner's total number of logins, identity of the last activity completed by the learner, total number of activities completed by the learner, and total number of messages posted to discussion forum activities and point-of-view activities. FIG. 19A shows an exemplary learner tracking report according to this implementation.

In operation, the facilitator requests compilation of the learner tracking report using the display page comprising the learner tracking facilitator tool. In response, host server 101 retrieves the appropriate data from database 106, compiles the learner tracking report therefrom, and causes the learner tracking report to be transmitted through network 102 to client computer 110, where it is displayed on the video display means of client computer 110. Each row of the table in the learner tracking report comprises information pertaining to one learner, with the data pertaining to the learner organized in a columnar format according to the learner tracking report's column headings.

In an embodiment, the learner tracking facilitator tool comprises a learner feedback tool. According to this embodiment, the facilitator may provide feedback to one or more learners from the display page comprising the learner tracking facilitator tool. In an implementation of this embodiment, the learner feedback tool is integrated into the learner tracking report. According to this implementation, the learner tracking report comprises a “learner feedback” column. If, in the discretion of the facilitator, the results reported for a learner in the learner tracking report warrant feedback to the learner, the facilitator may so indicate in the learner feedback column. The learner feedback tool then is operable to deliver feedback to the learners selected by the facilitator. Feedback may comprise an e-mail message to the learner, or other form of message to the learner comprising the facilitator's feedback. FIG. 19B shows an exemplary learner tracking report according to this implementation. In the exemplary report shown in FIG. 19B, the facilitator perceived that learner “John Smith” is less active in discussion forum activities than expected, and designated learner Smith for feedback on this point. Similarly, the facilitator perceived that learner “Susie Jones” may be executing the scenario at a slower pace than expected, and designated learner Jones for feedback on this point

The learner feedback tool may comprise one or more preformatted message templates comprising frequently used feedback message content. For example, the learner feedback tool may comprise a preformatted message template useable to inform a learner that the learner is not progressing through the scenario rapidly enough. In another example, the learner feedback tool may comprise a preformatted message template useable to inform a learner that the learner is not active enough in a discussion forum activity or a point-of-view activity. Other preformatted message templates may be created for the facilitator if so desired by the practitioner in a particular implementation of the present invention.

The schedule manager facilitator tool enables a facilitator to deliver reminders to learners about schedules and deadlines during the execution of a scenario. According to an embodiment of the schedule manager facilitator tool according to the present invention, after the facilitator operating client computer 110 establishes bi-directional communication with host server 101, the facilitator may request a display page comprising the schedule manager facilitator tool to be transmitted from host server 101 through network 102 to client computer 110, and to be displayed on the video display means of client computer 110. The display page comprising the schedule manager facilitator tool is operable to enable the facilitator to create messages for delivery to learners. For example, the schedule manager facilitator tool may comprise one or more preformatted message templates useable to inform a learner of the scenario's deadlines and activities. For example, the schedule manager facilitator tool may comprise preformatted message templates useable to inform learners of a scenario opening, a scenario closing, an episode opening, an episode closing, an activity deadline, and the like. Other preformatted message templates may be created for the facilitator if so desired by the practitioner in a particular implementation of the present invention.

The message creation facilitator tool enables a facilitator to create messages in advance, and to reveal such messages to the learners after the occurrence of an occurrence or after the passage of a predetermined period of time. For example, a message may be created by the facilitator prior to execution of the scenario, but may be revealed to a learner only when a learner enters a discussion forum activity or a point-of-view activity for the first time. Such messages also may comprise e-mail messages delivered to the e-mail inbox of a learner, or instant messages delivered when a learner's client computer is in bi-directional communication with host server 101.

The discussion capture facilitator tool enables a facilitator to capture one or more messages or discussion threads in a threaded discussion area, and to retrievably store such one or more messages or discussion threads in computer file. The computer file comprising the stored one or more messages or discussion threads then can be printed and/or distributed to the learners as an e-mail attachment or by other means known in the art for distribution of a computer file. This discussion capture facilitator tool is adaptable for use with any threaded discussion area of the present invention, including a discussion forum activity, a point-of-view activity, a common forum, a team forum, and the like.

As discussed previously, the present invention comprises facilitator tools for each type of activity. The survey activity comprises a survey results facilitator tool. As previously discussed herein, after completion of a survey activity, a learner is exposed to the survey activity results from the other learners on the team. A facilitator using the survey results facilitator tool can review a display page comprising survey results from one or more individual learners, from a team of learners, or from multiple teams of learners. Where such a display page comprises survey results from a team of learners, the facilitator can review survey results from each learner individually, and also from the team in aggregate. Likewise, where such a display page comprises survey results from multiple team, the facilitator can review survey results from each team individually, and also from the multiple teams in aggregate.

The quiz activity comprises a quiz results facilitator tool. As previously discussed herein, after completion of a quiz activity, a learner is exposed to the learner's results from the quiz activity. A facilitator using the quiz results facilitator tool can review a display page comprising quiz results from one or more individual learners, from a team of learners, or from multiple teams of learners. Where such a display page comprises quiz results from a team of learners, the facilitator can review quiz results from each learner individually, and also from the team in aggregate. Likewise, where such a display page comprises quiz results from multiple team, the facilitator can review quiz results from each team individually, and also from the multiple teams in aggregate.

The CFP activity comprises a CFP activity results facilitator tool. As previously discussed herein, after completion of a CFP activity, a learner is exposed to the learner's results from the CFP activity. A facilitator using the CFP activity results facilitator tool can review a display page comprising CFP activity results from one or more individual learners, from a team of learners, or from multiple teams of learners. Where such a display page comprises CFP activity results from a team of learners, the facilitator can review CFP activity results from each learner individually, and also from the team in aggregate. Likewise, where such a display page comprises CFP activity results from multiple team, the facilitator can review CFP activity results from each team individually, and also from the multiple teams in aggregate.

The discussion forum activity comprises a discussion forum activity results facilitator tool. A facilitator using the discussion forum activity results facilitator tool can review a display page comprising discussion forum activity results from one or more individual learners, from a team of learners, or from multiple teams of learners. For example, a facilitator can use the discussion forum activity results facilitator tool to review a display page comprising the total number of messages posted in a discussion forum activity, the total number of new threads started in a discussion forum activity, the number of messages posted in a discussion forum activity by each learner, and/or the number of threads started in a discussion forum activity by each learner. Where such a display page comprises discussion forum activity results from a team of learners, the facilitator can review discussion forum activity results from each learner individually, and also from the team in aggregate. Likewise, where such a display page comprises discussion forum activity results from multiple team, the facilitator can review discussion forum activity results from each team individually, and also from the multiple teams in aggregate.

In an embodiment, the discussion forum activity results facilitator tool comprises a discussion forum data mining tool. Review and assessment of each message posted in a discussion forum activity during a scenario can be difficult for a facilitator due to the volume of messages. It may be difficult for a facilitator to ascertain each learner's grasp of the learning objectives. The discussion forum data mining tool enables a facilitator (or a system operator) to efficiently search all messages in a discussion forum activity for the presence of certain keywords. Also possible is the reporting of content patterns and frequently used terms. Summaries of a posted message or a group of messages also are possible using the tool.

The point-of-view activity comprises a point-of-view activity results facilitator tool. A facilitator using the point-of-view activity results facilitator tool can review a display page comprising point-of-view activity results from one or more individual learners, from a team of learners, or from multiple teams of learners. For example, a facilitator can use the point-of-view activity results facilitator tool to review a display page comprising the total number of messages posted in a point-of-view activity and/or the number of messages posted in a point-of-view activity by each learner. Where such a display page comprises point-of-view activity results from a team of learners, the facilitator can review point-of-view activity results from each learner individually, and also from the team in aggregate. Likewise, where such a display page comprises point-of-view activity results from multiple team, the facilitator can review point-of-view activity results from each team individually, and also from the multiple teams in aggregate. In an embodiment, the point-of-view activity results facilitator tool comprises a point-of-view activity data mining tool of the type discussed above in regard to the discussion forum activity results facilitator tool.

An embodiment of the present invention also comprises “personal display pages” that are accessible only by one or more particular participants, and that are inaccessible by other participants who may have access to the scenario's other display pages. In this embodiment, the present invention is operable to recognize each participant such as, for example, through the use of a username and password which are unique to the participant. After recognition of the participant, the embodiment is operable to deliver personal display pages from host server 101 through network 102 to client computer 103 if the participant is a learner, or to client computer 110 if the participant is a facilitator.

Certain personal display pages comprise functionality called “personal tools.” In an embodiment, the present invention comprises a scenario journal personal tool, an action planning personal tool, and a personal reports personal tool. The participant profile maintenance interface shown in FIG. 16B is another example of a personal tool.

The scenario journal personal tool enables a participant to retrievably store “personal messages” such as, for example, memoranda, notes, thoughts, citations, reflections, references, and the like, for later retrieval. For example, if a learner has an insight or discovers a resource or activity which may be useful to the learner during or after execution of the scenario, the learner may retrievably store a personal message pertaining to the insight, the resource, or the activity in the learner's scenario journal personal tool.

To use the scenario journal personal tool, the participant first establishes bi-directional communication between the participant's client computer and host server 101. After bi-directional communication is established, the participant accesses one or more display pages comprising the scenario journal personal tool. The display pages comprising the scenario journal personal tool comprise at least one electronic form comprising at least one data entry field into which the participant may enter a personal message using the data entry means of the participant's client computer. The participant's personal message may comprise text, and also may comprise one or more attached computer files. After the participant enters the desired personal message, the scenario journal personal tool is operable to retrievably store the participant's personal message on host server 101 and/or in database 106.

To retrieve a personal message stored by the scenario journal personal tool, the participant establishes bi-directional communication between the participant's client computer and host server 101. After bi-directional communication is established, the participant accesses one or more display pages comprising the scenario journal personal tool. The display pages comprising the scenario journal personal tool comprise at least one display page in which information about the participant's stored personal messages is compiled. Optionally, the display page(s) comprising the compiled information about the participant's stored personal messages comprises graphical user interface hyperlink(s) and/or button(s) selectable by the participant to display one or more stored personal messages.

In an embodiment of the present invention, the participant's personal messages retrievably stored by the scenario journal personal tool may be retrieved by the participant at any time. For example, according to this embodiment, a participant may retrieve personal messages from the participant's scenario journal personal tool, even after all learners have completely executed the scenario.

The action planning personal tool enables a learner or a facilitator, or both, to create and retrievably store an “action plan” for a participant. An action plan according to the present invention comprises at least one goal or objective (each a “principal goal”) a participant desires to achieve, and at least one task to be performed by the participant in pursuit of each principal goal. An action plan according to the present invention also may comprise one or more interim goals or milestones, the achievement of which may be used to measure a participant's progress toward the principal goal(s).

The action planning personal tool is useful for aiding a learner in concentrating on a scenario's learning objectives, and/or on a broader set of personal improvement or performance improvement goals or objectives. Although the action planning personal tool is a component of the present invention, a learner's principal goal(s) need not be constrained to those which may achieved by executing a scenario. Executing the scenario may be one component of an action plan. The action planning personal tool enables a learner to document an action plan and the position the scenario plays in the learner's action plan.

The action planning personal tool according to the present invention enables the development of at least three types of action plans. The first type of action plan is a “non-customizable” action plan. According to this type of action plan, a learner's action plan is not modifiable using the present invention. The action plan is developed by the learner, or by another person such as, for example, the learner' supervisor, or by the learner in conjunction with another person such as the learner's supervisor.

A non-customizable action plan may be finalized outside the context of the present invention and then input or uploaded into the present invention using means known in the art. Alternatively, a non-customizable action plan may be finalized using the present invention. In either case, after a non-customizable action plan is stored on host server 101 and/or in database 106, it may be reviewed by a learner using the action planning personal tool, but may not be changed by the learner using the action planning personal tool.

The second type of action plan is a “semi-customizable” action plan. According to this type of action plan, a “framework” of an action plan is developed by a learner, or by another person such as, for example, the learner's supervisor, or by the learner in conjunction with another person such as the learner's supervisor. After the framework of the action plan is finalized, it cannot be modified by the learner using the present invention. The framework of the action plan may be finalized outside the context of the present invention and then input or uploaded into the present invention using means known in the art. Alternatively, the framework of the action plan action plan may be finalized using the present invention. In either case, once the framework of the action plan action plan is stored on host server 101 and/or in database 106, the learner may review, but may not modify, the framework of the action plan.

However, according to a semi-customizable action plan, within the framework certain items of the action plan are modifiable by a learner using the action planning personal tool. For example, where the action plan specifies a milestone to be accomplished by the learner, the learner may be provided two or more alternative means of accomplishing the milestone, such as, for example, two or more alternative tasks. The learner may select the most appealing of these two or more alternative tasks as part of the learner's action plan.

The third type of action plan is a “fully-customizable” action plan. According to this type of action plan, a learner utilizes the action planning personal tool to create the learner's action plan, including all tasks and milestones thereof. Optionally, a learner collaborates with a facilitator during development of a fully-customizable action plan. Although a learner may define the learner's principal goal(s) in a fully-customizable action plan, it is within the scope of the present invention that a fully-customizable action plan may be developed in response to an externally provided principal goal(s), such a principal goal provided by the learner's supervisor.

The personal reports personal tool enables a learner to review a learner's performance during execution of the scenario. As discussed previously herein, the present invention is operable to collect and retrievably store information about a learner's interactions with the scenario, including information about a learner's performance during the activities the learner encounters during execution of a scenario. The personal reports personal tool according to the present invention is operable to retrieve certain of this information from database 106, and compile it in a display page which is transmitted through network 102 and displayed on the video display means of client computer 103.

According to an embodiment of the personal reports personal tool, after the learner operating client computer 103 establishes bi-directional communication with host server 101, the learner may request a display page comprising the personal reports personal tool to be transmitted from host server 101 through network 102 to client computer 103, and to be displayed on the video display means of client computer 103. In one implementation of this embodiment, the display page comprising the personal reports personal tool is operable to enable the learner to request at least one activity report.

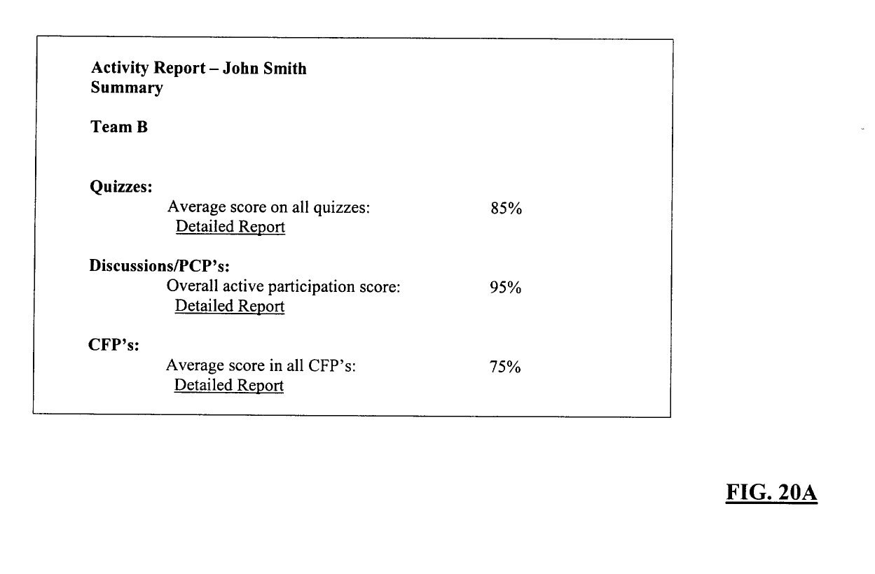

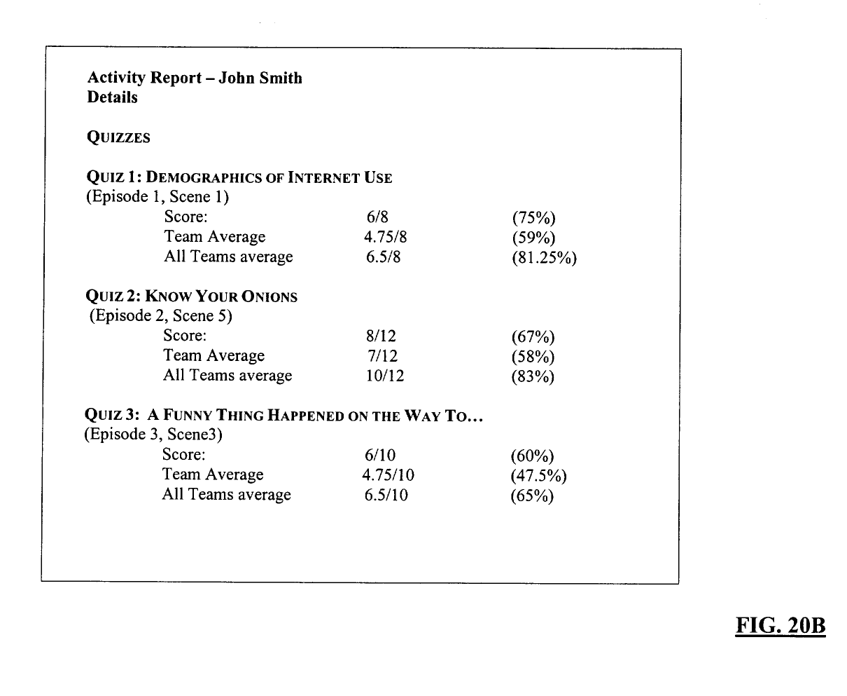

In operation, when the learner requests compilation of the activity report using the personal reports personal tool, host server 101 retrieves the appropriate data from database 106, compiles the activity report therefrom, and causes the activity report to be transmitted through network 102 to client computer 103 where it is displayed on the video display means of client computer 103. The format of the activity report (or that of any other type of learner personal report) available in a particular embodiment of the personal reports personal tool is left to the discretion of the practitioner. In one implementation, an activity report comprises a summary report and a detailed report. FIG. 20A shows an exemplary summary activity report according to this implementation, showing the aggregate performance of a hypothetical learner in several types of activities. If the learner selects hyperlink 1901 in FIG. 20A, the exemplary detailed activity report shown in FIG. 20B is revealed, showing the performance of a hypothetical learner in each individual activity comprising the aggregate activity performance shown in the summary report of FIG. 20A.

In an embodiment, the present invention comprises a software means called a “scenario authoring tool” that may be used to facilitate the development of a scenario. One implementation of the scenario authoring tool operates according to the application service provider (“ASP”) model of software distribution, but this is not required. According to the ASP model, the scenario authoring tool resides on host server 101. A user of the scenario authoring tool establishes bi-directional communication between host server 101 and a client computer operated by the user. After bi-directional communication is established, the user then is able to interact with the scenario authoring tool, and thereby to create or edit a scenario. Scenarios created by a user of the scenario authoring tool are stored on host server 101 and/or database 106 for access and execution by learners and facilitators as previously described herein.

In an embodiment of a scenario authoring tool according to the present invention, database 106 is adapted to comprise an activity database, a scene database, a resource database, a character profile database, a media object database, and, optionally, a scenario example database.

An activity database according to this embodiment comprises preformatted activity templates. Each such template corresponds to a different type of scenario activity. For example, an activity database may comprise a discussion forum template, a survey template, a point-of-view template, a CFP template, a quiz template, as well as an activity template for each other type of activity. Multiple templates also may be available for each type of activity. In operation, a user of the scenario authoring tool retrieves an activity template from the activity database, populates the activity template with information to create an activity, and then saves the activity on host server 101 and/or in database 106. The activity database also may comprise an “activity library,” which comprises activities previously developed by the user or by others. The user may re-use an activity from the activity library, or may develop a new activity based on an activity from the activity library.

The scene database according to this embodiment comprises preformatted scene templates, each corresponding to a different form of scene content which may be used in a scene, such as, for example, a conversation between two or more characters, an e-mail message, a voice mail message, a meeting, a letter, a fax, pages from a character's calendar, a character's diary, a character's monologue, etc. In operation, a user of the scenario authoring tool retrieves a scene template from the scene database, populates the scene template with information to create a scene, and then saves the scene on host server 101 and/or in database 106. The scene database also may comprise an “scene library,” which comprises scenes previously developed by the user or by others. The user may re-use a scene from the scene library, or may develop a new scene based on a scene from the scene library.

The resource database according to this embodiment comprises preformatted resource templates, each corresponding to a different form of content which may be used in a resource, such as, for example, digital documents, Internet hyperlinks, online tutorials, and the like. In operation, a user of the scenario authoring tool retrieves a resource template from the resource database, populates the resource template with information to create a resource, and then saves the resource on host server 101 and/or in database 106. The resource database also may comprise a “resource library,” which comprises resources previously developed by the user or by others. The user may re-use a resource from the resource library, or may develop a new resource based on a resource from the resource library.

The character profile database according to this embodiment comprises one or more preformatted character profile templates, which may be populated by the user with character profile information for a character in the scenario. In operation, a user of the scenario authoring tool retrieves a character profile template from the character profile database, populates the character profile template with information to create a character profile, and then saves the character profile on host server 101 and/or in database 106. The character profile database also may comprise a “character profile library,” which comprises character profiles previously developed by the user or by others. The user may re-use a character profile from the character profile library, or may develop a new character profile based on a character profile from the character profile library.

The media object database according to this embodiment comprises a library of media objects, pictures, symbols, clipart, images, wallpaper, graphical user interface icons and the like which may be incorporated into the scenario, episode events, character profiles, activities, and resources developed using the scenario authoring tool.

Finally, the optional scenario example database according to this embodiment comprises a library of finished scenarios previously developed by the user or by others. The user may use a finished scenario from the library of finished scenarios as a model for a new scenario.

A scenario authoring tool according to this embodiment of the present invention also comprises a plurality of software tools. A first such software tool comprises a development tool. The development tool according to this embodiment of the present invention enables its user to create and edit the components of a scenario including, for example, episodes, events, character profiles, activities, and resources. The development tool may comprise one or more “wizards” or similar software utilities. A wizard according to this embodiment of the present invention comprises a software means including a user interface which provides a user with step-by-step instructions for accomplishing a particular task. For example, if a user indicates a desire to create a new scenario, through its user interface a wizard according to the embodiment may request information about the desired scenario from the user. Such a wizard may ask questions such as: “What is the title of this scenario?” and/or “How many episodes are in this scenario?” For each episode in the desired scenario, and a wizard may ask questions such as, for example, “How many characters appear in this episode?” and/or “How many resources are used in this episode?” and/or “How many events are in this episode?” and/or “Which events include scenes?” and/or “Which events include activities?” For each event in the desired scenario, a wizard may ask questions such as, for example, “What scene content is associated with this event?” and/or “How many activities are associated with this event?” and/or “What type of activities are associated with this event?”

In each case, the user provides an appropriate response to question posed by the wizard. The development tool is operable, after receipt of the user's responses, to construct a scenario blueprint comprising the organizational structure of the scenario. After the scenario blueprint is constructed, the user interfaces with the development tool to add content to each component of the scenario. For example, for each episode event the development tool permits the user to retrieve an episode event template from the episode event database, and then permits the user to populate the episode event template with content. Likewise, for each activity the development tool permits the user to retrieve an activity template from the activity database, and then permits the user to populate the activity template with content. For each character profile, the development tool permits the user to retrieve a character profile template from the character profile database, and then permits the user to populate the character profile template with content. For each resource, the development tool permits the user to retrieve a resource template from the resource database, and then permits the user to populate the resource template with content. The development tool also is operable to retrieve items from media object database for appropriate incorporation into the scenario, episode events, character profiles, activities, and/or resources, according to the instructions of the user.

Although the development tool may comprise a wizard employing a step-by-step method for developing a scenario, the development tool according to the present invention also is operable to enable the user to edit the scenario at any time during the development process. For example, the development tool is operable to enable the user to change the number of episodes, events, resources, characters, and/or activities. The development tool is operable to enable the user to change types of activities or resources. The development tool is operable to enable the user to change the relationship between episodes and events, or change the sequence of events within an episode. Where such a change involves deleting part of the scenario, such as when the change involves deleting an episode, the development tool is operable to retrievably store the deleted part of the scenario on host server 101 and/or in database 106. If so desired, the user may retrieve all or a part of the deleted portion of the scenario for future use.

In a preferred embodiment, the development tool permits collaboration among a plurality of users working on a scenario. In this embodiment, a plurality of users may simultaneously access the development tool residing on host server 101 by establishing concurrent bi-directional communication between host server 101 and a plurality of client computers operated by the plurality of users. In an implementation where the development tool is made available for use according to an ASP model, access to the development tool residing on host server 101 may be accomplished through a computer network. Where the computer network comprises the Internet, such access may be accomplished from substantially all places in the world, at substantially all times of the day, provided the user is operating a client computer with access to the Internet. For enhanced security and flexibility, host server 101 and the user's client computer may be configured and programmed to comprise an “extranet” or a “virtual private network” through the use of known hardware and software means.

A scenario authoring tool according to this embodiment of the present invention comprises a second software tool comprising a scenario assembler tool. The scenario assembler tool according to this embodiment assembles the scenario components created using the development tool. According to an implementation of the assembler tool, a user may employ the scenario assembler tool at any point during scenario development to review the scenario in its then-current state. Thus, a user may use the assembler tool to review the scenario, even if the scenario may be merely a few display pages sparsely populated with content; or a partially completed scenario having, for example, one episode completely authored; or a complete scenario. The assembler tool may comprise a wizard or similar software utility.

A scenario authoring tool according to this embodiment of the present invention also comprises a third software tool comprising a scenario tester tool. After a scenario is completely developed and assembled using the development tool and the assembler tool, respectively, the scenario tester tool according to this embodiment of the present invention tests the scenario. Using software testing techniques known in the software art, the tester tool executes the scenario under simulated real-world conditions in an attempt to expose defects in the scenario before the scenario is released for use by learners and facilitators. Once a scenario passes testing, it may be released for execution by learners and facilitators.

Although the scenario authoring tool may be used to facilitate scenario development, certain activities must be accomplished before using the scenario development tool. Referring back to FIG. 17, prior to using the scenario authoring tool to facilitate the development of a scenario, at least one subject matter expert must be identified, as shown in the step shown as block 1700 of FIG. 17. The SME may also be the user of the scenario authoring tool, but this is not required. In addition to identifying at least one SME, prior to using the scenario authoring tool, the user also must identify learning objectives (as shown in the step shown as block 1702 of FIG. 17), and also must identify and characterize the learners (as shown in the step shown as block 1704 of FIG. 17). Similarly, the steps shown as blocks 1801-1802 of FIG. 18 should be performed prior to using the scenario authoring tool to facilitate the development of a scenario.

In an embodiment, the present invention is capable of integration into Learning Management Systems and Content Management Systems known in the art such as, for example, Learning Management Systems and Content Management Systems offered by, or under the trade name, Docent, Saba, WebCT, and Blackboard, and other such systems known in the art. Thus, scenarios according to the present invention may be made available to learners via such a Learning Management Systems and/or Content Management System, without the need for a learner to maintain separate accounts and separate interactive sessions with the present invention and the Learning Management Systems and/or Content Management System.

In addition, data reflective of a learner's execution of a scenario and stored in database 106 is compatible with standards for learning data interchange known in the art, such as, for example, the Shareable Content Object Reference Model (“SCORM”) (see, e.g., www.scorm.tamucc.edu/scorm/home.html), the standards developed by the Aviation Industry CBT Committee (see www.aicc.org), and the standards developed by the IMS Global Learning Consortium, Inc. (see www.imsproject.org). Such standards facilitate online distributed learning activities such as, for example, locating and using educational content, tracking learner progress, reporting learner performance, and exchanging student records between administrative systems.

The present invention is an improved system and method for case study instruction. Case studies according to the present invention, called scenarios, are accessible through a computer network, eliminating the need for a classroom or for co-location of learners. A plurality of learners may access a scenario simultaneously from a plurality of physical locations, provided each learner has access to the computer network. In an embodiment of the present invention where the computer network comprises the Internet, a learner may participate in a scenario from substantially any place in the world, and if the scenario permits, at substantially any time of the day. Scenarios according to the present invention comprise desirable case study features. For example, scenarios may be facilitated, enhancing the quality of the learning. Group participation in scenarios also is possible according to the present invention. Learners may participate on teams while executing a scenario according to the present invention.

Those of skill in the art will appreciate that the various software means recited herein and in the claims may be performed by computer software and/or computer hardware. Such computer software may be written in any programming language known in the art, such as, for example, Visual Basic, Java, Perl, Flash, CGI, C, C++, Pascal, Fortran, and the like.

While this invention has been described as having a preferred design, the present invention can be further modified within the scope and spirit of this disclosure. This application is therefore intended to cover any variations, uses, or adaptations of the invention using its general principles. For example, the methods disclosed herein and in the appended claims represent one possible sequence of performing the steps thereof. A practitioner of the present invention may determine in a particular implementation of the present invention that multiple steps of one or more of the disclosed methods may be combinable, or that a different sequence of steps may be employed to accomplish the same results. Each such implementation falls within the scope of the present invention as disclosed herein and in the appended claims. Furthermore, this application is intended to cover such departures from the present disclosure as come within known or customary practice in the art to which this invention pertains.

I claim:

1. A system for case study instruction comprising:
a host server;
a database associated with said host server;
at least one client computer;
a network operably connecting said host server and said at least one client computer; and
information about a case study, said case study comprising at least one episode, each of said at least one episodes comprising at least one event and at least one character profile, at least one of said events comprising at least one activity, said information retrievably stored on said host server and in said database, said information comprising a plurality of display pages, wherein at least one of said display pages comprises multimedia.

2. The system of claim 1, wherein at least one of said episodes further comprises at least one resource.

3. A system for case study instruction comprising:
a host server;
a database associated with said host server;
at least one client computer operated by at least one learner;
a network operably connecting said host server and said at least one client computer; and
information about a case study, said information retrievably stored on said host server and in said database, said case study comprising at least one episode, each of said at least one episodes comprising at least one event and at least one character profile, at least one of said events comprising one or more activities, said case study designed to assist said at least one learner in improving at least one hard skill.

4. The system of claim 3, wherein at least one of said episodes further comprises at least one resource.

5. A system for case study instruction comprising:
a host server;
a database associated with said host server;
at least one client computer;
a network operably connecting said host server and said at least one client computer; and
information about a case study, said information retrievably stored on said host server and in said database, said case study comprising at least one episode, each of said at least one episodes comprising at least one event and at least one character profile, wherein at least one of said events comprises one or more activities, at least one of said activities being selected from the group consisting of quiz activities, point-of-view activities, and computer facilitated practice activities.

6. The system of claim 5, wherein at least one of said events comprises location-specific scene content.

7. The system of claim 5, wherein at least one of said activities is a location-specific activity.

8. The system of claim 5, wherein at least one of said episodes further comprises at least one resource.

9. The system of claim 8, wherein said at least one resource is a location-specific resource.

10. The system of claim 5, wherein at least one of said client computers is operated by a facilitator, said system further comprising:
means useable by said facilitator for acquiring a report pertaining to at least one of said activities, said means operable to retrieve a portion of said information from said database, to compile said retrieved information in a format displayable on said client computer operated by said facilitator, and to display said compiled information on said client computer operated by said facilitator.

11. The system of claim 10, wherein each of said at least one activities is selected from the group consisting of survey activities, quiz activities, discussion forum activities, point-of-view activities, and computer facilitated practice activities.

12. The system of claim 5, wherein at least one of said activities comprises a quiz activity.

13. The system of claim 12, wherein said quiz activity comprises quiz activity randomization.

14. The system of claim 12, wherein said quiz activity comprises an adaptive quiz.

15. The system of claim 5, wherein at least one of said activities comprises a computer facilitated practice activity.

16. The system of claim 15, wherein said computer facilitated practice activity is adapted for use with generalized subject matter.

17. The system of claim 5, wherein at least one of said activities comprises a point-of-view activity.

18. The system of claim 5, wherein at least one of said activities is selected from the group consisting of quiz activities, point-of-view activities, computer facilitated practice activities, and survey activities, wherein said survey activities comprise survey activity randomization.

19. The system of claim 5, wherein at least one event comprises at least two activities.

20. A system for case study instruction comprising:
a host server;
a database associated with said host server;
a plurality of client computers operated by a plurality of participants;
a network operably connecting said host server and said plurality of client computers;
information about a case study, said information retrievably stored on said host server and in said database, said case study comprising at least one episode, each of said at least one episodes comprising at least one event and at least one character profile, at least one of said events comprising one or more activities; and
means for communicating between said plurality of participants.

21. The system of claim 20, wherein at least one of said episodes further comprises at least one resource.

22. The system of claim 20, wherein said plurality of participants comprises a plurality of learners, said plurality of learners being organized into at least two teams with each of said teams comprising at least one learner, said means for communicating between said plurality of participants comprising a threaded discussion wherein said at least one learner from a first team may communicate with said at least one learner from a second team.

23. The system of claim 22, further comprising means for organizing said learners into said teams, said means comprising:
means for obtaining profile information about at least two of said learners;
means for storing said profile information in said database; and
means operable to evaluate at least a portion of said profile information against predetermined team assignment criteria retrievably stored in said database, and operable to assign at least one said learner to at least one said team according to said evaluation.

24. The system of claim 20, wherein said means for communicating between said plurality of participants comprises a threaded discussion comprising at least one message, and wherein at least one of said participants is a facilitator, the system further comprising:
means operable by said facilitator for extracting at least one message from said threaded discussion and retrievably storing said at least one message in a computer file.

25. The system of claim 20, wherein said means for communicating between said plurality of participants comprises instant messaging.

26. The system of claim 20, wherein said means for communicating between said plurality of participants comprises means for sending one or more e-mail messages to another participant.

27. The system of claim 20, wherein said means for communicating between said plurality of participants comprises a chat room.

28. The system of claim 20, wherein said means for communicating between said plurality of participants comprises means for attaching a computer file to a message.

29. A system for case study instruction comprising:
a host server;
a database associated with said host server;
a first client computer operated by a first participant;
a network operably connecting said host server and said first client computer;
information about a case study, said information retrievably stored on said host server and in said database, said case study comprising at least one episode, each of said at least one episodes comprising at least one event and at least one character profile, wherein at least one of said events comprises one or more activities; and
means useable by said first participant for retrievably storing personal messages on said host server and in said database.

30. The system of claim 29, wherein at least one of said episodes further comprises at least one resource.

31. The system of claim 29, further comprising a second client computer operated by a second participant, said network operably connecting said host server and said second client computer, the system further comprising:
means for preventing said second participant from retrieving said personal messages retrievably stored by said first participant.

32. A system for case study instruction comprising:
a host server;
a database associated with said host server;
a first client computer operated by a first participant;
a network operably connecting said host server and said first client computer;
information about a case study, said information retrievably stored on said host server and in said database, said case study comprising at least one episode, each of said at least one episodes comprising at least one event and at least one character profile, wherein at least one of said events comprises one or more activities; and
action planning means useable by said first participant for retrievably storing an action plan.

33. The system of claim 32, wherein at least one of said episodes further comprises at least one resource.

34. The system of claim 32, further comprising a second client computer operated by a second participant, said network operably connecting said host server and said second client computer, the system further comprising:
means for preventing said second participant from retrieving said action plan retrievably stored by said first participant.

35. The system of claim 32, wherein said action planning means comprises means for editing said action plan.

36. The system of claim 32, wherein said action planning means comprises means for creating said action plan.

37. The system of claim 32, wherein said action plan comprises an action plan of a type selected from the group consisting of non-customizable action plans, semi-customizable action plans, and fully customizable action plans.

38. A system for case study instruction comprising:
a host server;
a database associated with said host server;
a client computer operated by a participant;
a network operably connecting said host server and said client computer;
information about a case study, said information retrievably stored on said host server and in said database, said case study comprising at least one episode, each of said at least one episodes comprising at least one event and at least one character profile, wherein at least one of said events comprises one or more activities; and
means useable by said participant for acquiring a report, said means operable to retrieve a portion of said information from said database, to compile said retrieved information in a format displayable on said client computer, and to display said compiled information on said client computer.

39. The system of claim 38, wherein at least one of said episodes further comprises at least one resource.

40. The system of claim 38, wherein said report pertains to at least one of said activities.

41. The system of claim 40, wherein each of said at least one activities is selected from the group consisting of survey activities, quiz activities, discussion forum activities, point-of-view activities, and computer facilitated practice activities.

42. The system of claim 38, further comprising at least one additional client computer operated by at least one learner, said at least one additional client computer operably connected to said host server by said network, wherein said participant is a facilitator and said compiled information is representative of said at least one learner's participation during said case study.

43. The system of claim 42, wherein said report comprises means useable by said facilitator for communicating with said at least one learner.

44. The system of claim 38, further comprising a plurality of additional client computers operated by a plurality of learners, said plurality of additional client computers operably connected to said host server by said network, wherein said report comprises compiled information representative of the participation of at least two of said plurality of learners during said case study.

45. The system of claim 44, wherein said report comprises means useable by said facilitator for communicating with at least one learner selected from among the learners to which the report pertains.

46. A system for case study instruction comprising:
a host server;
a database associated with said host server;
a client computer operated by a facilitator, said client computer comprising at least one data entry means;
a network operably connecting said host server and said client computer;
information about a case study, said information retrievably stored on said host server and in said database, said case study comprising at least one episode, each of said at least one episodes comprising at least one event and at least one character profile, wherein at least one of said events comprises one or more activities; and
means useable by said facilitator for supplementing said information about said case study, said means operable to receive said supplemental information from said facilitator, and to retrievably store said received supplemental information on said host server and in said database.

47. The system of claim 46, wherein said supplemental information comprises information about one or more activities.

48. The system of claim 46, wherein said database comprises an activity database and a resource database.

49. The system of claim 48, wherein said activity database comprises one or more activity templates, each of said activity templates being retrievable from said activity database by said facilitator using said client computer, populatable with information comprising an activity by said facilitator using data entry means of said client computer, and retrievably storable on said host server and in said database by said facilitator using said client computer.

50. The system of claim 48, further comprising an activity example database.

51. The system of claim 46, wherein said supplemental information comprises information about one or more resources.

52. The system of claim 48, wherein said resource database comprises resource templates, each of said resource templates being retrievable from said resource database by said facilitator using said client computer, populatable with information comprising a resource by said facilitator using data entry means of said client computer, and retrievably storable on said host server and in said database by said facilitator using said client computer.

53. The system of claim 48, further comprising a resource example database.

54. A system for creating information about a case study comprising:
a host server;
a database associated with said host server;
at least one client computer, each of said at least one client computers operated by a user, each of said at least one client computers comprising at least one data entry means;
a network operably connecting said host server and said at least one client computer;
means operable by said user for creating information about a case study, said information being retrievably storable on said host server and in said database, said case study comprising at least one episode, each of said at least one episodes comprising at least one event and at least one character profile, wherein at least one of said events comprises one or more activities.

55. The system of claim 54, wherein at least one of said episodes further comprises at least one resource.

56. The system of claim 54, wherein said database comprises an activity database, a scene database, a character profile database, and a resource database.

57. The system of claim 56, wherein said activity database comprises one or more activity templates, each of said activity templates being retrievable from said activity database by said user using said client computer, populatable with information comprising an activity by said user using data entry means of said client computer, and retrievably storable on said host server and in said database by said user using said client computer.

58. The system of claim 56, further comprising an activity example database.

59. The system of claim 56, wherein said resource database comprises one or more resource templates, each of said resource templates being retrievable from said resource database by said user using said client computer, populatable with information comprising a resource by said user using data entry means of said client computer, and retrievably storable on said host server and in said database by said user using said client computer.

60. The system of claim 56, further comprising a resource example database.

61. The system of claim 56, wherein said event database comprises one or more event templates, each of said event templates being retrievable from said event database by said user using said client computer, populatable with information comprising a scene by said user using data entry means of said client computer, and retrievably storable on said host server and in said database.

62. The system of claim 56, further comprising a scene example database.

63. The system of claim 56, wherein said character profile database comprises one or more character profile templates, each of said character profile templates being retrievable from said character profile database by said user using said client computer, populatable with information comprising a character profile by said user using data entry means of said client computer, and retrievably storable on said host server and in said database by said user using said client computer.

64. The system of claim 56, further comprising a character profile example database.

65. The system of claim 56, further comprising a case study example database.

66. A system for case study instruction comprising:
a host server;
a database associated with said host server;
at least one client computer;
a network operably connecting said host server and said at least one client computer;
information about a case study, said case study comprising at least one episode, each of said at least one episodes comprising at least one event and at least one character profile, at least one of said events comprising at least one activity, said information retrievably stored on said host server and in said database, said information comprising a plurality of display pages; and
a Learning Management System accessible using said client computer, said information being accessible using said Learning Management System.

67. A system for case study instruction comprising:
a host server;
a database associated with said host server;
at least one client computer operated;
a network operably connecting said host server and said at least one client computer;
information about a case study, said case study being executable by said learner, said case study comprising at least one episode, each of said at least one episodes comprising at least one event and at least one character profile, at least one of said events comprising at least one activity, said information retrievably stored on said host server and in said database, said information comprising a plurality of display pages; and
data reflective of said learner's execution of said case study, said data retrievably stored on said host server and in said database, said data formatted in accordance with at least one standard for learning data interchange.

68. A method for case study instruction, said case study comprising at least one episode, each of said at least one episodes comprising at least one event and at least one character profile, the method comprising:
providing a system according to claim 54;
identifying at least one subject matter expert;
identifying at least one learning objective;
identifying at least one learner;
defining information about said at least one character profile;
defining information about said at least one episode;
defining information about said at least one event;
finalizing said information about said case study; and
retrievably storing said information about said case study on said host server and in said database.

69. The method of claim 68, further comprising after the step of defining information about said at least one episode, the step of:
defining information about at least one resource.

70. The method of claim 68, further comprising after the step of defining information about said at least one event, the step of:
defining information about at least one activity.

71. The method of claim 68, further comprising the steps of:
defining a plan for implementing said case study;
registering said at least one learner;
introducing said at least one learners to said case study; and
executing said case study.

72. The method of claim 71, wherein said step of registering said at least one learner comprises the steps of:
obtaining profile information about at least one of said learners;
evaluating at least a portion of said profile information against predetermined team assignment criteria; and
assigning at least one of said learners to a team according to said evaluation.
